(19) United States
(12) Patent Application Publication
(10) Pub. No.: US 2024/0190216 A1
(43) Pub. Date: Jun. 13, 2024

(54) COMPRESSOR MODULE

(71) Applicant: DENSO CORPORATION, Kariya-city (JP)

(72) Inventors: Hiroshi MIEDA, Kariya-city (JP); Atsushi INABA, Kariya-city (JP); Yuichi KAMI, Kariya-city (JP); Norihiko ENOMOTO, Kariya-city (JP); Masahiro ITO, Kariya-city (JP)

(21) Appl. No.: 18/441,791

(22) Filed: Feb. 14, 2024

Related U.S. Application Data
(63) Continuation of application No. PCT/JP2022/030694, filed on Aug. 11, 2022.

(51) Int. Cl. B60H 1/32

(52) U.S. Cl. CPC B60H 1/3223

(57) ABSTRACT

A compressor module for a heat pump cycle includes a compressor, a channel forming member configured to define therein a plurality of internal refrigerant channels through which refrigerant flows, and a cover member configured to define a housing space of a housing, which houses the compressor, together with the channel forming member. The housing is provided therein with a compressor-side inlet and a compressor-side outlet communicating to the internal refrigerant channels, and is provided with an outside connection port outside of the housing space and communicating to the internal refrigerant channels. The compressor has a refrigerant discharge port coupled to the compressor-side inlet, and a refrigerant suction port coupled to the compressor-side outlet. The outside connection port is connected to inflow and outflow sides of external component devices disposed outside the housing space, in component devices of the heat pump cycle.

### CROSS REFERENCE TO RELATED APPLICATION

The present application is a continuation application of International Patent Application No. PCT/JP2022/030694 filed on Aug. 11, 2022, which designated the U.S. and claims the benefit of priority from Japanese Patent Application No. 2021-138006 filed on Aug. 26, 2021. The entire disclosures of all of the above applications are incorporated herein by reference.

### TECHNICAL FIELD

The present disclosure relates to a compressor module in which component devices of a heat pump cycle including a compressor are integrated.

### BACKGROUND

Conventionally, in a compressor module, a compressor, a manifold, and the like as component devices of a heat pump cycle are integrated. The manifold is a channel forming member or a channel connecting member that has refrigerant piping or heating medium piping formed therein. This type of a compressor module may be effectively used to enhance the productivity of a heat pump cycle.

### SUMMARY

According to an aspect of the present disclosure, a compressor module for a heat pump cycle includes a compressor, a channel forming member configured to define therein a plurality of internal refrigerant channels through which refrigerant flows, and a cover member configured to define a housing space of a housing, which houses the compressor, together with the channel forming member. The housing is provided therein with a compressor-side inlet and a compressor-side outlet communicating to the internal refrigerant channels, and is provided with an outside connection port outside of the housing space and communicating to the internal refrigerant channels. The compressor has a refrigerant discharge port coupled to the compressor-side inlet, and a refrigerant suction port coupled to the compressor-side outlet. The outside connection port is connected to inflow and outflow sides of external component devices disposed outside the housing space, in component devices of the heat pump cycle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic overall configuration diagram of a vehicle air conditioner in a first embodiment;

FIG. 2 is a perspective view of a compressor module in the first embodiment with a cover member removed;

FIG. 3 is a perspective view of the appearance of the compressor module in the first embodiment;

FIG. 4 is a block diagram of an electrical control unit of the vehicle air conditioner in the first embodiment;

FIG. 5 is a schematic overall configuration diagram illustrating a flow of a refrigerant in the vehicle air conditioner in the first embodiment in a hot gas heating mode;

FIG. 6 is a schematic overall configuration diagram of the vehicle air conditioner in a second embodiment;

FIG. 7 is a perspective view of the compressor module in the second embodiment with the cover member removed;

FIG. 8 is a schematic overall configuration diagram of the vehicle air conditioner in a third embodiment;

FIG. 9 is a perspective view of the compressor module in the third embodiment with the cover member removed;

FIG. 10 is a perspective view of the appearance of the compressor module as viewed in the X direction in FIG. 9;

FIG. 11 is a schematic overall configuration diagram of the vehicle air conditioner in a fourth embodiment;

FIG. 12 is a schematic overall configuration diagram of the vehicle air conditioner in a fifth embodiment;

FIG. 13 is a perspective view of the compressor module in the fifth embodiment with the cover member removed; and

FIG. 14 is a perspective view of the appearance of the compressor module in the fifth embodiment.

### DESCRIPTION OF EMBODIMENTS

In order to suppress noise of a compressor module, a noise-suppressing cover member may be provided to cover a compressor, manifold, and the like which are integrated in a compressor module.

According to studies by the inventors of the present application, noise of the compressor module cannot be sufficiently suppressed just by covering the compressor, manifold, and the like with the cover member. This is because to take refrigerant piping and heating medium piping connected to the manifold out of the cover member, a through hole or the like penetrating the cover member must be formed in the cover member. For this reason, noise of the compressor easily leaks to the outside of the cover member through a gap between the through hole and the piping.

To cope with the foregoing, a means to close the gap between the through hole and the piping with a soundproofing sealing member may be possible to sufficiently suppress noise of the compressor module. However, closing a gap between a through hole and piping with a sealing member can become a cause of incurring degradation in the productivity of a heat pump cycle.

In view of the above, it is an object of the present disclosure to provide a compressor module in which noise can be sufficiently suppressed without incurring degradation in the productivity of a heat pump cycle.

According to an exemplar of the present disclosure, a compressor module for a heat pump cycle includes a compressor, a channel forming member configured to define therein a plurality of internal refrigerant channels through which refrigerant flows, and a cover member configured to define a housing space of a housing, which houses the compressor, together with the channel forming member. The housing is provided therein with a compressor-side inlet and a compressor-side outlet communicating to the internal refrigerant channels, and is provided with an outside connection port outside of the housing space and communicating to the internal refrigerant channels. The compressor has a refrigerant discharge port coupled to the compressor-side inlet, and a refrigerant suction port coupled to the compressor-side outlet. The outside connection port is connected to inflow and outflow sides of external component devices disposed outside the housing space, in component devices of the heat pump cycle.

According to the above structure, the refrigerant discharged from the compressor can be made to flow out to the external component device side through the internal refrigerant channel. Similarly, the refrigerant flowing out of an external component device can be made to be sucked into the compressor through an internal refrigerant channel.

Therefore, a through hole or the like does not need to be formed in the channel forming member or the cover member to pass piping connecting the compressor and the external component devices. For this reason, noise of the compressor is prevented from leaking to the outside of a housing space through a gap between the through hole and the piping. Further, a gap between the through hole and the piping need not be closed with a soundproofing sealing member or the like. For example, according to another exemplar of the present disclosure, at least a part of an outer surface of the housing may be defined by both of the channel forming member and the cover member.

The compressor may be fixed to the channel forming member through a vibration insulating member, and the channel forming member may be configured to define a part of a high pressure-side refrigerant device of the component devices of the heat pump cycle, in which a high pressure-side refrigerant of the heat pump cycle flows. In this case, the vibration insulating member may be made of a material having a thermoplasticity and may be disposed to be heated by the high pressure-side refrigerant in the high pressure-side refrigerant device.

Alternatively, the compressor may be fixed to the channel forming member through a vibration insulating member, and the vibration insulating member may be made of a material having a thermoplasticity and may be disposed to be heated by heat generated by the compressor.

Hereinafter, multiple embodiments for performing the present disclosure will be described with reference to the drawings. In each embodiment, portions corresponding to those described in the preceding embodiment are denoted by the same reference numerals, and overlapping descriptions may be omitted. In a case where only a part of a configuration is described in each embodiment, the other embodiments described above are capable of being applied for the other parts of the configuration. Not only a combination of parts that clearly indicate that the combination is possible in each embodiment, but also a partial combination of embodiments even if the combination is not specified is also possible when there is no problem in the combination.

### First Embodiment

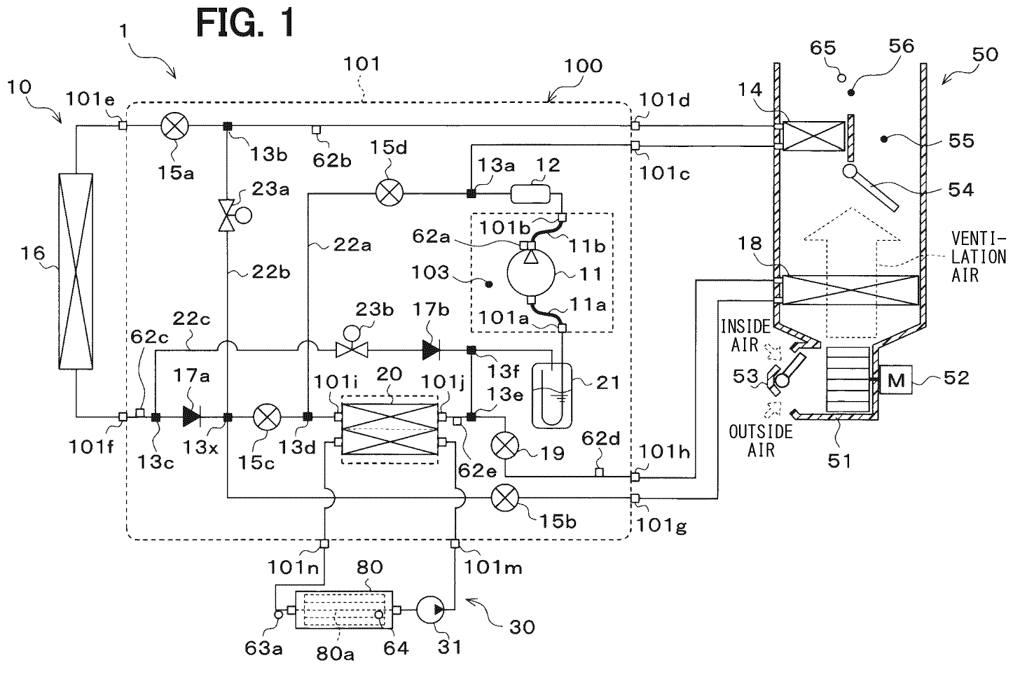

A description will be given to a first embodiment of the compressor module according to the present disclosure with reference to FIG. 1 to FIG. 5. A compressor module 100 in the present embodiment is applied to a vehicle air conditioner 1 mounted in an electric vehicle. The electric vehicle is a vehicle that obtains running driving force from an electric motor. The vehicle air conditioner 1 is a heat pump cycle that conditions the air in a vehicle compartment as a space to be air conditioned and controls a temperature of an in-vehicle device. Therefore, the vehicle air conditioner 1 can be referred to as an air conditioner with an in-vehicle device temperature control function or an in-vehicle device temperature controller with an air conditioning function.

In the vehicle air conditioner 1, specifically, a temperature of a battery 80 as an in-vehicle device is controlled. The battery 80 is a secondary battery that accumulates electric power supplied to a plurality of in-vehicle devices operating on electric power. The battery 80 is a battery pack formed by electrically connecting a plurality of laminated and disposed battery cells in series or in parallel. A battery cell in the present embodiment is a lithium-ion battery.

The battery 80 generates heat in operation (that is, during charging/discharging). The battery 80 has a property that the output thereof is prone to lower at a low temperature and deterioration is prone to progress at a high temperature. For this reason, a temperature of the battery 80 need be maintained within an appropriate temperature range (in the present embodiment, 15° C. or more and 55° C. or less). Consequently, in the electric vehicle in the present embodiment, the vehicle air conditioner 1 is used to control a temperature of the battery 80.

The vehicle air conditioner 1 includes a heat pump cycle 10, a low temperature-side heating medium circuit 30, an interior air conditioning unit 50, a controller 60, and the like. The compressor module 100 is a component obtained by mainly integrating a plurality of component devices constituting the heat pump cycle 10. In the compressor module 100 in the present embodiment, the component devices and the like encircled with the broken line in FIG. 1 are integrated.

More specifically, in the compressor module 100 in the present embodiment, of the component devices of the heat pump cycle 10, a compressor 11, a muffler portion 12, a heating expansion valve 15a, a cooling expansion valve 15b, a refrigerating expansion valve 15c, a hot gas flow regulating valve 15d, an evaporator pressure control valve 19, a chiller 20, an accumulator portion 21, a dehumidifying on-off valve 23a, a heating on-off valve 23b, and the like are integrated.

Of these component devices, the compressor 11, the heating expansion valve 15a, the cooling expansion valve 15b, the refrigerating expansion valve 15c, the hot gas flow regulating valve 15d, the evaporator pressure control value 19, the chiller 20, the dehumidifying on-off valve 23a, and the heating on-off valve 23b are integrated by being attached to a channel box 101 of the compressor module 100 described later. The muffler portion 12 and the accumulator portion 21 are integrally formed with the channel box 101.

Therefore, the channel box 101 is a mounting member for attachment of a plurality of component devices. Further, the channel box 101 is a channel forming member in which a plurality of internal refrigerant channels for letting a refrigerant of the heat pump cycle 10 flow and a plurality of internal heating medium channels for letting a low temperature-side heating medium of the low temperature-side heating medium circuit 10 flow are formed. A configuration of the compressor module 100 will be described in detail later.

First, a description will be given to the heat pump cycle 10. The heat pump cycle 10 is a refrigeration cycle apparatus of a vapor compression type that controls temperatures of ventilation air sent into a vehicle compartment and a low temperature-side heating medium circulating in the low temperature-side heating medium circuit 30. The heat pump cycle 10 is so configured that a refrigerant circuit can be switched according to various operating modes, described later, to condition the air in the vehicle compartment and cool the in-vehicle devices.

In the heat pump cycle 10, an HFO refrigerant (specifically, R1234yf) is adopted as refrigerant. The heat pump cycle 10 constitutes a subcritical refrigeration cycle in which a pressure of a high pressure-side refrigerant does not exceed a critical pressure of the refrigerant. Refrigerating machine oil for lubricating the compressor 11 is mixed into the refrigerant. The refrigerating machine oil is a PAG oil compatible with a liquid phase refrigerant. Part of the refrigerating machine oil circulates in the cycle together with the refrigerant.

The compressor 11 sucks, compresses, and discharges a refrigerant in the heat pump cycle 10. The compressor 11 is an electric compressor that drives a compressing mechanism of a fixed discharge amount type whose discharge amount is fixed with an electric motor. A number of revolutions (that is, refrigerant discharge capacity) of the compressor 11 is controlled according to a control signal outputted from the controller 60 described later. Therefore, the compressor 11 is an electrical device operated on electricity.

A compressor-side inlet 101b formed in the channel box 101 is connected to a discharge port of the compressor 11 through a high-pressure hose 11b. An outer circumferential layer of the high-pressure hose 11b is formed of an elastomer having thermoplasticity (hereafter, referred to as thermoplastic elastomer) with a foundation cloth; and an inner circumferential layer has a refrigerant hose portion of a multilayer structure formed of a resin that suppresses permeation of a refrigerant.

“Having thermoplasticity” cited here means that a property that elastic deformability is provided and when heated, a degree of elastic deformation is increased with increase in a degree of heating is provided. For this reason, the refrigerant hose portion of the high-pressure hose 11b has flexibility and can be elastically deformed.

The compressor-side inlet 101b communicates to an inlet of the muffler portion 12 formed in the channel box 101 through an internal refrigerant channel. The muffler portion 12 forms a buffer space for letting a refrigerant discharged from the compressor 11 flow in and reducing pressure pulsation in a discharged refrigerant. Therefore, the muffler portion 12 is a high pressure-side refrigerant device that lets a high pressure-side refrigerant flow in.

An outlet of the muffler portion 12 communicates to an inflow port of a first internal three-way joint 13a through an internal refrigerant channel. The first internal three-way joint 13a is a part of a three-way joint structure formed by connecting together a plurality of internal refrigerant channels formed in the channel box 101.

In the channel box 101 in the present embodiment, further, a second internal three-way joint 13b to a sixth internal three-way joint 13f are formed. The basic configurations of the second internal three-way joint 13b to the sixth internal three-way joint 13f and internal three-way joints described in relation to the following embodiments are all the same as that of the first internal three-way joint 13a.

In the three inflow and outflow ports of each of these internal three-way joints, one is used as an inflow port and two are used as outflow ports, the internal three-way joint provides a branching portion that branches a flow of a refrigerant flowing in through the one inflow port. In the three inflow and outflow ports, two are used as inflow ports and one is used as an outflow port, that internal three-way joint provides a merging portion that merges flows of a refrigerant flowing in through the two inflow ports.

Therefore, the first internal three-way joint 13a provides a discharge-side branching portion that branches a flow of a refrigerant discharged from the compressor 11.

One outflow port of the first internal three-way joint 13a communicates to a condenser-side outlet 101c formed in the channel box 101. The other outflow port of the first internal three-way joint 13a communicates to the one inflow port of the fourth internal three-way joint 13d through an internal refrigerant channel. The internal refrigerant channel extending from the other outflow port of the first internal three-way joint 13a to the one inflow port of the fourth internal three-way joint 13d is a hot gas channel 22a.

The hot gas flow regulating valve 15d is displaced in the hot gas channel 22a. The hot gas flow regulating valve 15d is an electrically operated variable throttle mechanism that depressurizes a refrigerant flowing through the hot gas channel 22a and regulates a flow rate (mass flow rate) of a refrigerant let to flow out to the downstream side in a hot gas heating mode, described later, or the like.

An operation of the hot gas flow regulating valve 15d is controlled according to a control signal (specifically, control pulse) outputted from the controller 60. Therefore, the hot gas flow regulating valve 15d is an electrical device. Further, the hot gas flow regulating valve 15d has a fully closing function of fully closing a throttle channel to close a refrigerant channel.

The refrigerant inlet side of an interior condenser 14 is connected to the condenser-side outlet 101. The interior condenser 14 is disposed in an air conditioner case 51 of the interior air conditioning unit 50. The interior condenser 14 is a heat exchanger unit that causes heat exchange between a refrigerant discharged from the compressor 11 and ventilation air. At the interior condenser 14, heat of a refrigerant discharged from the compressor 11 is radiated to ventilation air as a fluid to be heated to heat the ventilation air.

Therefore, the interior condenser 14 is a heating portion that heats ventilation air as a fluid to be heated using as a heat source one refrigerant branched at the first internal three-way joint 13a.

A condenser-side inlet 101d formed in the channel box 101 is connected to the refrigerant outlet of the interior condenser 14. The condenser-side inlet 101d communicates to the inflow port of the second internal three-way joint 13b through an internal refrigerant channel.

One outflow port of the second internal three-way joint 13b communicates to an outdoor machine-side outlet 101e formed in the channel box 101 through an internal refrigerant channel. The other outflow port of the second internal three-way joint 13b communicates to one inflow port of the internal four-way joint 13x through an internal refrigerant channel. The internal refrigerant channel extending from the other outflow port of the second internal three-way joint 13b to the one inflow port of the internal four-way joint 13x is a dehumidifying channel 22b.

The dehumidifying on-off valve 23a is disposed in the dehumidifying channel 22b. The dehumidifying on-off valve 23a is an on-off valve that opens and closes the dehumidifying channel 22b. The dehumidifying on-off valve 23a is an electromagnetic valve whose opening/closing operation is controlled according to a control voltage outputted from the controller 60. Therefore, the dehumidifying on-off valve 23a is an electrical device.

The internal four-way joint 13x is a part of a four-way joint structure formed by connecting together a plurality of internal refrigerant channels formed in the channel box 101. The internal four-way joint may be formed by combining a plurality of internal three-way joints.

The heating expansion valve 15a is disposed in the internal refrigerant channel extending from one outflow port of the second internal three-way joint 13b to the outdoor machine-side outlet 101. The heating expansion valve 15a is an outdoor machine depressurizing portion that depressurizes a refrigerant flowing out of one outflow port of the second internal three-way joint 13b and regulates a flow rate of a refrigerant let to flow out to the downstream side.

The basic configuration of the heating expansion valve 15a is the same as that of the hot gas flow regulating valve 15d. Therefore, the heating expansion valve 15a is an electrical device. The heating expansion valve 15a further has a fully opening function and fully opens a throttle channel and functions just as a refrigerant channel almost without exhibiting a flow rate regulating action or a refrigerant depressurizing action.

The refrigerant inlet side of an outdoor heat exchanger 16 is connected to the outdoor machine-side outlet 101e. The outdoor heat exchanger 16 is a heat exchange portion that causes heat exchange between a refrigerant flowing out of the heating expansion valve 15a and outside air sent by a cooling fan, not shown. The outdoor heat exchanger 16 is disposed on the front side in a driving gear room.

The driving gear room is formed on the front side of the vehicle compartment and forms a space in which at least a part of a device (for example, a motor generator) or the like for generating a running driving amount. Therefore, during vehicle running, traveling wind flowing into the driving gear room through a grille or the like can be applied to the outdoor heat exchanger 16.

The outdoor machine-side inlet 101f side formed in the channel box 101 is connected to the refrigerant outlet of the outdoor heat exchanger 16. The outdoor machine-side inlet 101f communicates to an inflow port of the third internal three-way joint 13c through an internal refrigerant channel.

One outflow port of the third internal three-way joint 13c communicates to the other inflow port of the internal four-way joint 13x through an internal refrigerant channel. A first check valve 17a is disposed in the internal refrigerant channel extending from one outflow port of the third internal three-way joint 13c to the other inflow port of the internal four-way joint 13x.

The first check valve 17a permits a flow of a refrigerant from the third internal three-way joint 13c side to the internal four-way joint 13x side and inhibits a flow of a refrigerant from the internal four-way joint 13x side to the third internal three-way joint 13c side.

The other outflow port of the third internal three-way joint 13c communicates to one inflow port of the sixth internal three-way joint 13f through the internal refrigerant channel. The internal refrigerant channel extending from the other outflow port of the third internal three-way joint 13c to one inflow port of the sixth internal three-way joint 13f is a heating channel 22c.

The heating on-off valve 23b and a second check valve 17b are disposed in the heating channel 22c. The heating on-off valve 23b is an on-off valve that opens and closes the heating channel 22c. The basic configuration of the heating on-off valve 23b is the same as that of the dehumidifying on-off valve 23a. Therefore, the heating on-off valve 23b is an electrical device.

The dehumidifying on-off valve 23a and the heating on-off valve 23b are capable of switching a refrigerant circuit by opening or closing an internal refrigerant channel. Therefore, the dehumidifying on-off valve 23a and the heating on-off valve 23b is a refrigerant circuit switching portion.

The second check valve 17b permits a flow of a refrigerant from the heating on-off valve 23b side to the sixth internal there-way joint 13f side and inhibits a flow of a refrigerant from the sixth internal there-way joint 13f to the heating on-off valve 23b side.

One inflow port of the internal four-way joint 13x communicates to an evaporator-side outlet 101g formed in the channel box 101 through an internal refrigerant channel. The other outflow port of the internal four-way joint 13x communicates to the other inflow port of the fourth internal three-way joint 13d through an internal refrigerant channel. The outflow port of the fourth internal three-way joint 13d communicates to a chiller-side outlet 101i formed in the channel box 101 through an internal refrigerant channel.

The cooling expansion valve 15b is disposed in the internal refrigerant channel extending from one outflow port of the internal four-way joint 13x to the evaporator-side outlet 101g. The cooling expansion valve 15b is an evaporator depressurizing portion that depressurizes a refrigerant flowing out of one outflow port of the internal four-way joint 13x and regulates a flow rate of a refrigerant let to flow out to the downstream side in a cooling mode, described later, or the like.

The basic configuration of the cooling expansion valve 15b is the same as that the heating expansion valve 15a. Therefore, the cooling expansion valve 15b is an electrical device.

The refrigerant inlet side of an interior evaporator 18 is connected to the evaporator-side outlet 101g. The interior evaporator 18 is disposed in the air conditioner case 51 of the interior air conditioning unit 50. The interior evaporator 18 is a heat exchange portion that causes heat exchange between a low pressure-side refrigerant depressurized at the cooling expansion valve 15b and ventilation air sent into the vehicle compartment. At the interior evaporator 18, a low pressure-side refrigerant is evaporated to exhibit a heat absorbing action and thereby cool ventilation air.

The evaporator-side inlet 101h side formed in the channel box 101 is connected to the refrigerant outlet of the interior evaporator 18. The evaporator-side inlet 101h communicates to one inflow port of the fifth internal three-way joint 13e through an internal refrigerant channel.

The evaporator pressure control valve 19 is disposed in the internal refrigerant channel extending from the evaporator-side inlet 101h to one inflow port of the fifth internal three-way joint 13e.

The evaporator pressure control valve 19 is an electrically operated variable throttle mechanism that varies a valve opening to maintain a refrigerant evaporating pressure in the interior evaporator 18 at a predetermined set pressure (in the present embodiment, a saturation pressure at 1° C.) or higher for suppression of frosting in the interior evaporator 18. The basic configuration of the evaporator pressure control valve 19 is the same as that of the heating expansion valve 15a. Therefore, the evaporator pressure control valve 19 is an electrical device.

The refrigerating expansion valve 15c is disposed in the internal refrigerant channel extending from the other outflow port of the internal four-way joint 13x to the other inflow port of the fourth internal three-way joint 13d. The refrigerating expansion valve 15c is a chiller depressurizing portion that depressurizes a refrigerant flowing out of the other outflow port of the internal four-way joint 13x and regulates a flow rate of a refrigerant let to flow out to the downstream side in a single cooling mode, described later, or the like.

The basic configuration of the refrigerating expansion valve 15c is the same as that the cooling expansion valve 15b. Therefore, the refrigerating expansion valve 15c is an electrical device.

The heating expansion valve 15a, the cooling expansion valve 15b, the refrigerating expansion valve 15c, and the hot gas flow regulating valve 15d have a fully closing function. These electrically operated variable throttle mechanisms are capable of switching a refrigerant circuit by exhibiting the fully closing function. Therefore, the cooling expansion valve 15b, the refrigerating expansion valve 15c, and the hot gas flow regulating valve 15d have a function of a refrigerant circuit switching portion as well.

The refrigerant inlet of the chiller 20 is connected directly to the chiller-side outlet 101i. The chiller 20 is a heat exchange portion that causes heat exchange between a low pressure-side refrigerant depressurized at the refrigerating expansion valve 15c and a low temperature-side heating medium circulating in the low temperature-side heating medium circuit 30. At the chiller 20, a low pressure-side refrigerant is evaporated to exhibit a heat absorbing action and a low temperature-side heating medium is thereby cooled.

The chiller-side inlet 101j formed in the channel box 101 is connected directly to the refrigerant outlet of the chiller 20. The chiller-side inlet 101j communicates to the other inflow port of the fifth internal three-way joint 13e. The outflow port of the fifth internal three-way joint 13e communicates to the other inflow port of the sixth internal three-way joint 13f through an internal refrigerant channel.

The outflow port of the sixth internal three-way joint 13f communicates to the inlet side of the accumulator portion 21 through an internal refrigerant channel. The accumulator portion 21 is a low pressure-side gas-liquid separator that separates a refrigerant flowing thereinto into gas and liquid and accumulates a surplus liquid-phase refrigerant in the cycle. The outlet of the accumulator portion 21 communicates to the compressor-side outlet 101a formed in the channel box 101 through an internal refrigerant channel.

The suction port of the compressor 11 is connected to the compressor-side outlet 101a through a low-pressure hose 11a. The basic configuration of the low-pressure hose 11a is the same as that the high-pressure hose 11b. Therefore, the refrigerant hose portion of the low-pressure hose 11a has flexibility and can be elastically deformed.

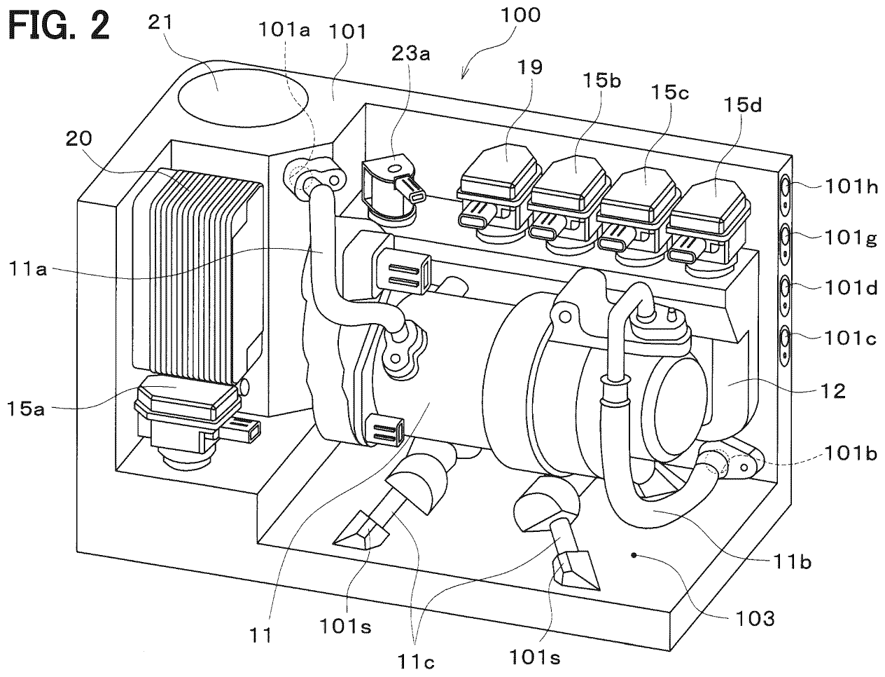

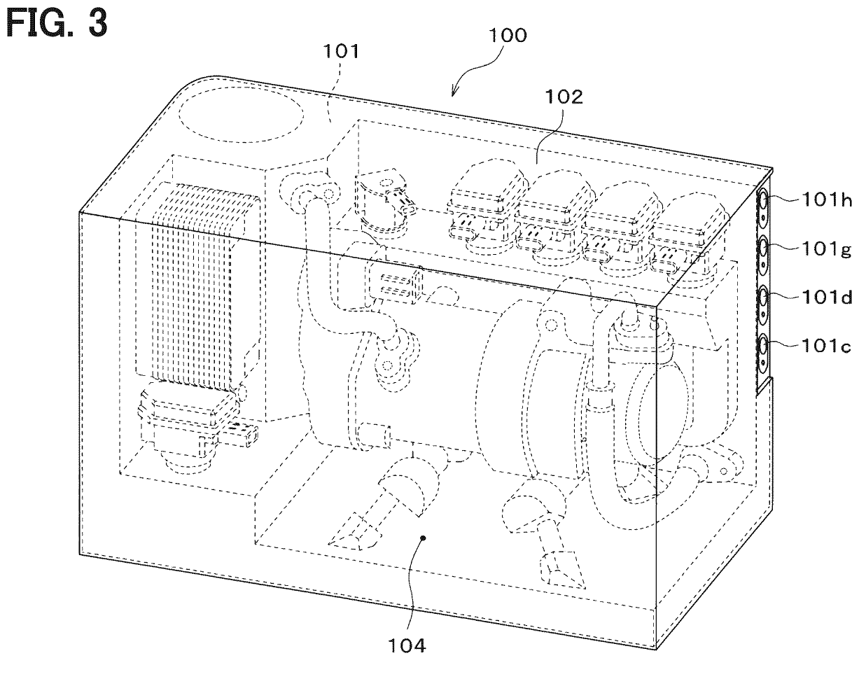

A detailed description will be given to a configuration of the compressor module 100 with reference to FIG. 2 and FIG. 3. As illustrated in FIG. 2 and FIG. 3, the compressor module 100 includes the channel box 101 and the cover member 102. The channel box 101 is formed of metal (in the present embodiment, an aluminum alloy). The cover member 102 is formed of a resin (in the present embodiment, polypropylene) superior to metal in sound insulating performance.

The cover member 102 is attached to the channel box 101 by such a means as bolting. With the cover member 102 attached to the channel box 101, as shown in FIG. 3, the appearance of the compressor module 100 is in a rectangular parallelepiped shape. Of the six outside surfaces of the rectangular parallelepiped shape of the compressor module 100, three surfaces are formed by the channel box 101. The remaining three surfaces are formed by the cover member 102.

When attached to the channel box 101, the cover member 102, together with the channel box 101, forms a housing space 103 for housing the compressor 11 and the like in the compressor module 100. In an area of contact between the channel box 101 and the over member 102, a seal member, not shown, is placed. For this reason, the housing space 103 is formed as a sealed space where inflow of air from the outside and outflow of air to the outside are prevented.

A heat insulating material 104 is disposed substantially throughout the outer side faces of the compressor module 100. The heat insulating material 104 is a heat insulating portion that suppresses heat transfer between air in the housing space 103 and the outside air. For the heat insulating material 104, such a fibrous heat insulating material as glass wool, such a foamed heat insulating material as urethane foam, or the like can be adopted.

In the housing space 103, the compressor 11, the heating expansion valve 15a, the cooling expansion valve 15b, the refrigerating expansion value 15c, the hot gas flow regulating valve 15d, the evaporator pressure control valve 19, the chiller 20, the dehumidifying on-off valve 23a, the heating on-off valve 23b, and the like are housed.

For this reason, the compressor-side outlet 101a, the compressor-side inlet 101b, the chiller-side outlet 101i, and the chiller side inlet 101j are formed in the housing space 103. More specifically, the compressor-side outlet 101a and the compressor-side inlet 101b are formed in inner side faces of the housing space 103 side of the channel box 101 and thus formed in the housing space 103.

The interior condenser 14, the outdoor heat exchanger 16, and the interior evaporator 18 are disposed outside the housing space 103. Therefore, in the present embodiment, the interior condenser 14, the outdoor heat exchanger 16 and the interior evaporator 18 are external component devices.

The condenser-side outlet 101c, the condenser-side inlet 101d, the outdoor machine-side outlet 101e, the outdoor machine-side inlet 101f, the evaporator-side outlet 101g, and the evaporator-side inlet 101h are formed in outer side faces of the channel box 101 and thus formed outside the housing space 103.

Therefore, in the present embodiment, the condenser-side outlet 101c, the condenser-side inlet 101d, the outdoor machine-side outlet 101e, the outdoor machine-side inlet 101f, the evaporator-side outlet 101g, and the evaporator-side inlet 101h are outside connection ports to which the inflow and outflow port sides of the external component devices.

A plurality of (in the present embodiment, four) fixing portions 101s for fixing the compressor 11 are formed in the bottom face forming the housing space 103 of the channel box 101. The compressor 11 is fixed to the fixing portions 101s through a rubber vibration insulator 11c. The rubber vibration insulator 11c is a vibration isolating member that suppresses transmission of vibration from the compressor 11 to the channel box 101.

More specifically, the rubber vibration insulator 11c is formed by bonding a metal bolt-shaped fastening member excellent in heat transference to both end faces of a substantially columnar thermoplastic elastomer. For this reason, by fastening the fastening member of the rubber vibration insulator 11c to the compressor 11, the heat of the compressor 11 can be transferred to the rubber vibration insulator 11c to heat the rubber vibration insulator 11c. In other words, the rubber vibration insulators 11c are so disposed that the rubber vibration insulators can be heated by heat generated in the compressor 11.

As illustrated in FIG. 2, the low-pressure hose 11a and the high-pressure hose 11b are attached to the compressor 11 and the channel box 101 as are curved.

The heating expansion valve 15a, the cooling expansion valve 15b, the refrigerating expansion valve 15c, the hot gas flow regulating valve 15d, the evaporator pressure control valve 19, the dehumidifying on-off valve 23a, and the heating on-off valve 23b are fixed to mounting holes formed in the channel box 101 by such a means as screw-fastening or press-fitting. The mounting holes communicate to internal refrigerant channels.

The chiller 20 is fixed to the channel box 101 by the refrigerant outlet and inlet and heating medium outlet and inlet so formed as to protrude to the outside being respectively fit into refrigerant outlet and inlet (that is, the chiller-side outlet 101i, the chiller-side inlet 101j) and heating medium outlet and inlet formed in the channel box 101.

The muffler portion 12 is formed in such a shape as to swell to the housing space 103 side to form a buffer space. The muffler portion 12 in the present embodiment is disposed on a side face of the channel box 101.

Electrical devices housed in the housing space 103 are connected to the controller 60 disposed outside the housing space 103 through a sealing terminal (so-called hermetic seal terminal), not shown.

Next, a description will be given to the low temperature-side heating medium circuit 30. The low temperature-side heating medium circuit 30 is a heating medium circuit for circulating a low temperature-side heating medium. In the low temperature-side heating medium circuit 30, an ethylene glycol aqueous solution is adopted as the low temperature-side heating medium. As shown in FIG. 1, a low temperature-side pump 31, a cooling water channel 80a of the battery 80, a heating medium channel of the chiller 20 of the compressor module 100, and the like are connected to the low temperature-side heating medium circuit 30.

The low temperature-side pump 31 is a low temperature-side heating medium pressure feed portion that sucks and pressure feeds a low temperature-side heating medium. The low temperature-side pump 31 pressure feeds a low temperature-side heating medium flowing out of the cooling water channel 80a of the battery 80 to the side of the low temperature-side heating medium inlet 101m formed in the channel box 101 of the compressor module 100. The low temperature-side pump 31 is an electric water pump whose number of revolutions (that is, pressure feed capacity) is controlled according to a control voltage outputted from the controller 60 and included in the electrical devices.

The low temperature-side heating medium inlet 101m communicates to an inlet of the heating medium channel of the chiller 20 through an internal heating medium channel. An outlet of the heating medium channel of the chiller 20 communicates to a low temperature-side heating medium outlet 101n formed in the channel box 101 through an internal heating medium channel.

The inlet side of the cooling water channel 80a of the battery 80 is connected to the low temperature-side heating medium outlet 101n. The cooling water channel 80a of the battery 80 is formed in a battery dedicated case housing a plurality of laminated and disposed battery cells. The channel configuration of the cooling water channel 80a is a channel configuration in which a plurality of channels is connected in parallel in the battery dedicated case. As a result, in the cooling water channel 80a, all the battery cells can be evenly cooled. The suction port side of the low temperature-side pump 31 is connected to the outlet of the cooling water channel 80a.

Next, a description will be given to the interior air conditioning unit 50. The interior air conditioning unit 50 is a unit in which a plurality of component devices is integrated to blow out ventilation air whose temperature has been conditioned to a temperature suitable for air conditioning in the vehicle compartment to an appropriate point in the vehicle compartment. The interior air conditioning unit 50 is disposed inside a dashboard (instrument panel) at the forefront of the vehicle compartment.

As shown in FIG. 1, the interior air conditioning unit 50 is formed by housing an interior blower 52, the interior evaporator 18, the interior condenser 14, and the like in the air conditioner case 51 forming an air channel of ventilation air. The air conditioner case 51 is formed of a resin (for example, polypropylene) having some degree of elasticity and excellent in strength as well.

An inside/outside air switching device 53 is disposed on the most upstream side of a ventilation air flow in the air conditioner case 51. The inside/outside air switching device 53 switches and guides inside air (that is, vehicle interior air) and outside air (that is, vehicle exterior air) into the air conditioner case 51. An operation of the inside/outside air switching device 53 is controlled according to a control signal outputted from the controller 60.

The interior blower 52 is disposed on the downstream side of a ventilation air flow in the inside/outside air switching device 53. The interior blower 52 sends air sucked through the inside/outside air switching device 53 toward the interior of the vehicle compartment. A number of revolutions (that is, ventilation capacity) of the interior blower 52 is controlled according to a control voltage outputted from the controller 60.

The interior evaporator 18 and the interior condenser 14 are disposed on the downstream side of a ventilation air flow in the interior blower 52. The interior evaporator 18 is disposed on the more upstream side of a ventilation air flow than the interior condenser 14. A cooling air bypass channel 55 for letting ventilation air that passed through the interior evaporator 18 flow with the interior condenser 14 bypassed, is formed in the air conditioner case 51.

An air mix door 54 is disposed on the downstream side of a ventilation air flow in the interior evaporator 18 and on the upstream side of a ventilation air flow in the interior condenser 14 and the cooling air bypass channel 55 in the air conditioner case 51.

The air mix door 54 adjusts an air flow rate ratio between an air flow rate of ventilation air let to pass through the interior condenser 14 side and an air flow rate of ventilation air let to pass through the cooling air bypass channel 55 with respect to ventilation air that passed through the interior evaporator 18. An operation of an actuator for driving the air mix door 54 is controlled according to a control signal outputted from the controller 60.

A mixing space 56 is disposed on the downstream side of a ventilation air flow in the interior condenser 14 and the cooling air bypass channel 55. The mixing space 56 is a space for mixing together ventilation air heated at the interior condenser 14 and unheated ventilation air that passed through the cooling air bypass channel 55.

Therefore, at the interior air conditioning unit 50, a temperature of ventilation air (that is, conditioned air) can be mixed in the mixing space 56 and blown out into the vehicle compartment by adjusting an opening of the air mix door 54.

A plurality of opening holes, not shown, for blowing out conditioned air to various spots in the vehicle compartment are formed in a part of the air conditioner case 51 located on the most downstream side of a ventilation air flow. A blowing mode door, not shown, for opening and closing a respective opening hole is disposed at each of the opening holes. An operation of the actuator for driving the blowing mode door is controlled according to a control signal outputted from the controller 60.

Therefore, in the interior air conditioning unit 50, conditioned air adjusted to an appropriate temperature can be blown out to an appropriate point in the vehicle compartment by changing opening holes opened or closed by the blowing mode doors.

A description will be given to an electric control unit in the present embodiment. The controller 60 includes a publicly known microcomputer, including CPU, ROM and RAM, and the like, and a peripheral circuit thereof. The controller 60 performs various arithmetic operations and varied processing based on a control program stored in the ROM. The controller 60 then controls operations of various devices 11, 15a to 15d, 19, 23a, 23b, 31, 52, 53, and so on to be controlled connected to the output side based on results of arithmetic operations and processing.

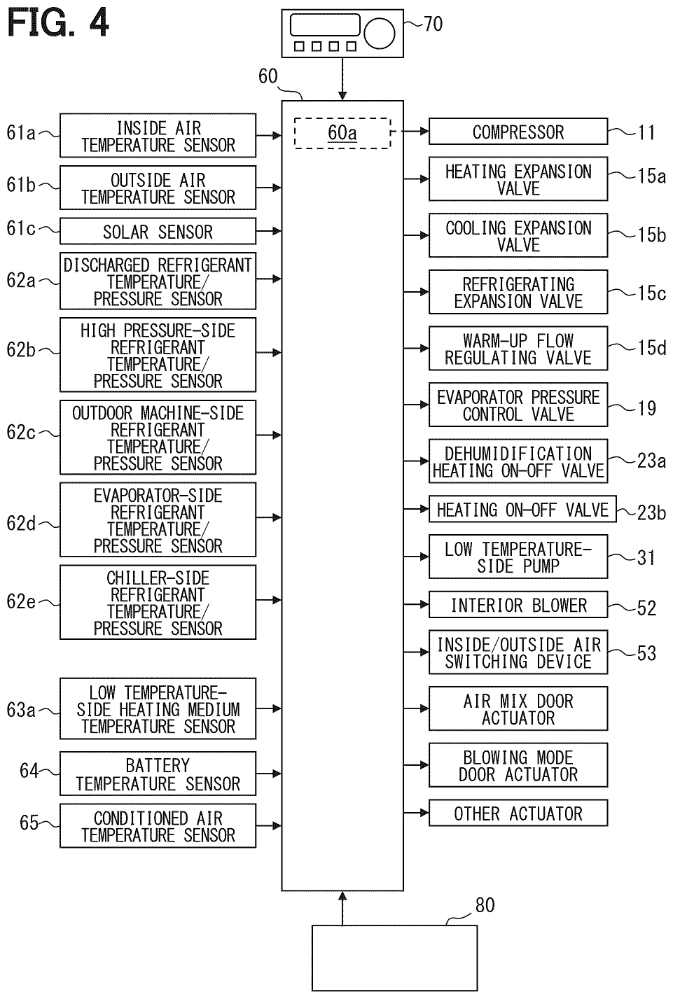

As shown in the block diagram of FIG. 4, an inside air temperature sensor 61a, an outside air temperature sensor 61b, a solar sensor 61c, a discharged refrigerant temperature/pressure sensor 62a, a high pressure-side refrigerant temperature/pressure sensor 62b, an outdoor machine-side refrigerant temperature/pressure sensor 62c, an evaporator-side refrigerant temperature/pressure sensor 62d, a chiller-side refrigerant temperature/pressure sensor 62e, a low temperature-side heating medium temperature sensor 63a, a battery temperature sensor 64, a conditioned air temperature sensor 65, and the like are connected to the input side of the controller 60.

Detection signals from a group of these controlling sensors are inputted to the controller 60. These sensors are included in the component devices of the heat pump cycle 1. Since these sensors output an electrical signal, the sensors are all included in the electrical devices.

The inside air temperature sensor 61a is an inside air temperature detecting portion that detects a vehicle interior temperature (inside air temperature) Tr. The outside air temperature sensor 61b is an outside air temperature detecting portion that detects a vehicle exterior temperature (outside air temperature) Tam. The solar sensor 61c is an amount of solar radiation detecting portion that detects an amount As of solar radiation applied to the interior of the vehicle compartment.

The discharged refrigerant temperature/pressure sensor 62a is a discharged refrigerant temperature and pressure detecting portion that detects a discharged refrigerant temperature Td and a discharged refrigerant pressure Pd of a refrigerant discharged from the compressor 11. The discharged refrigerant temperature/pressure sensor 62a in the present embodiment is attached to a housing portion forming a shell of the compressor 11. Therefore, the discharged refrigerant temperature/pressure sensor 62a is disposed in the housing space 103 of the compressor module 100.

The high pressure-side refrigerant temperature/pressure sensor 62b is a high pressure-side refrigerant temperature and pressure detecting portion that detects a high pressure-side refrigerant temperature T1 and a high pressure-side refrigerant pressure P1 of a refrigerant flowing out of the interior condenser 14. The outdoor machine-side refrigerant temperature/pressure sensor 62c detects an outdoor machine-side refrigerant temperature T2 and an outdoor machine-side refrigerant pressure P2 of a refrigerant flowing out of the outdoor heat exchanger 16.

The evaporator-side refrigerant temperature/pressure sensor 62d is an evaporator-side refrigerant temperature and pressure detecting portion that detects an evaporator-side refrigerant temperature Te and an evaporator-side refrigerant pressure Pe of a refrigerant flowing out of the interior evaporator 18. The chiller-side refrigerant temperature/pressure sensor 62e is a chiller-side refrigerant temperature and pressure detecting portion that detects a chiller-side refrigerant temperature Tc and a chiller-side refrigerant pressure Pc of a refrigerant flowing out of a refrigerant channel of the chiller 20.

The discharged refrigerant temperature/pressure sensor 62a, the high pressure-side refrigerant temperature/pressure sensor 62b, the outdoor machine-side refrigerant temperature/pressure sensor 62c, the evaporator-side refrigerant temperature/pressure sensor 62d, and the chiller-side refrigerant temperature/pressure sensor 62e are attached to the channel box 101 of the compressor module 100. Like the compressor 11 and the like, the sensors disposed in the housing space 103 are connected to the controller 60 thorough a sealing terminal, not shown.

In the present embodiment, a detecting portion in which a pressure detecting portion and a temperature detecting portion are integrated is adopted as a refrigerant temperature/pressure sensor; but a pressure detecting portion and a temperature detecting portion separately configurated may be adopted, needless to add.

The low temperature-side heating medium temperature sensor 63a is a low temperature-side heating medium temperature detecting portion that detects a low temperature-side heating medium temperature TWL, which is a temperature of a low temperature-side heating medium flowing into the cooling water channel 80a of the battery 80.

The battery temperature sensor 64 is a battery temperature detecting portion that detects a battery temperature TB, which is a temperature of the battery 80. The battery temperature sensor 64 includes a plurality of temperature sensors and detects a temperature of the battery 80 at a plurality of points. For this reason, in the controller 60, a temperature difference and a temperature distribution between battery cells forming the battery 80 can be detected. In addition, an average value of detection values of a plurality of temperature sensors is adopted as the battery temperature TB.

The conditioned air temperature sensor 65 is a conditioned air temperature detecting portion that detects a temperature TAV of ventilation air sent from the mixing space 56 into the vehicle compartment.

As shown in FIG. 4, an operation panel 70 disposed in proximity to the instrument panel at the front part of the interior of the vehicle compartment is connected to the input side of the controller 60. Operating signals from various operation switches provided in the operation panel 70 are inputted to the controller 60.

The various operation switches provided in the operation panel 70 specifically include an auto switch, an air conditioner switch, an air flow rate setting switch, a temperature setting switch, and the like.

The auto switch is an operation switch for setting or cancelling an automatically controlled operation of the vehicle air conditioner 1. The air conditioner switch is an operation switch requesting refrigeration of ventilation air in the interior evaporator 18. The air flow rate setting switch is an operation switch for manually setting an air flow rate of the interior blower 52. The temperature setting switch is an operation switch for setting a set temperature Tset in the interior of the vehicle compartment.

The controller 60 in the present embodiment is integrally configured with a control portion that controls various devices to be controlled connected to the output side thereof. Therefore, each configuration element (hardware and software) controlling an operation of a respective device to be controlled constitutes a control portion that controls an operation of a respective device to be controlled. For example, of the controller 60, a configuration element that controls a refrigerant discharge capacity (specifically, a number of revolutions) of the compressor 11 constitutes a discharge capacity control portion 60a.

A description will be given to an operation of the vehicle air conditioner 1 in the present embodiment. In the vehicle air conditioner 1 in the present embodiment, various operation modes are switched to perform air conditioning in the vehicle compartment and temperature control of the battery 80. Operation modes are switched by a control program, stored in the controller 60 in advance, being executed.

The control program is executed not only when a vehicle system has been actuated after a so-called IG switch is turned on (ON) but also when the battery 80 is being charged from an external power supply and the other like occasions. The control program reads a detection signal from the above-mentioned sensor group and an operation signal from an operation switch in the operation panel 70 at predetermined time intervals. Operation modes are switched based on read detection signal and operation signal.

Further, when the auto switch in the operation panel 70 is turned on (ON) and an automatically controlled operation of vehicle interior air conditioning is established, the control program in the present embodiment computes a target blowout temperature TAO, which is a target temperature of ventilation air blown out into the vehicle compartment based on read detection signal and operation signal.

The target blowout temperature TAO is calculated using the following mathematical formula F1:

TAO=Kset×Tset−Kr×Tr−Kam×Tam−Ks×As+C (F1)

Where, Tset denotes a set temperature of the interior of the vehicle compartment set by the temperature setting switch in the operation panel 70; Tr denotes an inside air temperature detected by the inside air temperature sensor 61a; Tam denotes an outside air temperature detected by the outside air temperature sensor 61b; As denotes an amount As of solar radiation detected by the solar sensor 61c. Kset, Kr, Kam, Ks are control gains; and C is a correction constant. Hereafter, a detailed description will be given to each operation mode.

### (a) Cooling Mode

The cooling mode is an operation mode in which the interior of the vehicle compartment is cooled by blowing refrigerated ventilation air out into the vehicle compartment. The control program in the present embodiment establishes the operation mode for cooling the interior of the vehicle compartment mainly when an outside air temperature Tam is relatively high as in summer seasons.

The cooling mode includes: a single cooling mode in which the interior of the vehicle compartment is cooled without refrigerating the battery 80; and a refrigeration cooling mode in which the battery 80 is refrigerated and the interior of the vehicle compartment is simultaneously cooled. The control program in the present embodiment establishes the operation mode for refrigerating the battery 80 as an on-board device when the battery temperature TB becomes equal to or higher than a predetermined reference upper limit temperature KTBH.

(a-1) Single Cooling Mode

In the heat pump cycle 10 in the single cooling mode, the controller 60 brings the heating expansion valve 15a into a fully opened state, the cooling expansion valve 15b into a throttled state in which a refrigerant depressurizing action is exhibited, the refrigerating expansion valve 15c into a fully closed state, and the hot gas flow regulating valve 15d into a fully closed state. Further, the controller 60 closes the dehumidifying on-off valve 23a and closes the heating on-off valve 23b.

For this reason, in the heat pump cycle 10 in the single cooling mode, the refrigerant circuit is switched to a refrigerant circuit, in which a refrigerant discharged from the compressor 11 circulates in the order of the muffler portion 12, the interior condenser 14, the fully opened heating expansion valve 15a, the outdoor heat exchanger 16, the throttled cooling expansion valve 15b, the interior evaporator 18, the evaporator pressure control valve 19, the accumulator portion 21 and the suction port of the compressor 11.

In the interior air conditioning unit 50 in the single cooling mode, an opening of the air mix door 54 is so controlled that a ventilation air temperature TAV detected by the conditioned air temperature sensor 65 is brought closer to the target blowout temperature TAO. In the interior air conditioning unit 50 in the single cooling mode, operations of the inside/outside air switching device 53 and the blowing mode door are controlled based on the target blowout temperature TAO. The controller 60 further controls operations of other devices to be controlled as appropriate.

Therefore, in the heat pump cycle 10 in the single cooling mode, a refrigeration cycle of a vapor compression type is so configured that the interior condenser 14 and the outdoor heat exchanger 16 are caused to function as a condenser that radiates heat from a refrigerant to condense the refrigerant; and the interior evaporator 18 is caused to function as an evaporator that evaporates a refrigerant.

In the interior air conditioning unit 50 in the single cooling mode, ventilation air sent from the interior blower 52 is refrigerated at the interior evaporator 18. The ventilation air refrigerated at the interior evaporator 18 is heated again at the interior condenser 14 so that the temperature thereof is brought closer to the target blowout temperature TAO according to an opening of the air mix door 54. Then, the temperature-controlled ventilation air is blown out into the vehicle compartment and cooling of the interior of the vehicle compartment is thereby implemented.

(a-2) Refrigeration Cooling Mode

In the heat pump cycle 10 in the refrigeration cooling mode, unlike the single cooling mode, the controller 60 brings the refrigerating expansion valve 15c into a throttled state.

For this reason, in the heat pump cycle 10 in the refrigeration cooling mode, a refrigerant discharged from the compressor 11 circulates as in the single cooling mode. At the same time, the refrigerant circuit is switched to a refrigerant circuit in which a refrigerant discharged from the compressor 11 circulates in the order of the muffler portion 12, the interior condenser 14, the fully opened heating expansion valve 15a, the outdoor heat exchanger 16, the throttled refrigerating expansion valve 15c, the chiller 20, the accumulator portion 21 and the suction port of the compressor 11. That is, the refrigerant circuit is switched to a refrigerant circuit in which the interior evaporator 18 and the chiller 20 are connected in parallel to a flow of a refrigerant.

Further, in the low temperature-side heating medium circuit 30 in the refrigeration cooling mode, the controller 60 actuates the low temperature-side pump 31 so as to exhibit a predetermined reference pressure feed capacity. For this reason, in the low temperature-side heating medium circuit 30, a low temperature-side heating medium pressure fed from the low temperature-side pump 31 circulates in the order of the heating medium channel of the chiller 20, the cooling water channel 80a of the battery 80 and the suction port of the low temperature-side pump 31.

In the interior air conditioning unit 50 in the refrigeration cooling mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the refrigeration cooling mode, a refrigeration cycle of a vapor compression type is so configured that the interior condenser 14 and the outdoor heat exchanger 16 are caused to function as a condenser; and the interior evaporator 18 and the chiller 20 are caused to function as an evaporator.

In the low temperature-side heating medium circuit 30 in the refrigeration cooling mode, a low temperature-side heating medium pressure fed from the low temperature-side pump 31 flows into the chiller 20 and is refrigerated there. The low temperature-side heating medium refrigerated at the chiller 20 passes through the cooling water channel 80a of the battery 80 and the battery 80 is thereby refrigerated.

In the interior air conditioning unit 50 in the refrigeration cooling mode, as in the single cooling mode, temperature-controlled ventilation air is blown out into the vehicle compartment and cooling of the interior of the vehicle compartment is thereby implemented.

### (b) Series Dehumidification Heating Mode

The series dehumidification heating mode is an operation mode in which refrigerated and dehumidified ventilation air is heated again and blown out into the vehicle compartment and the interior of the vehicle compartment is thereby dehumidified and heated. The control program in the present embodiment establishes the operation mode for dehumidifying and heating the interior of the vehicle compartment when the outside air temperature Tam is within an intermediate temperature range in which a cooling mode or a heating mode is less prone to be selected.

The series dehumidification heating mode includes: a single series dehumidification heating mode in which the interior of the vehicle compartment is dehumidified and heated without refrigerating the battery 80; and a refrigeration series dehumidification heating mode in which the battery 80 is refrigerated and the interior of the vehicle compartment is simultaneously dehumidified and heated.

(b-1) Single Series Dehumidification Heating Mode

In the heat pump cycle 10 in the single series dehumidification heating mode, the controller 60 brings the heating expansion valve 15a into a throttled state, the cooling expansion valve 15b into a throttled state, the refrigerating expansion valve 15a into a fully closed state, and the hot gas flow regulating valve 15d into a fully closed state. The controller 60 closes the dehumidifying on-off valve 23a and closes the heating on-off valve 23b.

For this reason, in the heat pump cycle 10 in the single series dehumidification heating mode, the refrigerant circuit is switched to a refrigerant circuit in which a refrigerant discharged from the compressor 11 circulates in the order of the muffler portion 12, the interior condenser 14, the throttled heating expansion valve 15a, the outdoor heat exchanger 16, the throttled cooling expansion valve 15b, the interior evaporator 18, the evaporator pressure control valve 19, the accumulator portion 21 and the suction port of the compressor 11.

In the interior air conditioning unit 50 in the single series dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the single series dehumidification heating mode, a refrigeration cycle of a vapor compression type is so configured that the interior condenser 14 is caused to function as a condenser; and the interior evaporator 18 is caused to function as an evaporator.

In the single series dehumidification heating mode, further, when a saturation temperature of a refrigerant in the outdoor heat exchanger 16 is higher than the outside air temperature Tam, the outdoor heat exchanger 16 is caused to function as a condenser. When a saturation temperature of a refrigerant in the outdoor heat exchanger 16 is lower than the outside air temperature Tam, the outdoor heat exchanger 16 is caused to function as an evaporator.

In the interior air conditioning unit 50 in the single series dehumidification heating mode, ventilation air sent from the interior blower 52 is refrigerated and dehumidified at the interior evaporator 18. Ventilation air refrigerated and dehumidified at the interior evaporator 18 is heated again at the interior condenser 14 so as to be brought closer to the target blowout temperature TAO according to an opening of the air mix door 54. Then the temperature-controlled ventilation air is blown out into the vehicle compartment and dehumidification and heating of the interior of the vehicle compartment are thereby implemented.

(b-2) Refrigeration Series Dehumidification Heating Mode

In the heat pump cycle 10 in the refrigeration series dehumidification heating mode, unlike the single series dehumidification heating mode, the controller 60 brings the refrigerating expansion valve 15c into a throttled state.

For this reason, in the heat pump cycle 10 in the refrigeration series dehumidification heating mode, a refrigerant discharged from the compressor 11 circulates as in the single series dehumidification heating mode. Simultaneously, the refrigerant circuit is switched to a refrigerant circuit in which a refrigerant discharged from the compressor 11 circulates in the order of the muffler portion 12, the interior condenser 14, the throttled heating expansion valve 15a, the outdoor heat exchanger 16, the throttled refrigerating expansion valve 15c, the chiller 20, the accumulator portion 21 and the suction port of the compressor 11. That is, the refrigerant circuit is switched to a refrigerant circuit in which the interior evaporator 18 and the chiller 20 are connected in parallel to a flow of a refrigerant.

In the low temperature-side heating medium circuit 30 in the refrigeration series dehumidification heating mode, an operation of the low temperature-side pump 31 is controlled as in the refrigeration cooling mode. For this reason, in the low temperature-side heating medium circuit 30 in the refrigeration series dehumidification heating mode, a low temperature-side heating medium circulates as in the refrigeration cooling mode.

In the interior air conditioning unit 50 in the refrigeration series dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the refrigeration series dehumidification heating mode, a refrigeration cycle of a vapor compression type is so configured that the interior condenser 14 is caused to function as a condenser; and the interior evaporator 18 and the chiller 20 are caused to function as an evaporator.

Further, in the refrigeration series dehumidification heating mode, as in the single series dehumidification heating mode, when a saturation temperature of a refrigerant in the outdoor heat exchanger 16 is higher than the outside air temperature Tam, the outdoor heat exchanger 16 is caused to function as a condenser. When a saturation temperature of a refrigerant in the outdoor heat exchanger 16 is lower than the outside air temperature Tam, the outdoor heat exchanger 16 is caused to function as the evaporator.

In the low temperature-side heating medium circuit 30 in the refrigeration series dehumidification heating mode, as in the refrigeration cooling mode, a low temperature-side heating medium refrigerated at the chiller 20 flows through the cooling water channel 80a of the battery 80 and the battery 80 is thereby refrigerated.

In the interior air conditioning unit 50 in the refrigeration series dehumidification heating mode, as in the single series dehumidification heating mode, temperature-controlled ventilation air is blown out into the vehicle compartment and dehumidification and heating of the interior of the vehicle compartment are thereby implemented.

### (c) Parallel Dehumidification Heating Mode

The parallel dehumidification heating mode is an operation mode in which refrigerated and dehumidified ventilation air is heated again with a higher heating capacity than in the series dehumidification heating mode and blown out into the vehicle compartment and dehumidification and heating of the interior of the vehicle compartment are thereby implemented.

The parallel dehumidification heating mode includes: a single parallel dehumidification heating mode in which the interior of the vehicle compartment is dehumidified and heated without refrigerating the battery 80; and a refrigeration parallel dehumidification heating mode in which the battery 80 is refrigerated and the interior of the vehicle compartment is simultaneously dehumidified and heated.

(c-1) Single Parallel Dehumidification Heating Mode

The heat pump cycle 10 in the single parallel dehumidification heating mode, the controller 60 brings the heating expansion valve 15a into a throttled state, the cooling expansion valve 15b into a throttled state, the refrigerating expansion valve 15c into a fully closed state, and the hot gas flow regulating valve 15d into a fully closed state. The controller 60 opens the dehumidifying on-off valve 23a and opens the heating on-off valve 23b.

For this reason, in the heat pump cycle 10 in the single parallel dehumidification heating mode, a refrigerant discharged from the compressor 11 circulates in the order of the muffler portion 12, the interior condenser 14, the throttled heating expansion valve 15a, the outdoor heat exchanger 16, the heating channel 22c, the accumulator portion 21 and the suction port of the compressor 11. Simultaneously, the refrigerant circuit is switched to a refrigerant circuit in which a refrigerant discharged from the compressor 11 circulates in the order of the muffler portion 12, the interior condenser 14, the dehumidifying channel 22b, the throttled cooling expansion valve 15b, the interior evaporator 18, the evaporator pressure control valve 19, the accumulator portion 21 and the suction port of the compressor 11. That is, the refrigerant circuit is switched to a refrigerant circuit in which the outdoor heat exchanger 16 and the interior evaporator 18 are connected in parallel to a flow of a refrigerant.

In the interior air conditioning unit 50 in the single parallel dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the single parallel dehumidification heating mode, a refrigeration cycle of a vapor compression type is so configured that the interior condenser 14 is caused to function as a condenser; and the outdoor heat exchanger 16 and the interior evaporator 18 are caused to function as an evaporator.

In the interior air conditioning unit 50 in the single parallel dehumidification heating mode, ventilation air sent from the interior blower 52 is refrigerated and dehumidified at the interior evaporator 18. Ventilation air refrigerated and dehumidified at the interior evaporator 18 is heated again at the interior condenser 14 so as to be brought closer to the target blowout temperature TAO according to an opening of the air mix door 54. Then the temperature-controlled ventilation air is blown out into the vehicle compartment and dehumidification and heating of the interior of the vehicle compartment are thereby implemented.

In the heat pump cycle 10 in the single parallel dehumidification heating mode, a throttle opening of the heating expansion valve 15a can be reduced to a smaller value than a throttle opening of the cooling expansion valve 15b. According to the foregoing, a refrigerant evaporation temperature in the outdoor heat exchanger 16 can be lowered to a lower temperature than a refrigerant evaporation temperature in the interior evaporator 18.

Therefore, in the single parallel dehumidification heating mode, an amount of heat absorption of refrigerant from the outside air at the outdoor heat exchanger 16 can be more increased than in the single series dehumidification heating mode to increase an amount of heat radiated from a refrigerant to ventilation air at the interior condenser 14. As a result, in the single parallel dehumidification heating mode, a heating capacity of ventilation air at the interior condenser 14 can be enhanced and made higher than in the single series dehumidification heating mode.

(c-2) Refrigeration Parallel Dehumidification Heating Mode

In the heat pump cycle 10 in the refrigeration parallel dehumidification heating mode, unlike the single parallel dehumidification heating mode, the controller 60 brings the refrigerating expansion valve 15c into a throttled state.

For this reason, in the heat pump cycle 10 in the refrigeration parallel dehumidification heating mode, a refrigerant discharged from the compressor 11 circulates as in the single parallel dehumidification heating mode. Simultaneously, the refrigerant circuit is switched to a refrigerant circuit in which a refrigerant discharged from the compressor 11 circulates in the order of the muffler portion 12, the interior condenser 14, the dehumidifying channel 22b, the throttled refrigerating expansion valve 15c, the chiller 20, the accumulator portion 21 and the suction port of the compressor 11. That is, the refrigerant circuit is switched to a refrigerant circuit in which the outdoor heat exchanger 16, the interior evaporator 18, and the chiller 20 are connected in parallel to a flow of a refrigerant.

In the low temperature-side heating medium circuit 30 in the refrigeration parallel dehumidification heating mode, an operation of the low temperature-side pump 31 is controlled as in the refrigeration cooling mode. For this reason, in the low temperature-side heating medium circuit 30 in the refrigeration series dehumidification heating mode, a low temperature-side heating medium circulates as in the refrigeration cooling mode.

In the interior air conditioning unit 50 in the refrigeration parallel dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the refrigeration parallel dehumidification heating mode, a refrigeration cycle of a vapor compression type is so configured that the interior condenser 14 is caused to function as a condenser; and the outdoor heat exchanger 16, the interior evaporator 18 and the chiller 20 are caused to function as an evaporator.

In the low temperature-side heating medium circuit 30 in the refrigeration parallel dehumidification heating mode, as in the refrigeration cooling mode, a low temperature-side heating medium refrigerated at the chiller 20 flows through the cooling water channel 80a of the battery 80 and the battery 80 is thereby refrigerated.

In the interior air conditioning unit 50 in the refrigeration parallel dehumidification heating mode, as in the single parallel dehumidification heating mode, temperature-controlled ventilation air is blown out into the vehicle compartment and dehumidification and heating of the interior of the vehicle compartment are thereby implemented.

### (d) Heating Mode

The heating mode is an operation mode in which the interior of the vehicle compartment is heated by blowing heated ventilation air out into the vehicle compartment. The control program in the present embodiment establishes the operation mode for heating the interior of the vehicle compartment mainly when the outside air temperature Tam is relatively low as in winter seasons.

The heating mode includes: a single heating mode in which the interior of the vehicle compartment is heated without refrigerating the battery 80; and a refrigeration heating mode in which the battery 80 is refrigerated and the interior of the vehicle compartment is simultaneously heated.

(d-1) Single Heating Mode

In the heat pump cycle 10 in the single heating mode, the controller 60 brings the heating expansion valve 15a into a throttled state, the cooling expansion valve 15b into a fully closed state, the refrigerating expansion valve 15c into a fully closed state, and the hot gas flow regulating valve 15d into a fully closed state. The controller 60 closes the dehumidifying on-off valve 23a and opens the heating on-off valve 23b.

For this reason, in the heat pump cycle 10 in the single heating mode, the refrigerant circuit is switched to a refrigerant circuit in which a refrigerant discharged from the compressor 11 circulates in the order of the muffler portion 12, the interior condenser 14, the throttled heating expansion valve 15a, the outdoor heat exchanger 16, the heating channel 22c, the accumulator portion 21 and the suction port of the compressor 11.

In the interior air conditioning unit 50 in the single heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the single heating mode, a refrigeration cycle of a vapor compression type is so configured that the interior condenser 14 is caused to function as a condenser; and the outdoor heat exchanger 16 is caused to function as an evaporator.

In the interior air conditioning unit 50 in the single heating mode, ventilation air sent from the interior blower 52 passes through the interior evaporator 18. The ventilation air that passed through the interior evaporator 18 is heated again at the interior condenser 14 so as to be brought closer to the target blowout temperature TAO according to an opening of the air mix door 54. Temperature-controlled ventilation air is blown out into the vehicle compartment and heating of the interior of the vehicle compartment is thereby implemented.

(d-2) Refrigeration Heating Mode

In the heat pump cycle 10 in the refrigeration heating mode, unlike the single heating mode, the controller 60 brings the refrigerating expansion valve 15c into a throttled state. The controller 60 opens the dehumidifying on-off valve 23a.

For this reason, in the heat pump cycle 10 in the refrigeration heating mode, a refrigerant discharged from the compressor 11 circulates as in the single heating mode. Simultaneously, the refrigerant circuit is switched to a refrigerant circuit in which a refrigerant discharged from the compressor 11 circulates in the order of the muffler portion 12, the interior condenser 14, the dehumidifying channel 22b, the throttled refrigerating expansion valve 15c, the chiller 20, the accumulator portion 21 and the suction port of the compressor 11. That is, the refrigerant circuit is switched to a refrigerant circuit in which the outdoor heat exchanger 16 and the chiller 20 are connected in parallel to a flow of a refrigerant.

In the low temperature-side heating medium circuit 30 in the refrigeration parallel dehumidification heating mode, an operation of the low temperature-side pump 31 is controlled as in the refrigeration cooling mode. For this reason, in the low temperature-side heating medium circuit 30 in the refrigeration series dehumidification heating mode, a low temperature-side heating medium circulates as in the refrigeration cooling mode.

In the interior air conditioning unit 50 in the refrigeration parallel dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the refrigeration heating mode, a refrigeration cycle of a vapor compression type is so configured that the interior condenser 14 is caused to function as a condenser; and the outdoor heat exchanger 16 and the chiller 20 are caused to function as an evaporator.

In the low temperature-side heating medium circuit 30 in the refrigeration heating mode, as in the refrigeration cooling mode, a low temperature-side heating medium refrigerated at the chiller 20 flows through the cooling water channel 80a of the battery 80 and the battery 80 is thereby refrigerated.

In the interior air conditioning unit 50 in the refrigeration heating mode, as in the single heating mode, temperature-controlled ventilation air is blown out into the vehicle compartment and heating of the interior of the vehicle compartment is thereby implemented.

(e-1) Hot Gas Heating Mode

The hot gas heating mode is an operation mode established for suppressing degradation in heating capacity in the vehicle compartment when the outside air temperature Tam becomes a cryogenic temperature (for example, −20° C. or below).

In the hot gas heating mode, the controller 60 brings the heating expansion valve 15a into a fully closed state, the cooling expansion valve 15b into a fully closed state, the refrigerating expansion valve 15c into a throttled state, and the hot gas flow regulating valve 15d into a throttled state. Further, the controller 60 opens the dehumidifying on-off valve 23a and closes the heating on-off valve 23b.

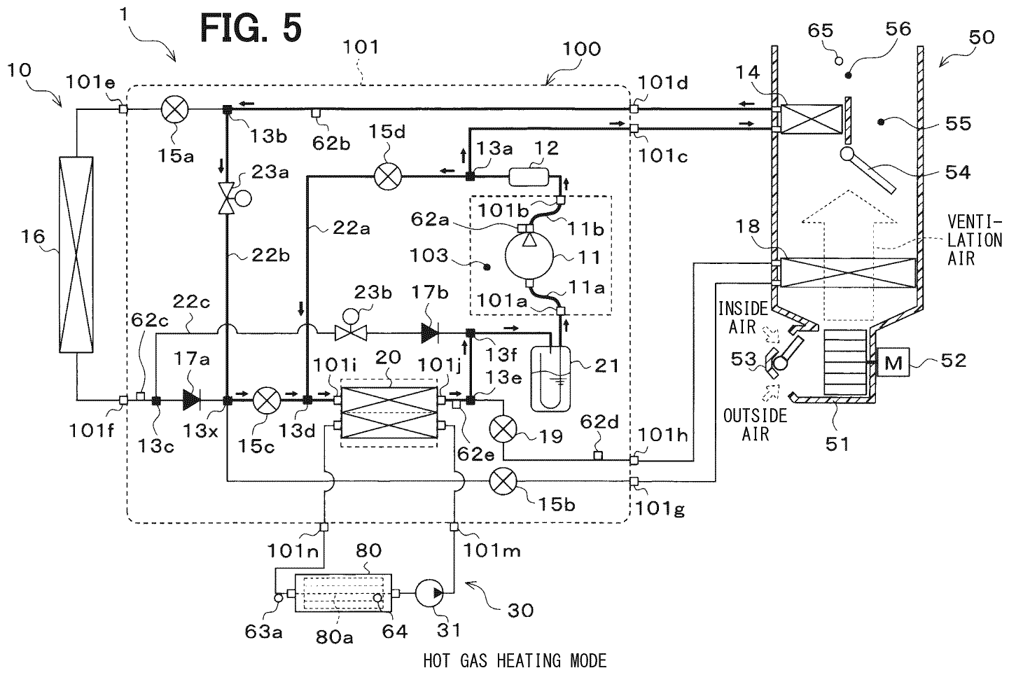

For this reason, in the heat pump cycle 10 in the hot gas heating mode, as indicated by the solid line arrows in FIG. 5, a refrigerant discharged from the compressor 11 circulates in the order of the muffler portion 12, the interior condenser 14, the dehumidifying channel 22b, the throttled refrigerating expansion valve 15c, the chiller 20, the accumulator portion 21 and the suction port of the compressor 11. Simultaneously, the refrigerant circuit is switched to a refrigerant circuit in which a refrigerant discharged from the compressor 11 circulates in the order of the muffler portion 12, the throttled hot gas flow regulating valve 15d in the hot gas channel 22a, the chiller 20, the accumulator portion 21 and the suction port of the compressor 11.

In the low temperature-side heating medium circuit 30 in the hot gas heating mode, the low temperature-side pump 31 is stopped. In the interior air conditioning unit 50 in the hot gas heating mode, as in the single cooling mode, operations of the air mix door 54, the inside/outside air switching device 53 and the blowing mode door are controlled. The controller 60 further controls operations of other devices to be controlled as appropriate.

Therefore, in the heat pump cycle 10 in the hot gas heating mode, a flow of a refrigerant discharged from the compressor 11 is branched at the first internal three-way joint 13a.

One refrigerant branched at the first internal three-way joint 13a flows into the interior condenser 14 and radiates heat to ventilation air. As a result, the ventilation air is heated. The refrigerant that flowed out of the interior condenser 14 flows into the refrigerating expansion valve 15c through the dehumidifying channel 22b and is depressurized there. The refrigerant depressurized at the refrigerating expansion valve 15c and relatively low in enthalpy flows into the chiller 20 through the fourth internal three-way joint 13d.

Meanwhile, the other refrigerant branched at the first internal three-way joint 13a has a flow rate thereof regulated at the hot gas flow regulating valve 15d and is depressurized there. The refrigerant depressurized at the hot gas flow regulating valve 15d and relatively high in enthalpy flows into the chiller 20 through the fourth internal three-way joint 13d.

At the chiller 20, the refrigerant depressurized at the refrigerating expansion valve 15c and the refrigerant depressurized at the hot gas flow regulating valve 15d are mixed together. Since the low temperature-side pump 31 is at a stop at this time, at the chiller 20, a refrigerant and a low temperature-side heating medium do not exchange heat. A refrigerant flowing out of the chiller 20 flows into the accumulator portion 21 and is separated into gas and liquid there. A vapor-phase refrigerant separated at the accumulator portion 21 is sucked into the compressor 11 and is compressed again there.

In the interior air conditioning unit 50 in the hot gas heating mode, ventilation air sent from the interior blower 52 passes through the interior evaporator 18. The ventilation air that passed through the interior evaporator 18 is heated at the interior condenser 14 according to an opening of the air mix door 54. Ventilation air heated at the interior condenser 14 is blown out into the vehicle compartment and heating of the interior of the vehicle compartment is thereby implemented.

More specifically, the hot gas heating mode is an operation mode established at a cryogenic outside air temperature; therefore, when a refrigerant flowing out of the interior condenser 14 is let to flow into the outdoor heat exchanger 16, the refrigerant can radiate heat to the outside air and this can lead to degradation in an enthalpy of the refrigerant. For this reason, when a refrigerant flowing out of the interior condenser 14 is let to flow into the outdoor heat exchanger 16, an enthalpy of a refrigerant flowing into the chiller 20 is also prone to be degraded.

Further, if a refrigerant radiates heat to the outside air at the outdoor heat exchanger 16, an amount of heat radiated by the refrigerant to ventilation air at the interior condenser 14 will be reduced; therefore, the heating capacity of ventilation air can be degraded.

In the hot gas heating mode, meanwhile, a refrigerant flowing out of the interior condenser 14 is not let to flow into the outdoor heat exchanger 16 but is let to flow into the refrigerating expansion valve 15c. Further, the low temperature-side pump 31 is stopped to prevent heat exchange between a refrigerant and a low temperature-side heating medium at the chiller 20. In addition, at the chiller 20, a refrigerant depressurized at the refrigerating expansion valve 15c and a refrigerant depressurized at the hot gas flow regulating valve 15d are mixed together.

Therefore, in the heat pump cycle 10 in the hot gas heating mode, even though the refrigerant discharge capacity of the compressor 11 is increased as compared with the heating mode, a suction-side refrigerant let to flow out from the chiller 20 to the suction port side of the compressor 11 can be made a vapor-phase refrigerant having a degree of superheat. By increasing a compression workload of the compressor 11, reduction in an amount of heat radiated from a refrigerant to ventilation air at the interior condenser 14 can be suppressed.

As a result, in the hot gas heating mode, heating of the interior of the vehicle compartment can be implemented while degradation in the heating capacity of ventilation air is suppressed.

Since the hot gas heating mode is an operation mode established at a cryogenic outside air temperature, the battery 80 need not be refrigerated. At a low outside air temperature, meanwhile, warm-up of the battery 80 may be required. In the vehicle air conditioner 1 in the present embodiment, consequently, a warm-up hot gas heating mode for warming up the battery 80 as an in-vehicle device can be performed.

A more specific description will be given. In the vehicle air conditioner 1 in the present embodiment, when the hot gas heating mode is in process and a battery temperature TB detected by the battery temperature sensor 64 becomes equal to or below a predetermined reference lower limit temperature KTBL, the warm-up hot gas heating mode is established.

(e-2) Warm-Up Hot Gas Heating Mode

In the low temperature-side heating medium circuit 30 in the warm-up hot gas heating mode, the controller 60 actuates the low temperature-side pump 31 so as to exhibit a predetermined reference pressure feed capacity. For this reason, in the low temperature-side heating medium circuit 30, a low temperature-side heating medium pressure fed from the low temperature-side pump 31 circulates in the order of the heating medium channel of the chiller 20 to the cooling water channel 80a of the battery 80. The other operations are the same as in the hot gas heating mode.

Therefore, in the heat pump cycle 10 in the warm-up hot gas heating mode, a refrigerant flowing into the chiller 20 radiates heat to a low temperature-side heating medium. As a result, the low temperature-side heating medium is heated. In the low temperature-side heating medium circuit 30 in the warm-up hot gas heating mode, a low temperature-side heating medium heated at the chiller 20 flows through the cooling water channel 80a of the battery 80. As a result, the battery 80 is warmed up.

### (f) Single Cooling Mode

The single refrigerating mode is an operation mode in which the battery 80 is refrigerated without performing air conditioning in the vehicle compartment.

In the heat pump cycle 10 in the single refrigerating mode, the controller 60 brings the heating expansion valve 15a into a fully opened state, the cooling expansion valve 15b into a fully closed state, the refrigerating expansion valve 15c into a throttled state, and the hot gas flow regulating valve 15d into a fully closed state. The controller 60 closes the dehumidifying on-off valve 23a and closes the heating on-off valve 23b.

For this reason, in the heat pump cycle 10 in the single refrigerating mode, the refrigerant circuit is switched to a refrigerant circuit in which a refrigerant discharged from the compressor 11 circulates in the order of the muffler portion 12, the interior condenser 14, the fully opened heating expansion valve 15, the outdoor heat exchanger 16, the throttled refrigerating expansion valve 15c, the chiller 20, the accumulator portion 21 and the suction port of the compressor 11.

In the low temperature-side heating medium circuit 30 in the single refrigerating mode, a low temperature-side heating medium pressure fed from the low temperature-side pump 31 circulates as in the refrigeration cooling mode. In the interior air conditioning unit 50 in the single refrigerating mode, the interior blower 52 is stopped.

Therefore, in the heat pump cycle 10 in the single refrigeration mode, a refrigeration cycle of a vapor compression type is so configured that the outdoor heat exchanger 16 is caused to function as a condenser and the chiller 20 is caused to function as an evaporator.

In the low temperature-side heating medium circuit 30 in the single refrigerating mode, as in the refrigeration cooling mode, a low temperature-side heating medium refrigerated at the chiller 20 flows through the cooling water channel 80a of the battery 80 and the battery 80 is thereby refrigerated.

As described up to this point, in the vehicle air conditioner 1 in the present embodiment, comfortable air conditioning in the vehicle compartment and appropriate temperature control of the battery 80 as an in-vehicle device can be performed by switching operation modes.

Further, since the present embodiment adopts the compressor module 100, noise of the compressor 11 can be sufficiently suppressed without incurring degradation in the productivity of the vehicle air conditioner 1 as a heat pump cycle.

More specifically, in the compressor module 100, a refrigerant discharged from the compressor 11 can be let to flow out to the side of the external component devices, such as the interior condenser 14, the outdoor heat exchanger 16, and the interior evaporator 18, through an internal refrigerant channel of the channel box 101. Similarly, a refrigerant flowing out of an external component device can be sucked into the compressor 11 through an internal refrigerant channel of the channel box 101.

Therefore, a through hole or the like for passing piping for connecting the compressor 11 and an external component device need not be formed in the channel box 101 or the cover member 102. For this reason, noise of the compressor 11 is prevented from leaking to the outside of the housing space 103 through a gap between the through hole and the piping. Further, a gap between the through hole and the piping need not be closed with the soundproofing sealing member or the like.

As a result, noise can be sufficiently suppressed without incurring degradation in the productivity of the heat pump cycle 1. Further, since in the compressor module 100 in the present embodiment, the housing space 103 is formed as a sealed space, noise of the compressor 11 is prevented from leaking to outside the housing space 103 through any other gap.

The low-pressure hose 11a and the high-pressure hose 11b of the compressor module 100 in the present embodiment have flexibility and include an elastically deformable refrigerant hose portion. The low-pressure hose 11a and the high-pressure hose 11b are attached to the compressor 11 and the channel box 101 as are curved.

According to the foregoing, vibration of the compressor 11 can be suppressed from being transmitted to the channel box 101 or the cover member 102 through the low-pressure hose 11a and the high-pressure hose 11b. Therefore, the channel box 101 or the cover member 102 can be suppressed from producing noise due to vibration transmitted from the compressor 11.

In the compressor module 100 in the present embodiment, a thermoplastic rubber vibration insulator 11c is disposed between the compressor 11 and the fixing portions 101s of the channel box 101. Heat of the compressor 11 can be transferred to the rubber vibration insulators 11c to heat the rubber vibration insulators 11c.

According to the foregoing, even at a low outside air temperature, heat of the compressor 11 can be transferred to the rubber vibration insulators 11c to heat the rubber vibration insulators 11c and degradation in the elasticity of the rubber vibration insulators 11c can be thereby suppressed. Therefore, the channel box 101 and the cover member 102 can be effectively suppressed from producing noise because of transmission of vibration from the compressor 11 to the channel box 101 or the cover member 102.

The compressor module 100 in the present embodiment is provided with the heat insulating material 104. According to the foregoing, even at a low outside air temperature, heat in the hosing space 103 can be suppressed from being unnecessarily radiated from an outer side face of the compressor module 100. This is advantageous in a heat pump cycle that must be operated even at a cryogenic outside air temperature. Further, a higher soundproof effect can be brought about by the heat insulating material 104.

In the present embodiment, in addition, the heat insulating material 104 is disposed on the outer side faces of the compressor module 100. Therefore, the heat insulating material 104 can be easily attached to the compressor module 100, for example, by sticking a heat insulating material formed in a sheet to the outer side faces of the compressor module 100.

In the heat pump cycle 1 in the present embodiment, in the hot gas heating mode, the refrigerant circuit of the heat pump cycle 10 is switched to a refrigerant circuit in which a refrigerant flowing out of the interior condenser 14 and the other refrigerant branched at the first internal three-way joint 13a are merged and sucked into the compressor 11.

Since the hot gas heating mode is an operation mode established at a cryogenic outside air temperature, a refrigerant discharge capacity (that is, a number of revolutions) of the compressor 11 is increased to a higher value than in the heating mode. For this reason, noise of the compressor 11 is also prone to increase. Therefore, application of the compressor module 100 to a heat pump cycle capable of performing the hot gas heating mode is very effective for noise suppression.

### Second Embodiment

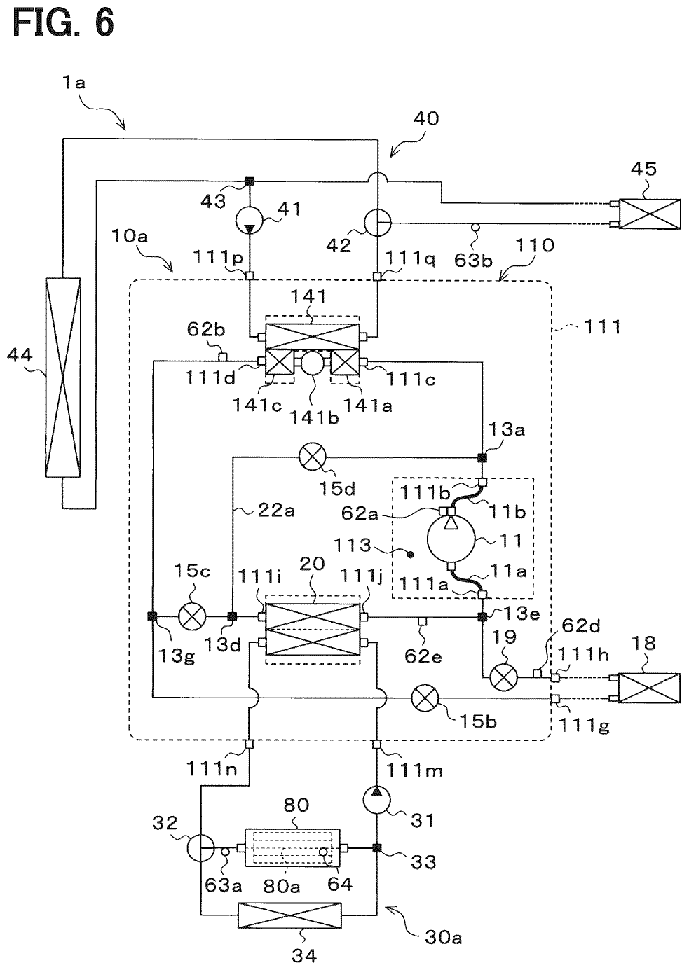

In relation to the present embodiment, a description will be given to an example in which a compressor module 110 according to the present disclosure is applied to a vehicle air conditioner 1a whose overall configuration diagram is shown in FIG. 6. Like the vehicle air conditioner 1 descried in relation to the first embodiment, the vehicle air conditioner 1a is a heat pump cycle that performs air conditioning in the vehicle compartment and temperature control of in-vehicle devices. In FIG. 6, the interior air conditioning unit 50 is omitted for the sake of clarification of the drawing.

The vehicle air conditioner 1a includes a high temperature-side heating medium circuit 40 in addition to a heat pump cycle 10a, a low temperature-side heating medium circuit 30a, the interior air conditioning unit 50, and the like.

In the heat pump cycle 10a in the present embodiment, unlike the heat pump cycle 10 described in relation to the first embodiment, the muffler portion 12, interior condenser 14, heating expansion valve 15a, outdoor heat exchanger 16, dehumidifying channel 22b, heating channel 22c, dehumidifying on-off valve 23a, heating on-off valve 23b, and the like are abolished.

The compressor module 110 is a component in which a plurality of component devices constituting the heat pump cycle 10a are mainly integrated. In the compressor module 110 in the present embodiment, the component devices and the like encircled with the broken line in FIG. 6 are integrated.

More specifically, in the compressor module 110 in the present embodiment, of the component devices of the heat pump cycle 10a, the compressor 11, a water refrigerant heat exchanger 141, the cooling expansion valve 15b, the refrigerating expansion valve 15c, the hot gas flow regulating valve 15d, the evaporator pressure control valve 19, the chiller 20, and the like are integrated.

These component devices are integrated by being attached to a channel box 111 of the compressor module 110. A receiver portion 141b of the water refrigerant heat exchanger 141 is integrally formed in the channel box 111. The channel box 111 is a mounting member like the channel box 101 described in relation to the first embodiment and is a channel forming member.

As in the first embodiment, a compressor-side inlet 111b formed in the channel box 111 is connected to the discharge port of the compressor 11 of the heat pump cycle 10a through a high-pressure hose 11b. The compressor-side inlet 111b communicates to the inflow port of the first internal three-way joint 13a through an internal refrigerant channel.

One outflow port of the first internal three-way joint 13a communicates to a condenser-side outlet 111c formed in the channel box 111 through an internal refrigerant channel. The other outflow port of the first internal three-way joint 13a communicates to one inflow port of the fourth internal three-way joint 13d through the hot gas channel 22a. As in the first embodiment, the hot gas flow regulating valve 15d is disposed in the hot gas channel 22a.

An inlet of a refrigerant channel of the water refrigerant heat exchanger 141 is connected directly to the condenser-side outlet 111c. More specifically, an inlet of a condensing portion 141a of the water refrigerant heat exchanger 141 is directly connected. The water refrigerant heat exchanger 141 is a heat exchange portion that causes heat exchange between a refrigerant discharged from the compressor 11 and a high temperature-side heating medium circulating in the high temperature-side heating medium circuit 40.

In the heat pump cycle 10a, a so-called subcool type heat exchanger is adopted as the water refrigerant heat exchanger 141. For this reason, the water refrigerant heat exchanger 141 includes the condensing portion 141a, the receiver portion 141b, and a supercooling portion 141c.

The condensing portion 141a is a condensing heat exchange portion that causes heat exchange between a refrigerant discharged from the compressor 11 and a high pressure-side heating medium to condense a high pressure-side refrigerant. An inlet of the receiver portion 141b formed in the channel box 111 is connected to the refrigerant outlet of the condensing portion 141a.

The receiver portion 141b is a high pressure-side gas-liquid separating portion that separates a refrigerant flowing out of the condensing portion 141a into gas and liquid and accumulates a separated liquid-phase refrigerant as a surplus refrigerant in the cycle. The refrigerant inlet of the supercooling portion 141c is connected to an outlet of the receiver portion 141b formed in the channel box 111.

The supercooling portion 141c is a supercooling heat exchange portion that causes heat exchange between a liquid-phase refrigerant flowing out of the receiver portion 141b and a high pressure-side heating medium to supercool the liquid-phase refrigerant. Therefore, the water refrigerant heat exchanger 141 including the receiver portion 141b is a high pressure-side refrigerant device.

The condenser-side inlet 111d formed in the channel box 111 is connected directly to the outlet of the supercooling portion 141c of the water refrigerant heat exchanger 141. The condenser-side inlet 111d communicates to the inflow port of a seventh internal three-way joint 13g through an internal refrigerant channel.

One outflow port of the seventh internal three-way joint 13g communicates to an evaporator-side outlet 111g formed in the channel box 111 through an internal refrigerant channel. The cooling expansion valve 15b is disposed in the internal refrigerant channel extending from one outflow port of the seventh internal three-way joint 13g to the evaporator-side outlet 111g.

The refrigerant inlet side of the interior evaporator 18 is connected to the evaporator-side outlet 111g. The side of an evaporator-side inlet 111h formed in the channel box 111 is connected to the refrigerant outlet of the interior evaporator 18.

The other outflow port of the seventh internal three-way joint 13g communicates to the other inflow port of the fourth internal three-way joint 13d through an internal refrigerant channel. The refrigerating expansion valve 15c is disposed in the internal refrigerant channel extending from the other outflow port of the seventh internal three-way joint 13g to the other inflow port of the fourth internal three-way joint 13d.

The outflow port of the fourth internal three-way joint 13d communicates to a chiller-side outlet 111i formed in the channel box 111. The refrigerant inlet of the chiller 20 is connected directly to the chiller-side outlet 111i. The chiller-side inlet 111j formed in the channel box 111 is connected directly to the refrigerant outlet of the chiller 20. The other configuration elements of the heat pump cycle 10a are the same as those of the heat pump cycle 10 described in relation to the first embodiment.

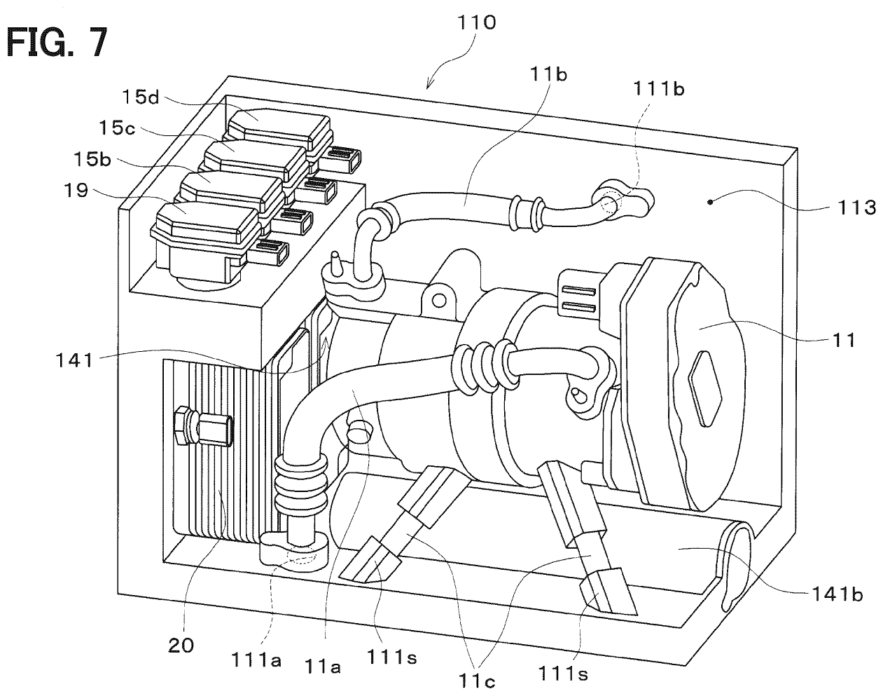

A detailed description will be given to a configuration of the compressor module 110 with reference to FIG. 7. The basic configuration of the compressor module 110 is the same as that the compressor module 100 described in relation to the first embodiment. The compressor module 110 includes the channel box 111 made of metal. Further, the compressor module 110 includes a cover member, not shown, made of resin.

As in the first embodiment, the cover member forms a housing space 113 that is a sealed space for housing the compressor 11 and the like in the compressor module 110 by being attached to the channel box 111. The appearance of the compressor module 110 is also in a rectangular parallelepiped shape as in the first embodiment. As in the first embodiment, a heat insulating material, not shown, is disposed on the outer side faces of the compressor module 110.

In the housing space 113, the water refrigerant heat exchanger 141, cooling expansion valve 15b, refrigerating expansion valve 15c, hot gas flow regulating valve 15d, evaporator pressure control valve 19, and chiller 20 are housed in addition to the compressor 11.

For this reason, the compressor-side outlet 111a, compressor-side inlet 111b, condenser-side outlet 111c, condenser-side inlet 111d, chiller-side outlet 111i, and chiller side inlet 111j are formed in the housing space 113. More specifically, the compressor-side outlet 111a and the compressor-side inlet 111b are formed in inner side faces of the housing space 113 side of the channel box 111 and thus formed in the housing space 113.

The interior evaporator 18 is disposed outside the housing space 113. Therefore, in the present embodiment, the interior evaporator 18 is an external component device. The evaporator-side outlet 111g and the evaporator-side inlet 111h are formed in an outer side face on the outer circumferential side of the channel box 111 and are consequently formed outside the housing space 113. Therefore, in the present embodiment, the evaporator-side outlet 111g and the evaporator-side inlet 111h is the outside connection port.

As in the first embodiment, the compressor 11 is fixed to a plurality (four in the present embodiment) of fixing portions 111s formed on the bottom face forming the housing space 113 of the channel box 111 through a rubber vibration insulator 11c.

The water refrigerant heat exchanger 141 is fixed to the channel box 111 by a refrigerant inlet/outlet and a heating medium inlet/outlet so formed as to protrude to the outside being respectively fit into a refrigerant inlet/outlet (that is, the condenser-side outlet 111c, the condenser-side inlet 111d, and the like) and a heating medium inlet/outlet formed in the channel box 111.

The receiver portion 141b is formed in such a shape as to swell to the housing space 113 side for forming a liquid storage space. The receiver portion 141b is disposed in the bottom face of the channel box 111 so that the receiver portion is encircled with the fixing portions 111s. In other words, the fixing portions 111s are disposed around the area where the receiver portion 141b is formed.

As a result, in the compressor module 110, heat of a high pressure-side refrigerant in the receiver portion 141b can be transferred to the rubber vibration insulators 11c to heat the rubber vibration insulators 11c. In other words, the rubber vibration insulators 11c are so disposed that the rubber vibration insulators can be heated by heat of a high pressure-side refrigerant in the receiver portion 141b. Fixation and electrical connection of the other component devices are the same as those in the first embodiment.

Next, a description will be given to the low temperature-side heating medium circuit 30a. The low temperature-side heating medium circuit 30a is so configured that heating medium circuits can be switched according to various operation modes described later. As shown in FIG. 6, the low temperature-side pump 31, a low temperature-side flow regulating valve 32, a low temperature-side radiator 34, the cooling water channel 80a of the battery 80, the heating medium channel of the chiller 20 of the compressor module 110, and the like are connected to the low temperature-side heating medium circuit 30a.

The low temperature-side pump 31 in the present embodiment pressure feeds a low temperature-side heating medium flowing out of a low temperature-side three-way joint 33 to the side of a low temperature-side heating medium inlet 111m formed in the channel box 111 of the compressor module 110. The low temperature-side three-way joint 33 is a low temperature-side heating medium three-way joint having three inflow and outflow ports communicating to one another.

The low temperature-side heating medium inlet 111m communicates to an inlet of the heating medium channel of the chiller 20 through an internal heating medium channel. An outlet of the heating medium channel of the chiller 20 communicates to a low temperature-side heating medium outlet 111n formed in the channel box 111 through an internal heating medium channel.

An inflow port of the low temperature-side flow regulating valve 32 is connected to the low temperature-side heating medium outlet 111n. The inlet side of the cooling water channel 80a of the battery 80 is connected to one outflow port of the low temperature-side flow regulating valve 32. The heating medium inlet side of the low temperature-side radiator 34 is connected to the other outflow port of the low temperature-side flow regulating valve 32.

The low temperature-side flow regulating valve 32 is a three-direction system low temperature-side heating medium flow regulating portion that can continuously adjust a flow rate ratio between a flow rate to be let to flow out to the side of the cooling water channel 80a of the battery 80 and a flow rate to be let to flow out to the low temperature-side radiator 34 side with respect to a low temperature-side heating medium flowing out of the low temperature-side heating medium outlet 111n. An operation of the low temperature-side flow regulating valve 32 is controlled according to a control signal outputted from the controller 60. The low temperature-side flow regulating valve 32 is included in the electrical devices.

The low temperature-side flow regulating valve 32 can be caused to let a low temperature-side heating medium flow out to only either the cooling water channel 80a of the battery 80 or the low temperature-side radiator 34 by adjusting a flow rate ratio. Therefore, the low temperature-side flow regulating valve 32 is a low temperature-side heating medium circuit switching portion that switches a circuit configuration of the low temperature-side heating medium circuit 30a.

The low temperature-side radiator 34 is a heat exchange portion that causes heat exchange between a low temperature-side heating medium and outside air. The low temperature-side radiator 34, together with a high temperature-side radiator 44, described later, is disposed in a driving gear room. One inflow port of the low temperature-side three-way joint 33 is connected to the heating medium outlet of the low temperature-side radiator 34. The other inflow port of the low temperature-side three-way joint 33 is connected to the outlet of the cooling water channel 80a of the battery 80.

Next, a description will be given to the high temperature-side heating medium circuit 40. The high temperature-side heating medium circuit 40 is a heating medium circuit for circulating a high temperature-side heating medium. In the high temperature-side heating medium circuit 40, a fluid of the same type as a low temperature-side heating medium is adopted as the high temperature-side heating medium. The high temperature-side heating medium circuit 40 is so configured that heating medium circuits can be switched according to various operation modes described later.

As shown in FIG. 6, the high temperature-side pump 41, the high temperature-side flow regulating valve 42, the high temperature-side radiator 44, a heater core 45, the heating medium channel of the water refrigerant heat exchanger 141 of the compressor module 110, and the like are connected to the high temperature-side heating medium circuit 40.

The high temperature-side pump 41 is a high temperature-side heating medium pressure feed portion that sucks and pressure feeds a high temperature-side heating medium. The high temperature-side pump 41 pressure feeds a high temperature-side heating medium flowing out of the outflow port of a high temperature-side three-way joint 43 to the side of a high temperature-side heating medium inlet 111p formed in the channel box 111 of the compressor module 110. The basic configuration of the high temperature-side pump 41 is the same as that of the low temperature-side pump 31. The basic configuration of the high temperature-side three-way joint 43 is the same as that of the low temperature-side three-way joint 33.

The high temperature-side heating medium inlet 111p communicates to the inlet of the heating medium channel of the water refrigerant heat exchanger 141 through an internal heating medium channel. The outlet of the heating medium channel of the water refrigerant heat exchanger 141 communicates to a high temperature-side heating medium outlet 111q formed in the channel box 111 through an internal heating medium channel.

The inflow port of the high temperature-side flow regulating valve 42 is connected to the high temperature-side heating medium outlet 111q. The heating medium inlet side of the high temperature-side radiator 44 is connected to one outflow port of the high temperature-side flow regulating valve 42. The heating medium inlet side of the heater core 45 is connected to the other outflow port of the high temperature-side flow regulating valve 42.

The high temperature-side flow regulating valve 42 is a three-direction system high temperature-side heating medium flow regulating portion that can continuously adjust a flow rate ratio between a flow rate to be let to flow out to the high temperature-side radiator 44 side and a flow rate to be let to flow out to the heater core 45 side with respect to a high temperature-side heating medium flowing out of the high temperature-side heating medium outlet 111q. The basic configuration of the high temperature-side flow regulating valve 42 is the same as that of the low temperature-side flow regulating valve 32.

The high temperature-side flow regulating valve 42 can be caused to let a high temperature-side heating medium out to only either the high temperature-side radiator 44 or the heater core 45 by adjusting a flow rate ratio. Therefore, the high temperature-side flow regulating valve 42 is a high temperature-side heating medium circuit switching portion that switches a circuit configuration of the high temperature-side heating medium circuit 40.

The high temperature-side radiator 44 is a heat exchange portion that causes heat exchange between a high temperature-side heating medium and outside air. The high temperature-side radiator 44, together with the low temperature-side radiator 34, is disposed in a driving gear room. In the driving gear room, the high temperature-side radiator 44 is disposed on the upstream side of an outside air flow in the low temperature-side radiator 34. For this reason, in the low temperature-side radiator 34, heat is exchanged between a low temperature-side heating medium and outside air that passed through the high temperature-side radiator 44.

The heater core 45 is disposed in the air conditioner case 51 of the interior air conditioning unit 50 like the interior condenser 14 described in relation to the first embodiment. The heater core 45 is a heat exchange portion that causes heat exchange between a high temperature-side heating medium heated at the water refrigerant heat exchanger 141 and ventilation air. At the heater core 45, heat of a high temperature-side heating medium is radiated to ventilation air to heat the ventilation air.

Therefore, in the high temperature-side heating medium circuit 40, at the water refrigerant heat exchanger 141, heat can be exchanged between a high pressures-side refrigerant and a high temperature-side heating medium to heat the high temperature-side heating medium. Further, at the heater core 45, heat can be exchanged between a high temperature-side heating medium and ventilation air to heat the ventilation air. In the present embodiment, therefore, each component device of the water refrigerant heat exchanger 141 and the high temperature-side heating medium circuit 40 provides a heating portion that heats air using, as a heat source, a refrigerant discharged from the compressor 11.

A high temperature-side heating medium temperature sensor 63b is connected to the input side of the controller 60 in the present embodiment. The high temperature-side heating medium temperature sensor 63b is a high temperature-side heating medium temperature detecting portion that detects a high temperature-side heating medium temperature TWH, which is a temperature of a high temperature-side heating medium flowing into the heater core 45.

The other configuration elements of the vehicle air conditioner 1a are the same as those of the vehicle air conditioner 1 described in relation to the first embodiment.

A description will be given to an operation of the vehicle air conditioner 1a in the present embodiment configured as mentioned above. In the vehicle air conditioner 1a, as in the vehicle air conditioner 1 described in relation to the first embodiment, operation modes are switched to perform air conditioning in the vehicle compartment and temperature control of the battery 80. Hereafter, a detailed description will be given to each operation mode.

(a-1) Single Cooling Mode

In the heat pump cycle 10a in the single cooling mode, the controller 60 brings the cooling expansion valve 15b into a throttled state, the refrigerating expansion valve 15c into a fully closed state, and the hot gas flow regulating valve 15d into a fully closed state.

For this reason, in the heat pump cycle 10a in the single cooling mode, the refrigerant circuit is switched to a refrigerant circuit in which a refrigerant discharged from the compressor 11 circulates in the order of the water refrigerant heat exchanger 141, the throttled cooling expansion valve 15b, the interior evaporator 18, the evaporator pressure control valve 19 and the suction port of the compressor 11.

Further, in the high temperature-side heating medium circuit 40 in the single cooling mode, the high temperature-side pump 41 is actuated so as to exhibit a predetermined reference pressure feed capacity. In addition, an operation of the high temperature-side flow regulating valve 42 is so controlled that a high temperature-side heating medium temperature TWH is brought closer to a predetermined reference high temperature-side heating medium temperature KTWH.

For this reason, in the high temperature-side heating medium circuit 40 in the single cooling mode, a low temperature-side heating medium pressure fed from the high temperature-side pump 41 circulates in the order of the water refrigerant heat exchanger 141, the heater core 45 and the suction port of the high temperature-side pump 41. Simultaneously, the circuit configuration is switched to a circuit configuration in which a low temperature-side heating medium pressure fed from the high temperature-side pump 41 circulates in the order of the water refrigerant heat exchanger 141, the high temperature-side radiator 44 and the suction port of the high temperature-side pump 41.

In a cooling mode for cooling the interior of the vehicle compartment, an amount of heat radiated from a high temperature-side heating medium to ventilation air at the heater core 45 is reduced. For this reason, at the high temperature-side flow regulating valve 42 in a cooling mode, almost all the amount of a high temperature-side heating medium flowing out of the high temperature-side heating medium outlet 111q is often let to flow out to the high temperature-side radiator 44 side.

In the interior air conditioning unit 50 in the single cooling mode, as in the single cooling mode and the like in the first embodiment, an opening of the air mix door 54 is so controlled that a ventilation air temperature TAV is brought closer to the target blowout temperature TAO. In the interior air conditioning unit 50 in the single cooling mode, operations of the inside/outside air switching device 53 and the blowing mode door are controlled based on the target blowout temperature TAO. The controller 60 further controls operations of other devices to be controlled as appropriate.

Therefore, in the heat pump cycle 10a in the single refrigeration mode, a refrigeration cycle of a vapor compression type is so configured that the water refrigerant heat exchanger 141 is caused to function as a condenser; and the interior evaporator 18 is caused to function as an evaporator.

In the high temperature-side heating medium circuit 40 in the single cooling mode, a high temperature-side heating medium pressure fed from the high temperature-side pump 41 is heated at the water refrigerant heat exchanger 141. The high temperature-side heating medium heated at the water refrigerant heat exchanger 141 flows into the high temperature-side radiator 44 and the heater core 45 according to an operation of the high temperature-side flow regulating valve 42. The high temperature-side heating medium flowing into the high temperature-side radiator 44 radiates heat to outside air and is thereby refrigerated. The high temperature-side heating medium flowing into the heater core 45 radiates heat to ventilation air.

In the interior air conditioning unit 50 in the single cooling mode, ventilation air sent from the interior blower 52 is refrigerated at the interior evaporator 18. Ventilation air refrigerated at the interior evaporator 18 is heated again at the heater core 45 so as to be brought closer to the target blowout temperature TAO according to an opening of the air mix door 54. Then, the temperature-controlled ventilation air is blown out into the vehicle compartment and cooling of the interior of the vehicle compartment is thereby implemented.

(a-2) Refrigeration Cooling Mode

In the heat pump cycle 10a in the refrigeration cooling mode, unlike the single cooling mode, the controller 60 brings the refrigerating expansion valve 15c into a throttled state.

For this reason, in the heat pump cycle 10a in the refrigeration cooling mode, a refrigerant discharged from the compressor 11 circulates in the order of the water refrigerant heat exchanger 141, the throttled cooling expansion valve 15b, the interior evaporator 18, the evaporator pressure control valve 19 and the suction port of the compressor 11. Simultaneously, the refrigerant circuit is switched to a refrigerant circuit in which a refrigerant discharged from the compressor 11 circulates in the order of the water refrigerant heat exchanger 141, the throttled refrigerating expansion valve 15c, the chiller 20 and the suction port of the compressor 11. That is, the refrigerant circuit is switched to a refrigerant circuit in which the interior evaporator 18 and the chiller 20 are connected in parallel to a flow of a refrigerant.

In the low temperature-side heating medium circuit 30a in the refrigeration cooling mode, the controller 60 actuates the low temperature-side pump 31 so as to exhibit a predetermined reference pressure feed capacity. Further, an operation of the low temperature-side flow regulating valve 32 is so controlled as to let all the amount of a high temperature-side heating medium flowing out of the low temperature-side heating medium outlet 111n flow out to the side of the cooling water channel 80a of the battery 80.

For this reason, the low temperature-side heating medium circuit 30a in the refrigeration cooling mode, the circuit configuration is switched to a circuit configuration in which a low temperature-side heating medium pressure fed from the low temperature-side pump 31 circulates in the order of the chiller 20, the cooling water channel 80a of the battery 80 and the suction port of the low temperature-side pump 31.

In the high temperature-side heating medium circuit 40 in the refrigeration cooling mode, as in the single cooling mode, operations of the high temperatures-side pump 41 and the high temperature-side flow regulating valve 42 are controlled.

In the interior air conditioning unit 50 in the refrigeration cooling mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10a in the refrigeration cooling mode, a refrigeration cycle of a vapor compression type is so configured that the water refrigerant heat exchanger 141 is caused to function as a condenser that radiates heat from a refrigerant to condense the refrigerant; and the interior evaporator 18 and the chiller 20 are caused to function as an evaporator that evaporates a refrigerant.

In the low temperature-side heating medium circuit 30a in the refrigeration cooling mode, a low temperature-side heating medium pressure fed from the low temperature-side pump 31 flows into the chiller 20 and is refrigerated there. The low temperature-side heating medium refrigerated at the chiller 20 flows through the colling water channel 80a of the battery 80 and the battery 80 is thereby refrigerated.

In the high temperature-side heating medium circuit 40 in the refrigeration cooling mode, as in the single cooling mode, a high temperature-side heating medium flowing into the high temperature-side radiator 44 radiates heat to outside air and is thereby refrigerated. The high temperature-side heating medium flowing into the heater core 45 radiates heat to ventilation air.

In the interior air conditioning unit 50 in the refrigeration cooling mode, as in the single cooling mode, temperature-controlled ventilation air is blown out into the vehicle compartment and cooling of the interior of the vehicle compartment is thereby implemented.

(b-1) Single dehumidification heating mode

In the heat pump cycle 10a in the single dehumidification heating mode, the controller 60 brings the cooling expansion valve 15b into a throttled state, the refrigerating expansion valve 15c into a throttled state, and the hot gas flow regulating valve 15d into a fully closed state.

For this reason, the heat pump cycle 10a in the single dehumidification heating mode, as in the refrigeration cooling mode, the refrigerant circuit is switched. That is, the refrigerant circuit is switched to a refrigerant circuit in which the interior evaporator 18 and the chiller 20 are connected in parallel to a flow of a refrigerant.

Further, in the low temperature-side heating medium circuit 30a in the signal dehumidification heating mode, the controller 60 actuates the low temperature-side pump 31 so as to exhibit a predetermined reference pressure feed capacity. Further, an operation of the low temperature-side flow regulating valve 32 is so controlled as to let all the amount of a high temperature-side heating medium flowing out of the low temperature-side heating medium outlet 111n flow out to the side of the low temperature-side radiator 34.

For this reason, in the low temperature-side heating medium circuit 30a in the single dehumidification heating mode, the circuit configuration is switched to a circuit configuration in which a low temperature-side heating medium pressure fed from the low temperature-side pump 31 circulates in the order of the chiller 20, the low temperature-side radiator 34 and the suction port of the low temperature-side pump 31.

In the high temperature-side heating medium circuit 40 in the single dehumidification heating mode, as in the single cooling mode, operations of the high temperature-side pump 41 and the high temperature-side flow regulating valve 42 are controlled.

In the interior air conditioning unit 50 in the single dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10a in the single dehumidification heating mode, a refrigeration cycle of a vapor compression type is so configured that the water refrigerant heat exchanger 141 is caused to function as a condenser; and the interior evaporator 18 and the chiller 20 are caused to function as an evaporator.

In the low temperature-side heating medium circuit 30a in the single dehumidification heating mode, a low temperature-side heating medium pressure fed from the low temperature-side pump 31 flows into the chiller 20 and is refrigerated there. The low temperature-side heating medium refrigerated at the chiller 20 flows into the low temperature-side radiator 34. At the low temperature-side radiator 34, the low temperature-side heating medium exchanges heat with outside air and absorbs heat from the outside air.

In the high temperature-side heating medium circuit 40 in the single dehumidification heating mode, as in the single cooling mode, a high temperature-side heating medium flowing into the high temperature-side radiator 44 radiates heat to outside air and is thereby refrigerated. The high temperature-side heating medium flowing into the heater core 45 radiates heat to ventilation air.

In the interior air conditioning unit 50 in the single dehumidification heating mode, ventilation air sent from the interior blower 52 is refrigerated and dehumidified at the interior evaporator 18. The ventilation air refrigerated and dehumidified at the interior evaporator 18 is heated again at the heater core 45 so as to be brought closer to the target blowout temperature TAO according to an opening of the air mix door 54. Then the temperature-controlled ventilation air is blown out into the vehicle compartment and dehumidification and heating of the interior of the vehicle compartment are thereby implemented.

(b-2) Refrigeration dehumidification heating mode

In the heat pump cycle 10a in the refrigeration dehumidification heating mode, as in the single dehumidification heating mode, the controller 60 brings the cooling expansion valve 15b into a throttled state, the refrigerating expansion valve 15c into a throttled state, and the hot gas flow regulating valve 15d into a fully closed state.

For this reason, in the heat pump cycle 10a in the refrigeration dehumidification heating mode, as in the single dehumidification heating mode, the refrigerant circuit is switched. That is, the refrigerant circuit is switched to a refrigerant circuit in which the interior evaporator 18 and the chiller 20 are connected in parallel to a flow of a refrigerant.

Further, in the low temperature-side heating medium circuit 30a in the refrigeration dehumidification heating mode, the controller 60 actuates the low temperature-side pump 31 so as to exhibit a predetermined reference pressure feed capacity. Further, in the low temperature-side heating medium circuit 30a, an operation of the low temperature-side flow regulating valve 32 is controlled so that a low temperature-side heating medium temperature TWL detected by the low temperature-side heating medium temperature sensor 63a is brought closer to a predetermined reference low temperature-side heating medium temperature KTWL.

In addition, in the high temperature-side heating medium circuit 40 in the refrigeration dehumidification heating mode, as in the single cooling mode, operations of the high temperature-side pump 41 and the high temperature-side flow regulating valve 42 are controlled.

In the interior air conditioning unit 50 in the refrigeration dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10a in the refrigeration dehumidification heating mode, a refrigeration cycle of a vapor compression type is so configured that the water refrigerant heat exchanger 141 is caused to function as a condenser; and the interior evaporator 18 and the chiller 20 are caused to function as an evaporator.

In the low temperature-side heating medium circuit 30a in the refrigeration dehumidification heating mode, a low temperature-side heating medium pressure fed from the low temperature-side pump 31 flows into the chiller 20 and is refrigerated there. The low temperature-side heating medium refrigerated at the chiller 20 flows into the cooling water channel 80a of the battery 80 and the low temperature-side radiator 34 according to an operation of the low temperature-side flow regulating valve 32.

The low temperature-side heating medium refrigerated at the chiller 20 passes through the cooling water channel 80a of the battery 80 and the battery 80 is thereby refrigerated. The low temperature-side heating medium that flowed into the low temperature-side radiator 34 exchanges heat with outside air and absorbs heat from the outside air.

In the high temperature-side heating medium circuit 40 in the refrigeration dehumidification heating mode, as in the single cooling mode, a high temperature-side heating medium flowing into the high temperature-side radiator 44 radiates heat to outside air and is thereby refrigerated. The high temperature-side heating medium flowing into the heater core 45 radiates heat to ventilation air.

In the interior air conditioning unit 50 in the refrigeration dehumidification heating mode, as in the single dehumidification heating mode, temperature-controlled ventilation air is blown out into the vehicle compartment and dehumidification heating of the interior of the vehicle compartment is thereby implemented.

(d-1) Single Heating Mode

In the heat pump cycle 10a in the single heating mode, the controller 60 brings the cooling expansion valve 15b into a fully closed state, the refrigerating expansion valve 15c into a throttled state, and the hot gas flow regulating valve 15d into a fully closed state.

For this reason, in the heat pump cycle 10a in the single heating mode, the refrigerant circuit is switched to a refrigerant circuit in which a refrigerant discharged from the compressor 11 circulates in the order of the water refrigerant heat exchanger 141, the throttled refrigerating expansion valve 15c, the chiller 20 and the suction port of the compressor 11.

Further, in the low temperature-side heating medium circuit 30a in the single heating mode, as in the single dehumidification heating mode, operations of the low temperature-side pump 31 and the low temperature-side flow regulating valve 32 are controlled.

In addition, in the high temperature-side heating medium circuit 40 in the single heating mode, as in the single cooling mode, operations of the high temperature-side pump 41 and the high temperature-side flow regulating valve 42 are controlled.

In the heating mode for heating the interior of the vehicle compartment, an amount of heat radiated from a high temperature-side heating medium to ventilation air at the heater core 45 is increased to a higher value than in the cooling mode and the dehumidification heating mode. For this reason, at the high temperature-side flow regulating valve 42 in the heating mode, almost all the amount of a high temperature-side heating medium flowing out of the high temperature-side heating medium outlet 111q is often let to flow out to the heater core 45 side.

In the interior air conditioning unit 50 in the single heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10a in the single heating mode, a refrigeration cycle of a vapor compression type is so configured that the water refrigerant heat exchanger 141 is caused to function as a condenser; and the chiller 20 is caused to function as an evaporator.

In the low temperature-side heating medium circuit 30a in the single heating mode, as in the single dehumidification heating mode, a low temperature-side heating medium refrigerated at the chiller 20 flows into the low temperature-side radiator 34. At the low temperature-side radiator 34, the low temperature-side heating medium exchanges heat with outside air and absorbs heat from the outside air.

In the high temperature-side heating medium circuit 40 in the single heating mode, as in the single cooling mode, a high temperature-side heating medium that flowed into the high temperature-side radiator 44 radiates heat to outside air and is thereby refrigerated. The high temperature-side heating medium flowing into the heater core 45 radiates heat to ventilation air.

In the interior air conditioning unit 50 in the single heating mode, ventilation air sent from the interior blower 52 passes through the interior evaporator 18. The ventilation air that passed through the interior evaporator 18 is heated again at the interior condenser 14 so as to be brought closer to the target blowout temperature TAO according to an opening of the air mix door 54. Temperature-controlled ventilation air is blown out into the vehicle compartment and heating of the interior of the vehicle compartment is thereby implemented.

(d-2) Refrigeration Heating Mode

In the heat pump cycle 10a in the refrigeration heating mode, the controller 60 brings the cooling expansion valve 15b into a fully closed state, the refrigerating expansion valve 15c into a throttled state, and the hot gas flow regulating valve 15d into a fully closed state.

For this reason, in the heat pump cycle 10a in the refrigeration heating mode, the refrigerant circuit is switched like the single heating mode.

In the low temperature-side heating medium circuit 30a in the refrigeration heating mode, as in the refrigeration dehumidification heating mode, operations of the low temperature-side pump 31 and the low temperature-side flow regulating valve 32 are controlled.

In the high temperature-side heating medium circuit 40 in the refrigeration heating mode, as in the single cooling mode, operations of the high temperature-side pump 41 and the high temperature-side flow regulating valve 42 are controlled.

In the interior air conditioning unit 50 in the refrigeration heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10a in the refrigeration heating mode, a refrigeration cycle of a vapor compression type is so configured that the water refrigerant heat exchanger 141 is caused to function as a condenser; and the chiller 20 is caused to function as an evaporator.

In the low temperature-side heating medium circuit 30a in the refrigeration heating mode, as in the refrigeration humidification heating mode, a low temperature-side heating medium refrigerated at the chiller 20 flows through the cooling water channel 80a of the battery 80 and the battery 80 is thereby refrigerated. The low temperature-side heating medium that flowed into the low temperature-side radiator 34 exchanges heat with outside air and absorbs heat from the outside air.

In the high temperature-side heating medium circuit 40 in the refrigeration heating mode, as in the single cooling mode, a high temperature-side heating medium that flowed into the high temperature-side radiator 44 radiates heat to outside air and is thereby refrigerated. The high temperature-side heating medium flowing into the heater core 45 radiates heat to ventilation air.

In the interior air conditioning unit 50 in the refrigeration heating mode, as in the refrigeration heating mode, temperature-controlled ventilation air is blown out into the vehicle compartment and heating of the interior of the vehicle compartment is thereby implemented.

(e-1) Hot Gas Heating Mode

In the hot gas heating mode, the controller 60 brings the cooling expansion valve 15b into a fully closed state, the refrigerating expansion valve 15c into a throttled state, and the hot gas flow regulating valve 15d into a throttled state.

For this reason, in the heat pump cycle 10a in the hot gas heating mode, a refrigerant discharged from the compressor 11 circulates in the order of the water refrigerant heat exchanger 141, the throttled refrigerating expansion valve 15c, the chiller 20 and the suction port of the compressor 11. Simultaneously, the refrigerant circuit is switched to a refrigerant circuit in which a refrigerant discharged from the compressor 11 circulates in the order of the throttled hot gas flow regulating valve 15d in the hot gas channel 22a, the chiller 20 and the suction port of the compressor 11.

In the low temperature-side heating medium circuit 30a in the hot gas heating mode, the low temperature-side pump 31 is stopped.

Further, in the high temperature-side heating medium circuit 40 in the hot gas heating mode, the controller 60 actuates the high temperature-side pump 41 so as to exhibit a predetermined reference pressure feed capacity. Further, an operation of the high temperature-side flow regulating valve 42 is so controlled as to let all the amount of a high temperature-side heating medium flowing out of the high temperature-side heating medium outlet 111q flow out to the side of the heater core 45.

For this reason, in the high temperature-side heating medium circuit 40 in the hot gas heating mode, the circuit configuration is switched to a circuit configuration in which a high temperature-side heating medium pressure fed from the high temperature-side pump 41 circulates in the order of the heating medium channel of the water refrigerant heat exchanger 141, the heater core 45 and the suction port of the high temperature-side pump 41.

In the interior air conditioning unit 50 in the hot gas heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10a in the hot gas heating mode, a flow of a refrigerant discharged from the compressor 11 is branched at the first internal three-way joint 13a.

One refrigerant branched at the first internal three-way joint 13a flows into the water refrigerant heat exchanger 141 and radiates heat to a high temperature-side heating medium. As a result, the high temperature-side heating medium is heated. A refrigerant flowing out of the water refrigerant heat exchanger 141 flows into the refrigerating expansion valve 15c and is depressurized there. The refrigerant depressurized at the refrigerating expansion valve 15c and relatively low in enthalpy flows into the chiller 20.

Meanwhile, the other refrigerant branched at the first internal three-way joint 13a has a flow rate thereof regulated at the hot gas flow regulating valve 15d and is depressurized there. The refrigerant depressurized at the hot gas flow regulating valve 15d and relatively high in enthalpy flows into the chiller 20.

At the chiller 20, the refrigerant depressurized at the refrigerating expansion valve 15c and the refrigerant depressurized at the hot gas flow regulating valve 15d are mixed together. Since the low temperature-side pump 31 is at a stop at this time, at the chiller 20, a refrigerant and a low temperature-side heating medium do not exchange heat. The refrigerant flowing out of the chiller 20 is sucked into the compressor 11 and is compressed again there.

In the high temperature-side heating medium circuit 40 in the hot gas heating mode, a high temperature-side heating medium flowing into the heater core 45 radiates heat to ventilation air.

In the interior air conditioning unit 50 in the hot gas heating mode, ventilation air sent from the interior blower 52 passes through the interior evaporator 18. The ventilation air that passed through the interior evaporator 18 is heated at the heater core 45 according to an opening of the air mix door 54. The ventilation air heated at the heater core 45 is blown out into the vehicle compartment and heating of the interior of the vehicle compartment is thereby implemented.

(e-2) Warm-Up Hot Gas Heating Mode

In the low temperature-side heating medium circuit 30a in the warm-up hot gas heating mode, as in the refrigeration cooling mode, the controller 60 controls operations of the low temperature-side pump 31 and the low temperature-side flow regulating valve 32. For this reason, in the low temperature-side heating medium circuit 30a, the circuit configuration is switched to a circuit configuration in which a low temperature-side heating medium pressure fed from the low temperature-side pump 31 circulates in the order of the chiller 20, the cooling water channel 80a of the battery 80 and the suction port of the low temperature-side pump 31. The other operations are the same as in the hot gas heating mode.

Therefore, in the heat pump cycle 10a in the warm-up hot gas heating mode, a refrigerant flowing into the chiller 20 radiates heat to a low temperature-side heating medium. As a result, the low temperature-side heating medium is heated. In the low temperature-side heating medium circuit 30 in the warm-up hot gas heating mode, a low temperature-side heating medium heated at the chiller 20 flows through the cooling water channel 80a of the battery 80. As a result, the battery 80 is warmed up.

### (f) Single Cooling Mode

In the heat pump cycle 10a in the single refrigerating mode, the controller 60 brings the cooling expansion valve 15b into a fully closed state, the refrigerating expansion valve 15c into a throttled state, and the hot gas flow regulating valve 15d into a fully closed state.

For this reason, in the heat pump cycle 10a in the single refrigerating mode, as in the single heating mode, the refrigerant circuit is switched to a refrigerant circuit in which a refrigerant discharged from the compressor 11 circulates in the order of the water refrigerant heat exchanger 141, the throttled refrigerating expansion valve 15c, the chiller 20 and the suction port of the compressor 11.

Further, in the low temperature-side heating medium circuit 30a in the single refrigerating mode, as in the refrigeration cooling mode, operations of the low temperature-side pump 31 and the low temperature-side flow regulating valve 32 are controlled.

For this reason, in the low temperature-side heating medium circuit 30a in the single refrigerating mode, the controller 60 switches the circuit configuration to a circuit configuration in which a low temperature-side heating medium pressure fed from the low temperature-side pump 31 circulates in the order of the chiller 20, the cooling water channel 80a of the battery 80 and the suction port of the low temperature-side pump 31.

Further, in the high temperature-side heating medium circuit 40 in the single refrigerating mode, the high temperature-side pump 41 is actuated so as to exhibit a predetermined reference pressure feed capacity. Further, an operation of the high temperature-side flow regulating valve 42 is so controlled as to let all the amount of a high temperature-side heating medium flowing out of the high temperature-side heating medium outlet 111q flow out to the side of the high temperature-side radiator 44.

For this reason, in the high temperature-side heating medium circuit 40 in the single refrigerating mode, the circuit configuration is switched to a circuit configuration in which a high temperature-side heating medium pressure fed from the high temperature-side pump 41 circulates in the order of the water refrigerant heat exchanger 141, the high temperature-side radiator 44 and the suction port of the high temperature-side pump 41.

Therefore, in the heat pump cycle 10a in the single heating mode, a refrigeration cycle of a vapor compression type is so configured that the water refrigerant heat exchanger 141 is caused to function as a condenser; and the chiller 20 is caused to function as an evaporator.

In the low temperature-side heating medium circuit 30a in the single refrigerating mode, as in the refrigeration cooling mode, a low temperature-side heating medium refrigerated at the chiller 20 flows through the cooling water channel 80a of the battery 80 and the battery 80 is thereby refrigerated.

In the high temperature-side heating medium circuit 40 in the single refrigerating mode, a high temperature-side heating medium pressure fed from the high temperature-side pump 41 is heated at the water refrigerant heat exchanger 141. The high temperature-side heating medium heated at the water refrigerant heat exchanger 141 flows into the high temperature-side radiator 44. The high temperature-side heating medium flowing into the high temperature-side radiator 44 radiates heat to outside air and is thereby refrigerated.

As described up to this point, in the vehicle air conditioner 1a in the present embodiment, comfortable air conditioning in the vehicle compartment and appropriate temperature control of the battery 80 as an in-vehicle device can be performed by switching operation modes.

In the heat pump cycle 10a in the present embodiment, a subcool type heat exchanger is adopted as the water refrigerant heat exchanger 141. Further, a refrigerant flowing out of a heat exchanger functioning as an evaporator can be made a refrigerant having a degree of supercooling. As a result, an amount of heat absorption at a heat exchanger functioning as an evaporator can be increased to enhance a coefficient of performance (COP) of the cycle.

In addition, since the present embodiment adopts the compressor module 110, the same effects as in the first embodiment can be obtained. That is, noise of the compressor 11 can be sufficiently suppressed without incurring degradation in the productivity of the vehicle air conditioner 1a as a heat pump cycle.

In the compressor module 110 in the present embodiment, heat of a high pressure-side refrigerant in the receiver portion 141b as a high pressure-side refrigerant device can be transferred to the rubber vibration insulators 11c to heat the rubber vibration insulators 11c.

According to the foregoing, even at a low outside air temperature or on other like occasions, the rubber vibration insulators 11c can be heated to suppress degradation in the elasticity of the rubber vibration insulators 11c. Therefore, vibration of the compressor 11 can be effectively suppressed from being transmitted to the channel box 111 or the cover member leading to production of noise in the channel box 111 or the cover member.

### Third Embodiment

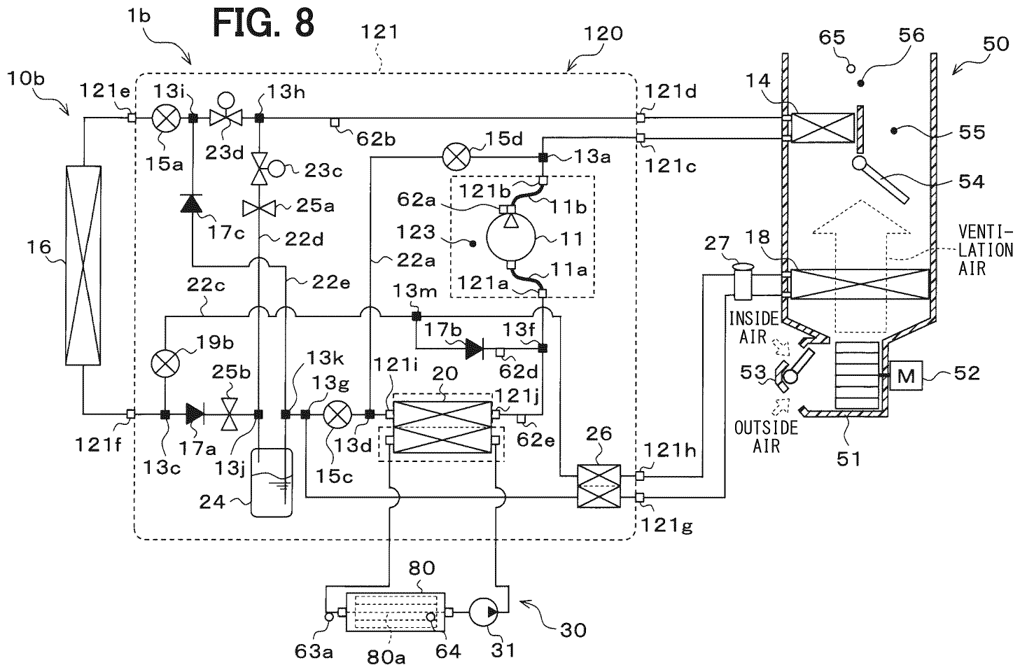

In relation to the present embodiment, a description will be given to an example in which a compressor module 120 according to the present disclosure is applied to a vehicle air conditioner 1b shown in the overall configuration diagram in FIG. 8. Like the vehicle air conditioner 1 described in relation to the first embodiment, the vehicle air conditioner 1b is a heat pump cycle that performs air conditioning of the interior of the vehicle compartment and temperature control of in-vehicle devices.

The vehicle air conditioner 1b includes a heat pump cycle 10b, the low temperature-side heating medium circuit 30, and the interior air conditioning unit 50.

In the heat pump cycle 10b in the present embodiment, unlike the heat pump cycle 10 described in relation to the first embodiment, the muffler portion 12, the evaporator pressure control valve 19, the accumulator portion 21, the dehumidifying channel 22b, the dehumidifying on-off valve 23a, and the like are abolished. The heat pump cycle 10b adopts a receiver portion 24, an internal heat exchange portion 26, and a thermostatic expansion valve 27.

The compressor module 120 is a component obtained by mainly integrating a plurality of component devices constituting the heat pump cycle 10b. In the compressor module 120 in the present embodiment, the component devices and the like encircled with the broken line in FIG. 8 are integrated.

More specifically, in the compressor module 120 in the present embodiment, of the component devices of the heat pump cycle 10b, the compressor 11, the heating expansion valve 15a, the refrigerating expansion valve 15c, the hot gas flow regulating valve 15d, the hot gas flow regulating valve 15d, an outdoor machine pressure control valve 19b, the chiller 20, a first on-off valve 23c, the receiver portion 24, a first fixed throttling 25a, a second fixed throttling 25b, the internal heat exchange portion 26 and the like are integrated.

Of these component devices, the compressor 11, the heating expansion valve 15a, the refrigerating expansion valve 15c, the hot gas flow regulating valve 15d, the outdoor machine pressure control valve 19b, the chiller 20, the first on-off valve 23c, and a second on-off valve 23d are integrated by being attached to a channel box 121 of the compressor module 120.

The receiver portion 24, the first fixed throttling 25a, the second fixed throttling 25b, and the internal heat exchange portion 26 are integrally formed with the channel box 121. The channel box 121 is a mounting member like the channel box 101 described in relation to the first embodiment and is a channel forming member.

As in the first embodiment, a compressor-side inlet 121b formed in the channel box 121 is connected to the discharge port of the compressor 11 of the heat pump cycle 10b through the high-pressure hose 11b. The compressor-side inlet 121b communicates to the inflow port of the first internal three-way joint 13a through an internal refrigerant channel.

One outflow port of the first internal three-way joint 13a communicates to a condenser-side outlet 121c formed in the channel box 121 through an internal refrigerant channel. The other outflow port of the first internal three-way joint 13a communicates to one inflow port of the fourth internal three-way joint 13d through the hot gas channel 22a. As in the first embodiment, the hot gas flow regulating valve 15d is disposed in the hot gas channel 22a.

The side of a condenser-side inlet 121d formed in the channel box 121 is connected to the refrigerant outlet of the interior condenser 14 of the heat pump cycle 10b. The condenser-side inlet 121d communicates to the inflow port of an eighth internal three-way joint 13h through an internal refrigerant channel.

The other outflow port of the eighth internal three-way joint 13h communicates to the one inflow port of a ninth internal three-way joint 13i through an internal refrigerant channel. The other outflow port of the eighth internal three-way joint 13h communicates to the one inflow port of a tenth internal three-way joint 13j through an internal refrigerant channel. The internal heating medium channel extending from the other outflow port of the eighth three-way joint 13h to the inflow port of the receiver portion 24 is an inlet-side channel 22d.

The first on-off valve 23c and the first fixed throttling 25a are disposed in the inlet-side channel 22d. The first on-off valve 23c is an on-off valve that opens and closes the inlet-side channel 22d. The basic configuration of the first on-off valve 23c is the same as those of the dehumidifying on-off valve 23a and the like described in relation to the first embodiment. Therefore, the first on-off valve 23c is an electrical device and is a refrigerant circuit switching portion. The first fixed throttling 25a is a depressurizing portion that depressurizes a refrigerant flowing into the receiver portion 24. An orifice, a capillary tube, or the like can be adopted as the first fixed throttling 25a.

The outflow port of the tenth internal three-way joint 13j communicates to the inflow port of the receiver portion 24 formed in the channel box 121. The receiver portion 24 is a high pressure-side gas-liquid separating portion that separates a refrigerant flowing out of a heat exchange portion functioning as a condenser into vapor and liquid and accumulates a separated liquid-phase refrigerant as a surplus refrigerant of the cycle.

The outflow port of the receiver portion 24 communicates to the inflow port of an eleventh internal three-way joint 13k through an internal refrigerant channel. One outflow port of the eleventh internal three-way joint 13k communicates to the inflow port of the seventh internal three-way joint 13g through an internal refrigerant channel. The other outflow port of the eleventh internal three-way joint 13k communicates to the other inflow port of the ninth internal three-way joint 13i through an internal refrigerant channel.

The internal heating medium channel extending from the other outflow port of the eleventh internal three-way joint 13k to the ninth internal three-way joint 13i is an outlet-side channel 22e. A third check valve 17c is disposed in the outlet-side channel 22e. The third check valve 17c permits a flow of a refrigerant from the eleventh internal three-way joint 13k side to the ninth internal three-way joint 13i side and inhibits a flow of a refrigerant from the ninth internal three-way joint 13i side to the eleventh internal three-way joint 13k side.

The second on-off valve 23d is disposed in the internal refrigerant channel extending from one outflow port of the eighth internal three-way joint 13h to one inflow port of the ninth internal three-way joint 13i. The second on-off valve 23d is an on-off valve that opens and closes the internal refrigerant channel extending from the eighth internal three-way joint 13h to the ninth internal three-way joint 13i. The basic configuration of the second on-off valve 23d is the same as that of the first on-off valve 23c. Therefore, the second on-off valve 23d is an electrical device and is a refrigerant circuit switching portion.

The outflow port of the eighth internal three-way joint 13h communicates to an outdoor machine-side outlet 121e formed in the channel box 121 through an internal refrigerant channel. The heating expansion valve 15a is disposed in the internal refrigerant channel extending from the outflow port of the eighth internal three-way joint 13h to the outdoor machine-side outlet 121e.

The refrigerant inlet side of the outdoor heat exchanger 16 is connected to the outdoor machine-side outlet 121e. The side of an outdoor machine-side inlet 121f formed in the channel box 121 is connected to the refrigerant outlet of the outdoor heat exchanger 16. The outdoor machine-side inlet 101f communicates to an inflow port of the third internal three-way joint 13c through an internal refrigerant channel.

One outflow port of the third internal three-way joint 13c communicates to the other inflow port of the tenth internal three-way joint 13j through an internal refrigerant channel. The other outflow port of the third internal three-way joint 13c communicates to one inflow port of the sixth internal three-way joint 13f through the heating channel 22c.

The outdoor machine pressure control valve 19b, a twelfth internal three-way joint 13m, and the second check valve 17b are disposed in the heating channel 22c. The outdoor machine pressure control valve 19b is an electrically operated variable throttle mechanism that controls a refrigerant pressure in the outdoor heat exchanger 16. The basic configuration of the outdoor machine pressure control valve 19b is the same as that the refrigerating expansion valve 15c. Therefore, the refrigerating expansion valve 15c is an electrical device. The refrigerating expansion valve 15c has a fully closing function.

The second check valve 17b in the present embodiment permits a flow of a refrigerant from the twelfth internal three-way joint 13m side to the sixth internal three-way joint 13f side and inhibits a flow of a refrigerant from the sixth internal three-way joint 13f side to the twelfth internal three-way joint 13m side.

One outflow port of the seventh internal three-way joint 13g communicates to the inlet of a high pressure-side channel of the internal heat exchange portion 26 formed in the channel box 121 through an internal refrigerant channel. The internal heat exchange portion 26 is a heat exchange portion that causes heat exchange between a refrigerant flowing through a high pressure-side channel and a refrigerant flowing through a low pressure-side channel. More specifically, in the cooling mode or the like, the internal heat exchange portion 26 causes heat exchange between a high pressure-side refrigerant flowing out of the receiver portion 24 and a low pressure-side refrigerant flowing out of the interior evaporator 18.

The outlet of the high pressure-side channel of the internal heat exchange portion 26 communicates to an evaporator-side outlet 121g formed in the channel box 121 through an internal refrigerant channel. The inlet side of the thermostatic expansion valve 27 is connected to the evaporator-side outlet 121g. The thermostatic expansion valve 27 is an evaporator depressurizing portion that, like the cooling expansion valve 15b described in relation to the first embodiment, depressurizes a refrigerant flowing out of one outflow port of the internal four-way joint 13x and further regulates a flow rate of a refrigerant let to flow out to the downstream side in the cooling mode or the like, described later.

The thermostatic expansion valve 27 is constituted of a mechanical mechanism. The thermostatic expansion valve 27 includes: a thermosensitive portion having a deformable member (specifically, diaphragm) that deforms according to a temperature and a pressure of an outlet-side refrigerant in the interior evaporator 18; and a valve element portion that is displaced and varies a throttle opening according to deformation of the deformable member.

At the thermostatic expansion valve 27, a throttle opening is varied so that a degree of superheat of an outlet-side refrigerant in the interior evaporator 18 is brought closer to a predetermined reference degree of superheat (in the present embodiment, 5° C.). When the thermosensitive portion is brought to a cryogenic temperature, the deformable member displaces the valve element portion to the side on which a throttle channel is closed.

The refrigerant inlet side of the interior evaporator 18 is connected to the outlet of the thermostatic expansion valve 27. The refrigerant outlet of the interior evaporator 18 communicates to an evaporator-side inlet 121h formed in the channel box 121 through a thermosensitive portion channel of the thermostatic expansion valve 27.

The evaporator-side inlet 121h communicates to the inlet of a low pressure-side channel of the internal heat exchange portion 26 through an internal refrigerant channel. The outlet of the low pressure-side channel of the internal heat exchange portion 26 communicates to the other inflow port of the twelfth internal three-way joint 13m through an internal refrigerant channel.

The other outflow port of the seventh internal three-way joint 13g communicates to the other inflow port of the fourth internal three-way joint 13d through an internal refrigerant channel. As in the first embodiment, the refrigerating expansion valve 15c is disposed in the internal refrigerant channel extending from the other outflow port of the seventh internal three-way joint 13g to the other inflow port of the fourth internal three-way joint 13d.

The outflow port of the fourth internal three-way joint 13d communicates to a chiller-side outlet 121i formed in the channel box 121. The refrigerant inlet of the chiller 20 is connected directly to the chiller-side outlet 121i. The chiller-side inlet 121j formed in the channel box 121 is connected directly to the refrigerant outlet of the chiller 20. The other configuration elements of the heat pump cycle 10b are the same as those of the heat pump cycle 10 described in relation to the first embodiment.

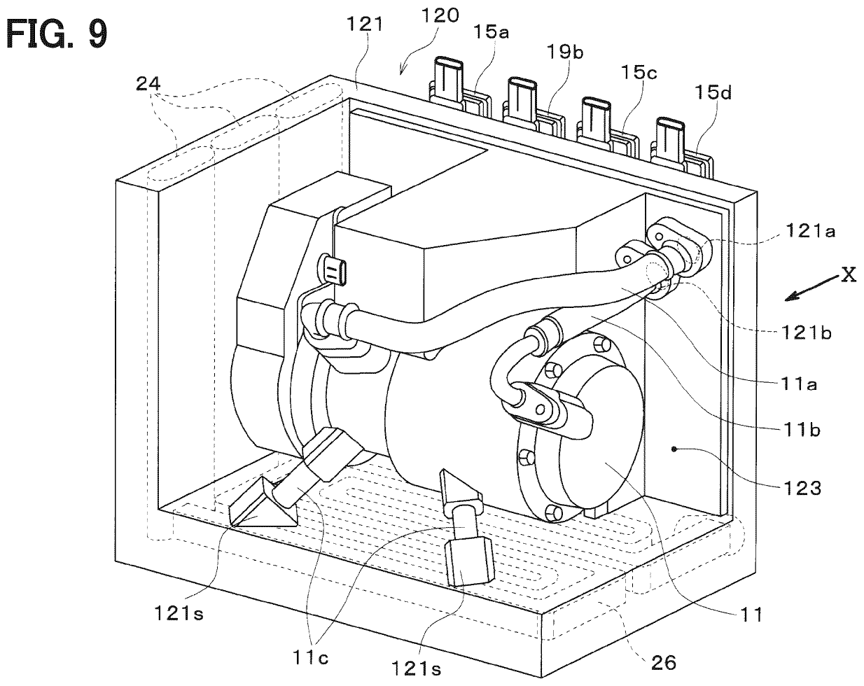

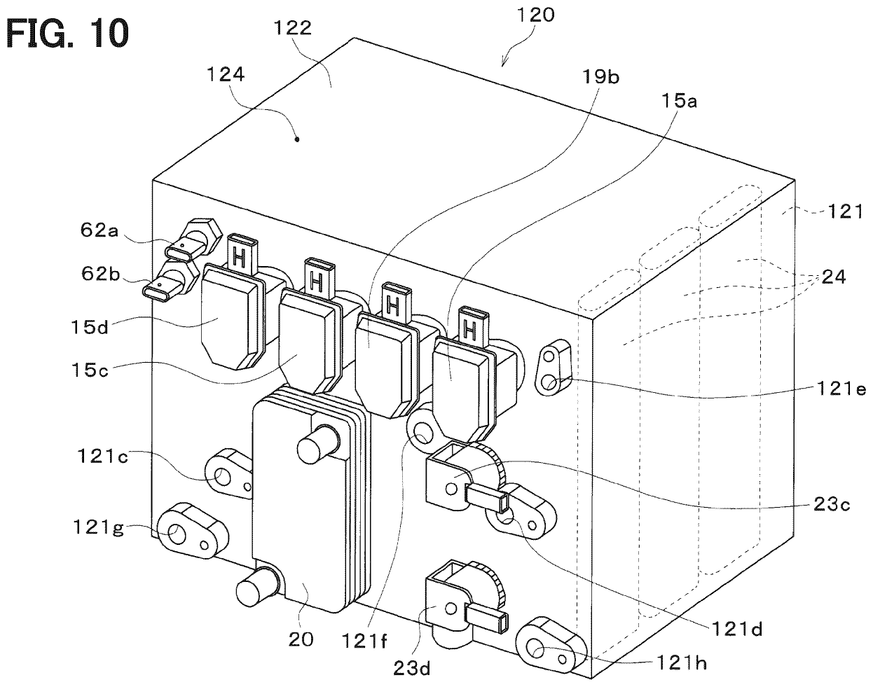

A detailed description will be given to a configuration of the compressor module 120 with reference to FIGS. 9 and 10. The basic configuration of the compressor module 120 is the same as that the compressor module 100 described in relation to the first embodiment. As illustrated in FIG. 9, the compressor module 120 includes the channel box 121 made of metal. As illustrated in FIG. 10, the compressor module 120 includes a cover member 122 made of resin.

As in the first embodiment, when attached to the channel box 121, the cover member 122 forms a housing space 123 as a sealed space for housing the compressor 11 and the like in the compressor module 120. As in the first embodiment, a heat insulating material 124 is disposed on the outer side faces of the compressor module 120.

As shown in FIG. 9, the compressor 11 is housed in the housing space 123. For this reason, the compressor-side outlet 121a and compressor-side inlet 121b are formed in the housing space 123. More specifically, the compressor-side outlet 121a and the compressor-side inlet 121b are formed in inner side faces of the housing space 123 side of the channel box 121 and thus formed in the housing space 123.

As shown in FIG. 10, the interior condenser 14, the heating expansion valve 15a, the refrigerating expansion valve 15c, the hot gas flow regulating valve 15d, the outdoor heat exchanger 16, the interior evaporator 18, the outdoor machine pressure control valve 19b, the chiller 20, the first on-off valve 23c, and the second on-off valve 23d are disposed outside the housing space 123. Therefore, in the present embodiment, the interior condenser 14, the outdoor heat exchanger 16, the interior evaporator 18 and the chiller are external component devices.

The condenser-side outlet 121c, the condenser-side inlet 121d, the outdoor machine-side outlet 121e, the outdoor machine-side inlet 121f, the evaporator-side outlet 121g, the evaporator-side inlet 121h, the chiller-side outlet 121i, and the chiller-side outlet 121j are formed in outer side faces of the channel box 101 and thus formed outside the housing space 123.

Therefore, in the present embodiment, the condenser-side outlet 121c, the condenser-side inlet 121d, the outdoor machine-side outlet 121e, the outdoor machine-side inlet 121f, the evaporator-side outlet 121g, and the evaporator-side inlet 121h, the chiller-side outlet 121i and the chiller-side outlet 121j are outside connection ports to which the inflow and outflow port sides of the external component devices.

As in the first embodiment, the compressor 11 is fixed to a plurality (four in the present embodiment) of fixing portions 121s formed on the bottom face forming the housing space 123 of the channel box 121 through a rubber vibration insulator 11c.

The receiver portion 24 is formed in a side face portion of the channel box 121. The internal heat exchange portion 26 is formed at the bottom face portion of the channel box 121. Specifically, a high pressure-side channel and a low pressure-side channel are formed inside the bottom face portion of the channel box 121 so that the high pressure-side channel and the low pressure-side channel are disposed in proximity to each other and thus a high pressure-side refrigerant and a low pressure-side refrigerant can exchange heat therebetween.

The chiller 20 is fixed to the channel box 101 by the refrigerant outlet and inlet so formed as to protrude to the outside being respectively fit into refrigerant outlet and inlet (that is, the chiller-side outlet 101i, the chiller-side inlet 101j) formed in the channel box 101. The heating medium piping of the low temperature-side heating medium circuit 30 is connected directly to the heating medium outlet/inlet of the chiller 20.

The other configuration elements of the vehicle air conditioner 1b are the same as those of the vehicle air conditioner 1 described in relation to the first embodiment.

A description will be given to an operation of the vehicle air conditioner 1b in the present embodiment configured as mentioned above. In the vehicle air conditioner 1b, as in the vehicle air conditioner 1 described in relation to the first embodiment, air conditioning of the interior of the vehicle compartment and temperature control of the battery 80 are performed by switching various operation modes. Hereafter, a detailed description will be given to each operation mode.

(a-1) Single Cooling Mode

In the heat pump cycle 10b in the single cooling mode, the controller 60 brings the heating expansion valve 15a into a fully opened state, the refrigerating expansion valve 15c into a fully closed state, the hot gas flow regulating valve 15b into a fully closed state, and the outdoor machine pressure control valve 19b into a fully closed state. The controller 60 closes the first on-off valve 23c and opens the second on-off valve 23d.

For this reason, in the heat pump cycle 10b in the single cooling mode, the refrigerant circuit is switched to a refrigerant circuit in which a refrigerant discharged from the compressor 11 circulates in the order of the interior condenser 14, the fully opened heating expansion valve 15a, the outdoor heat exchanger 16, the second fixed throttling 25b, the receiver portion 24, the high pressure-side channel of the internal heat exchange portion 26, the thermostatic expansion valve 27, the interior evaporator 18, the low pressure-side channel of the internal heat exchange portion 26 and the suction port of the compressor 11.

In the interior air conditioning unit 50 in the single cooling mode, as in the single cooling mode and the like in the first embodiment, an opening of the air mix door 54 is so controlled that a ventilation air temperature TAV is brought closer to the target blowout temperature TAO. In the interior air conditioning unit 50 in the single cooling mode, operations of the inside/outside air switching device 53 and the blowing mode door are controlled based on the target blowout temperature TAO. The controller 60 further controls operations of other devices to be controlled as appropriate.

Therefore, in the heat pump cycle 10b in the single cooling mode, a refrigeration cycle of a vapor compression type is so configured that the interior condenser 14 and the outdoor heat exchanger 16 are caused to function as a condenser; and the interior evaporator 18 is caused to function as an evaporator.

In the interior air conditioning unit 50 in the single cooling mode, ventilation air sent from the interior blower 52 is refrigerated at the interior evaporator 18. Ventilation air refrigerated at the interior evaporator 18 is heated again at the heater core 45 so as to be brought closer to the target blowout temperature TAO according to an opening of the air mix door 54. Then, the temperature-controlled ventilation air is blown out into the vehicle compartment and cooling of the interior of the vehicle compartment is thereby implemented.

(a-2) Refrigeration Cooling Mode

In the heat pump cycle 10b in the refrigeration cooling mode, unlike the single cooling mode, the controller 60 brings the refrigerating expansion valve 15c into a throttled state.

For this reason, in the heat pump cycle 10b in the refrigeration cooling mode, a refrigerant discharged from the compressor 11 circulates in the order of the interior condenser 14, the fully opened heating expansion valve 15a, the outdoor heat exchanger 16, the second fixed throttling 25b, the receiver portion 14, the high pressure-side channel of the internal heat exchange portion 26, the thermostatic expansion valve 27, the interior evaporator 18, the low pressure-side channel of the internal heat exchange portion 26 and the suction port of the compressor 11. Simultaneously, the refrigerant circuit is switched to a refrigerant circuit in which a refrigerant discharged from the compressor 11 circulates in the order of the interior condenser 14, the fully opened heating expansion valve 15a, the outdoor heat exchanger 16, the second fixed throttling 25b, the receiver portion 24, the throttled refrigerating expansion valve 15c, the chiller 20 and the suction port of the compressor 11. That is, the refrigerant circuit is switched to a refrigerant circuit in which the interior evaporator 18 and the chiller 20 are connected in parallel to a flow of a refrigerant.

Further, in the low temperature-side heating medium circuit 30 in the refrigeration cooling mode, the controller 60 actuates the low temperature-side pump 31 so as to exhibit a predetermined reference pressure feed capacity. For this reason, in the low temperature-side heating medium circuit 30, a low temperature-side heating medium pressure fed from the low temperature-side pump 31 circulates in the order of the heating medium channel of the chiller 20, the cooling water channel 80a of the battery 80 and the suction port of the low temperature-side pump 31.

In the interior air conditioning unit 50 in the refrigeration cooling mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10b in the refrigeration cooling mode, a refrigeration cycle of a vapor compression type is so configured that the interior condenser 14 and the outdoor heat exchanger 16 are caused to function as a condenser; and the interior evaporator 18 and the chiller 20 are caused to function as an evaporator.

In the low temperature-side heating medium circuit 30 in the refrigeration cooling mode, a low temperature-side heating medium pressure fed from the low temperature-side pump 31 flows into the chiller 20 and is refrigerated there. The low temperature-side heating medium refrigerated at the chiller 20 passes through the cooling water channel 80a of the battery 80 and the battery 80 is thereby refrigerated.

In the interior air conditioning unit 50 in the refrigeration cooling mode, as in the single cooling mode, temperature-controlled ventilation air is blown out into the vehicle compartment and cooling of the interior of the vehicle compartment is thereby implemented.

(b-1) Single Series Dehumidification Heating Mode

In the heat pump cycle 10b in the single series dehumidification heating mode, the controller 60 brings the heating expansion valve 15a into a throttled state, the refrigerating expansion valve 15c into a fully closed state, the hot gas flow regulating valve 15d into a fully closed state, and the outdoor machine pressure control valve 19b into a fully closed state. The controller 60 closes the first on-off valve 23c and opens the second on-off valve 23d.

For this reason, in the heat pump cycle 10b in the single series dehumidification heating mode, the refrigerant circuit is switched to a refrigerant circuit in which a refrigerant discharged from the compressor 11 circulates in the order of the interior condenser 14, the throttled heating expansion valve 15a, the outdoor heat exchanger 16, the second fixed throttling 25b, the receiver portion 24, the high pressure-side channel of the internal heat exchange portion 26, the thermostatic expansion valve 27, the interior expansion valve 18, the low pressure-side channel of the internal heat exchange portion 26 and the suction port of the compressor 11.

In the interior air conditioning unit 50 in the single series dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10b in the single series dehumidification heating mode, a refrigeration cycle of a vapor compression type is so configured that the interior condenser 14 and the outdoor heat exchanger 16 are caused to function as a condenser; and the interior evaporator 18 is caused to function as an evaporator.

In the interior air conditioning unit 50 in the single series dehumidification heating mode, ventilation air sent from the interior blower 52 is refrigerated and dehumidified at the interior evaporator 18. Ventilation air refrigerated and dehumidified at the interior evaporator 18 is heated again at the interior condenser 14 so as to be brought closer to the target blowout temperature TAO according to an opening of the air mix door 54. Then the temperature-controlled ventilation air is blown out into the vehicle compartment and dehumidification and heating of the interior of the vehicle compartment are thereby implemented.

Since the vehicle air conditioner 1b in the present embodiment includes the receiver portion 24, the series dehumidification heating mode is performed within such a temperature range that a saturation temperature of a refrigerant in the outdoor heat exchanger 16 is higher than the outside air temperature Tam.

(b-2) Refrigeration Series Dehumidification Heating Mode

In the heat pump cycle 10b in the refrigeration series dehumidification heating mode, unlike the single series dehumidification heating mode, the controller 60 brings the refrigerating expansion valve 15c into a throttled state.

For this reason, in the heat pump cycle 10b in the refrigeration series dehumidification heating mode, a refrigerant discharged from the compressor 11 circulates as in the single series dehumidification heating mode. The refrigerant circuit is switched to a refrigerant circuit in which a refrigerant discharged from the compressor 11 circulates in the order of the interior condenser 14, the throttled heating expansion valve 15a, the outdoor heat exchanger 16, the second fixed throttling 25b, the receiver portion 24, the throttled refrigerating expansion valve 15c, the chiller 20 and the suction port of the compressor 11. That is, the refrigerant circuit is switched to a refrigerant circuit in which the interior evaporator 18 and the chiller 20 are connected in parallel to a flow of a refrigerant.

In the low temperature-side heating medium circuit 30 in the refrigeration series dehumidification heating mode, an operation of the low temperature-side pump 31 is controlled as in the refrigeration cooling mode. For this reason, in the low temperature-side heating medium circuit 30 in the refrigeration series dehumidification heating mode, a low temperature-side heating medium circulates as in the refrigeration cooling mode.

Therefore, in the heat pump cycle 10b in the refrigeration series dehumidification heating mode, a refrigeration cycle of a vapor compression type is so configured that the interior condenser 14 and the outdoor heat exchanger 16 are caused to function as a condenser; and the interior evaporator 18 and the chiller 20 are caused to function as an evaporator.

In the low temperature-side heating medium circuit 30 in the refrigeration series dehumidification heating mode, as in the refrigeration cooling mode, a low temperature-side heating medium refrigerated at the chiller 20 flows through the cooling water channel 80a of the battery 80 and the battery 80 is thereby refrigerated.

In the interior air conditioning unit 50 in the refrigeration series dehumidification heating mode, as in the single series dehumidification heating mode, temperature-controlled ventilation air is blown out into the vehicle compartment and dehumidification and heating of the interior of the vehicle compartment are thereby implemented.

(c-1) Single Parallel Dehumidification Heating Mode

In the heat pump cycle 10b in the single parallel dehumidification heating mode, the controller 60 brings the heating expansion valve 15a into a throttled state, the refrigerating expansion valve 15c into a fully closed state, the hot gas flow regulating valve 15d into a fully closed state, and the outdoor machine pressure control valve 19b into a fully opened or throttled state. Further, the controller 60 opens the first on-off valve 23c and closes the second on-off valve 23d.

For this reason, in the heat pump cycle 10b in the signal dehumidification heating mode, a refrigerant discharged from the compressor 11 circulates in the order of the interior condenser 14, the inlet-side channel 22d, the receiver portion 24, the outlet-side channel 22e, the throttled heating expansion valve 15a, the outdoor heat exchanger 16, the outdoor machine pressure control valve 19b in the heating channel 22c and the suction port of the compressor 11. Simultaneously, the refrigerant circuit is switched to a refrigerant circuit in which a refrigerant discharged from the compressor 11 circulates in the order of the interior condenser 14, the inlet-side channel 22d, the receiver portion 24, the high pressure-side channel of the internal heat exchange portion 26, the thermostatic expansion valve 27, the interior evaporator 18, the low pressure-side channel of the internal heat exchange portion 26 and the suction port of the compressor 11. That is, the refrigerant circuit is switched to a refrigerant circuit in which the interior evaporator 18 and the outdoor heat exchanger 16 are connected in parallel to a flow of a refrigerant.

In the interior air conditioning unit 50 in the single dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10b in the single dehumidification heating mode, a refrigeration cycle of a vapor compression type is so configured that the interior condenser 14 is caused to function as a condenser; and the outdoor heat exchanger 16 and the interior evaporator 18 are caused to function as an evaporator.

In the interior air conditioning unit 50 in the single dehumidification heating mode, ventilation air sent from the interior blower 52 is refrigerated and dehumidified at the interior evaporator 18. Ventilation air refrigerated and dehumidified at the interior evaporator 18 is heated again at the interior condenser 14 so as to be brought closer to the target blowout temperature TAO according to an opening of the air mix door 54. Then the temperature-controlled ventilation air is blown out into the vehicle compartment and dehumidification and heating of the interior of the vehicle compartment are thereby implemented.

(c-2) Refrigeration parallel dehumidification heating mode

In the heat pump cycle 10 in the Refrigeration Parallel Dehumidification heating mode, unlike the single parallel dehumidification heating mode, the controller 60 brings the refrigerating expansion valve 15c into a throttled state.

For this reason, in the heat pump cycle 10b in the refrigeration parallel dehumidification heating mode, a refrigerant discharged from the compressor 11 circulates as in the single parallel dehumidification heating mode. Simultaneously, the refrigerant circuit is switched to a refrigerant circuit in which a refrigerant discharged from the compressor 11 circulates in the order of the interior condenser 14, the inlet-side channel 22d, the receiver portion 24, the throttled refrigerating expansion valve 15c, the chiller 20 and the suction port of the compressor 11. That is, the refrigerant circuit is switched to a refrigerant circuit in which the outdoor heat exchanger 16, the interior evaporator 18, and the chiller 20 are connected in parallel to a flow of a refrigerant.

In the low temperature-side heating medium circuit 30 in the refrigeration parallel dehumidification heating mode, an operation of the low temperature-side pump 31 is controlled as in the refrigeration cooling mode. For this reason, in the low temperature-side heating medium circuit 30 in the refrigeration parallel dehumidification heating mode, as in the refrigeration cooling mode, a low temperature-side heating medium circulates.

In the interior air conditioning unit 50 in the refrigeration parallel dehumidification heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the refrigeration parallel dehumidification heating mode, a refrigeration cycle of a vapor compression type is so configured that the interior condenser 14 is caused to function as a condenser; and the outdoor heat exchanger 16, the interior evaporator 18 and the chiller 20 are caused to function as an evaporator.

In the low temperature-side heating medium circuit 30 in the refrigeration dehumidification heating mode, as in the refrigeration cooling mode, a low temperature-side heating medium refrigerated at the chiller 20 flows through the cooling water channel 80a of the battery 80 and the battery 80 is thereby refrigerated.

In the interior air conditioning unit 50 in the refrigeration dehumidification heating mode, as in the single dehumidification heating mode, temperature-controlled ventilation air is blown out into the vehicle compartment and dehumidification heating of the interior of the vehicle compartment is thereby implemented.

(d-1) Single Heating Mode

In the heat pump cycle 10b in the single heating mode, the controller 60 brings the heating expansion valve 15a into a throttled state, the refrigerating expansion valve 15c into a fully closed state, the hot gas flow regulating valve 15d into a fully closed state, and the outdoor machine pressure control valve 19b into a fully opened or throttled state. Further, the controller 60 opens the first on-off valve 23c and closes the second on-off valve 23d.

For this reason, in the heat pump cycle 10 in the single heating mode, the refrigerant circuit is switched to a refrigerant circuit in which a refrigerant discharged from the compressor 11 circulates in the order of the interior condenser 14, the inlet-side channel 22d, the receiver portion 24, the outlet-side channel 22e, the throttled heating expansion valve 15a, the outdoor heat exchanger 16, the outdoor machine pressure control valve 19b in the heating channel 22c and the suction port of the compressor 11.

In the interior air conditioning unit 50 in the single heating mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the single heating mode, a refrigeration cycle of a vapor compression type is so configured that the interior condenser 14 is caused to function as a condenser; and the outdoor heat exchanger 16 is caused to function as an evaporator.

In the interior air conditioning unit 50 in the single heating mode, ventilation air sent from the interior blower 52 passes through the interior evaporator 18. The ventilation air that passed through the interior evaporator 18 is heated again at the interior condenser 14 so as to be brought closer to the target blowout temperature TAO according to an opening of the air mix door 54. Temperature-controlled ventilation air is blown out into the vehicle compartment and heating of the interior of the vehicle compartment is thereby implemented.

(d-2) Refrigeration Heating Mode

In the heat pump cycle 10 in the refrigeration heating mode, unlike the single heating mode, the controller 60 brings the refrigerating expansion valve 15c into a throttled state.

For this reason, in the heat pump cycle 10 in the refrigeration heating mode, a refrigerant discharged from the compressor 11 circulates as in the single heating mode. Simultaneously, the refrigerant circuit is switched to a refrigerant circuit in which a refrigerant discharged from the compressor 11 circulates in the order of the interior condenser 14, the inlet-side channel 22d, the receiver portion 24, the throttled refrigerating expansion valve 15c, the chiller 20 and the suction port of the compressor 11. That is, the refrigerant circuit is switched to a refrigerant circuit in which the outdoor heat exchanger 16 and the chiller 20 are connected in parallel to a flow of a refrigerant.

In the low temperature-side heating medium circuit 30 in the refrigeration parallel dehumidification heating mode, an operation of the low temperature-side pump 31 is controlled as in the refrigeration cooling mode. For this reason, in the low temperature-side heating medium circuit 30 in the refrigeration series dehumidification heating mode, a low temperature-side heating medium circulates as in the refrigeration cooling mode.

In the interior air conditioning unit 50 in the refrigeration parallel dehumidification mode, as in the single cooling mode, an opening of the air mix door 54 and operations of the inside/outside air switching device 53 and the blowing mode door are controlled. The controller 60 further controls operations of other devices to be controlled as appropriate.

Therefore, in the heat pump cycle 10 in the refrigeration heating mode, a refrigeration cycle of a vapor compression type is so configured that the interior condenser 14 is caused to function as a condenser; and the outdoor heat exchanger 16 and the chiller 20 are caused to function as an evaporator.

In the low temperature-side heating medium circuit 30 in the refrigeration heating mode, as in the refrigeration cooling mode, a low temperature-side heating medium refrigerated at the chiller 20 flows through the cooling water channel 80a of the battery 80 and the battery 80 is thereby refrigerated.

In the interior air conditioning unit 50 in the refrigeration heating mode, as in the single heating mode, temperature-controlled ventilation air is blown out into the vehicle compartment and heating of the interior of the vehicle compartment is thereby implemented.

(e-1) Hot Gas Heating Mode

In the hot gas heating mode, the controller 60 brings the heating expansion valve 15a into a fully closed state, the refrigerating expansion valve 15c into a throttled state, the hot gas flow regulating valve 15d into a throttled state, and the outdoor machine pressure control valve 19b into a fully closed state. Further, the controller 60 opens the first on-off valve 23c and closes the second on-off valve 23d.

For this reason, in the heat pump cycle 10b in the hot gas heating mode, a refrigerant discharged from the compressor 11 circulates in the order of the interior condenser 14, the inlet-side channel 22d, the receiver portion 24, the throttled refrigerating expansion valve 15c, the chiller 20 and the suction port of the compressor 11. Simultaneously, the refrigerant circuit is switched to a refrigerant circuit in which a refrigerant discharged from the compressor 11 circulates in the order of the throttled hot gas flow regulating valve 15d in the hot gas channel 22a, the chiller 20 and the suction port of the compressor 11.

In the low temperature-side heating medium circuit 30 in the hot gas heating mode, the low temperature-side pump 31 is stopped. In the interior air conditioning unit 50 in the hot gas heating mode, as in the single cooling mode, operations of the air mix door 54, the inside/outside air switching device 53 and the blowing mode door are controlled. The controller 60 further controls operations of other devices to be controlled as appropriate.

Therefore, in the heat pump cycle 10b in the hot gas heating mode, a flow of a refrigerant discharged from the compressor 11 is branched at the first internal three-way joint 13a.

One refrigerant branched at the first internal three-way joint 13a flows into the interior condenser 14 and radiates heat to ventilation air. As a result, the ventilation air is heated. A refrigerant flowing out of the interior condenser 14 flows into the receiver portion 14 through the inlet-side channel 22d. The refrigerant that flowed out of the receiver portion 24 flows into the refrigerating expansion valve 15c and is depressurized there.

The refrigerant depressurized at the refrigerating expansion valve 15c and relatively low in enthalpy flows into the chiller 20 through the fourth internal three-way joint 13d. The thermostatic expansion valve 27 is brought into a fully closed state at a low outside air temperature. Therefore, a refrigerant does not flow out from the receiver portion 24 to the internal heat exchange portion 26 side.

Meanwhile, the other refrigerant branched at the first internal three-way joint 13a has a flow rate thereof regulated at the hot gas flow regulating valve 15d and is depressurized there. The refrigerant depressurized at the hot gas flow regulating valve 15d and relatively high in enthalpy flows into the chiller 20.

At the chiller 20, the refrigerant depressurized at the refrigerating expansion valve 15c and the refrigerant depressurized at the hot gas flow regulating valve 15d are mixed together. Since the low temperature-side pump 31 is at a stop at this time, at the chiller 20, a refrigerant and a low temperature-side heating medium do not exchange heat. The refrigerant flowing out of the chiller 20 is sucked into the compressor 11 and is compressed again there.

In the high temperature-side heating medium circuit 40 in the hot gas heating mode, a high temperature-side heating medium flowing into the heater core 45 radiates heat to ventilation air.

In the interior air conditioning unit 50 in the hot gas heating mode, ventilation air sent from the interior blower 52 passes through the interior evaporator 18. The ventilation air that passed through the interior evaporator 18 is heated at the heater core 45 according to an opening of the air mix door 54. The ventilation air heated at the heater core 45 is blown out into the vehicle compartment and heating of the interior of the vehicle compartment is thereby implemented.

(e-2) Warm-Up Hot Gas Heating Mode

In the low temperature-side heating medium circuit 30 in the warm-up hot gas heating mode, the controller 60 actuates the low temperature-side pump 31 so as to exhibit a predetermined reference pressure feed capacity. For this reason, in the low temperature-side heating medium circuit 30, a low temperature-side heating medium pressure fed from the low temperature-side pump 31 circulates in the order of the heating medium channel of the chiller 20 to the cooling water channel 80a of the battery 80. The other operations are the same as in the hot gas heating mode.

Therefore, in the heat pump cycle 10b in the warm-up hot gas heating mode, a refrigerant that flowed into the chiller 20 radiates heat to a low temperature-side heating medium. As a result, the low temperature-side heating medium is heated. In the low temperature-side heating medium circuit 30 in the warm-up hot gas heating mode, a low temperature-side heating medium heated at the chiller 20 flows through the cooling water channel 80a of the battery 80. As a result, the battery 80 is warmed up.

### (f) Single Cooling Mode

In the heat pump cycle 10b in the single cooling mode, the controller 60 brings the heating expansion valve 15a into a fully opened state, the refrigerating expansion valve 15c into a throttled state, the hot gas flow regulating valve 15d into a fully closed state, and the outdoor machine pressure control valve 19b into a fully closed stated. The controller 60 closes the first on-off valve 23c and opens the second on-off valve 23d.

For this reason, the heat pump cycle 10b in the single cooling mode, the refrigerant circuit is switched to a refrigerant circuit in which a refrigerant discharged from the compressor 11 circulates in the order of the muffler portion 12, the interior condenser 14, the fully opened heating expansion valve 15a, the outdoor heat exchanger 16, the second fixed throttling 25b, the receiver portion 24, the throttled refrigerating expansion valve 15c, the chiller 20 and the suction port of the compressor 11.

In the low temperature-side heating medium circuit 30 in the single refrigerating mode, a low temperature-side heating medium pressure fed from the low temperature-side pump 31 circulates as in the refrigeration cooling mode. In the interior air conditioning unit 50 in the single refrigerating mode, the interior blower 52 is stopped.

Therefore, in the heat pump cycle 10 in the single refrigeration mode, a refrigeration cycle of a vapor compression type is so configured that the outdoor heat exchanger 16 is caused to function as a condenser; and the chiller 20 is caused to function as an evaporator.

In the low temperature-side heating medium circuit 30 in the single refrigerating mode, as in the refrigeration cooling mode, a low temperature-side heating medium refrigerated at the chiller 20 flows through the cooling water channel 80a of the battery 80 and the battery 80 is thereby refrigerated.

As described up to this point, in the vehicle air conditioner 1b in the present embodiment, comfortable air conditioning in the vehicle compartment and appropriate temperature control of the battery 80 as an in-vehicle device can be performed by switching operation modes.

In the heat pump cycle 10b in the present embodiment, the thermostatic expansion valve 27 is adopted. As a result, an amount of heat absorption at the interior evaporator 18 can be increased to enhance a coefficient of performance (COP) of the cycle.

In addition, since the present embodiment adopts the compressor module 120, the same effects as in the first embodiment can be obtained. That is, noise of the compressor 11 can be sufficiently suppressed without incurring degradation in the productivity of the vehicle air conditioner 1b as a heat pump cycle.

### Fourth Embodiment

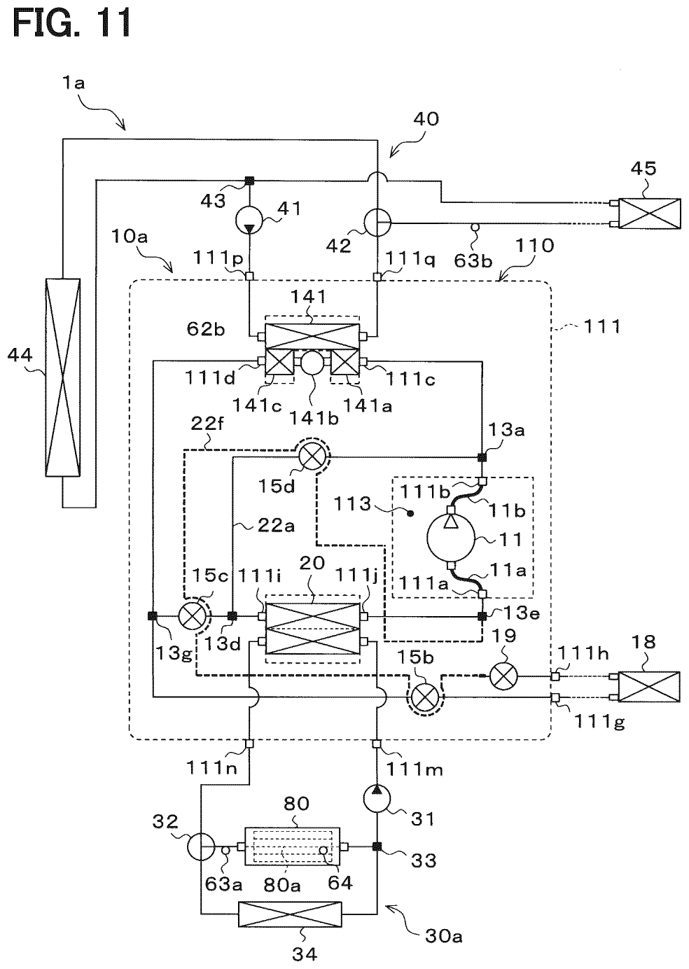

In relation to the present embodiment, a description will be given to a modification to the second embodiment. In the present embodiment, as shown in the overall configuration diagram in FIG. 11, a refrigeration channel 22f is formed in the channel box 111 of the compressor module 110 as an internal refrigerant channel. The refrigeration channel 22f is an internal refrigerant channel extending from the outlet side of the evaporator pressure control valve 19 to one inflow port of the fifth internal three-way joint 13e.

As shown in FIG. 11, the refrigeration channel 22f is so formed as to run around such electrical devices as the cooling expansion valve 15b, refrigerating expansion valve 15c, and hot gas flow regulating valve 15d. For this reason, in the vehicle air conditioner 1a, the above-mentioned electrical devices can be refrigerated in an operation mode in which a low pressure-side refrigerant flows through the refrigeration channel 22f as in the single cooling mode, refrigeration cooling mode, single dehumidification heating mode, and refrigeration dehumidification heating mode.

In other words, the cooling expansion valve 15b, refrigerating expansion valve 15c, and hot gas flow regulating valve 15d in the present embodiment are so disposed that the valves can be refrigerated by cold heat of a low pressure-side refrigerant flowing through the refrigeration channel 22f.

The other configuration elements of the vehicle air conditioner 1a is the same as in the second embodiment. Therefore, according to the vehicle air conditioner 1a in the present embodiment, the same effects as in the second embodiment can be obtained. That is, noise of the compressor 11 can be sufficiently suppressed without incurring degradation in the productivity of the vehicle air conditioner 1a as a heat pump cycle.

Further, since the refrigeration channel 22f is formed in the compressor module 110 in the present embodiment, the electrical devices attached to the compressor module 110 can be refrigerated by a low pressure-side refrigerant in the heat pump cycle 10a. Therefore, operations of the electrical devices attached to the compressor module 110 can be stabilized.

Though in the description of the present embodiment, an example in which only the refrigeration channel 22f is provided has been taken, the refrigeration channel 22f may be added to the second embodiment. That is, the refrigeration channel 22f may be provided in parallel with an internal refrigerant channel that directly connects the outlet side of the evaporator pressure control valve 19 and one inflow port of the fifth internal three-way joint 13e. According to the foregoing, a flow rate of a low pressure-side refrigerant flowing through the refrigeration channel 22f can be appropriately regulated.

### Fifth Embodiment

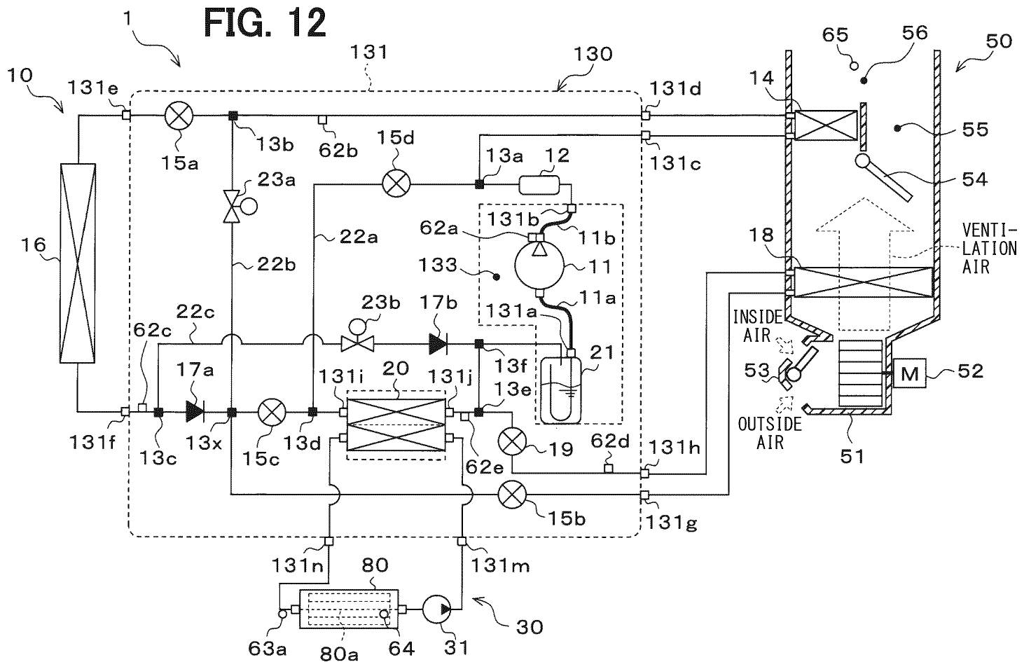

In relation to the present embodiment, a description will be given to an example in which a compressor module 130 is applied to the vehicle air conditioner 1 described in relation to the first embodiment as shown in FIG. 12,

In the compressor module 130 in the present embodiment, as in the first embodiment, of the component devices of the heat pump cycle 10, the compressor 11, the muffler portion 12, the heating expansion valve 15a, the cooling expansion valve 15b, the refrigerating expansion valve 15c, the hot gas flow regulating valve 15d, the evaporator pressure control valve 19, the chiller 20, the accumulator portion 21, the dehumidifying on-off valve 23a, the heating on-off valve 23b, and the like are integrated.

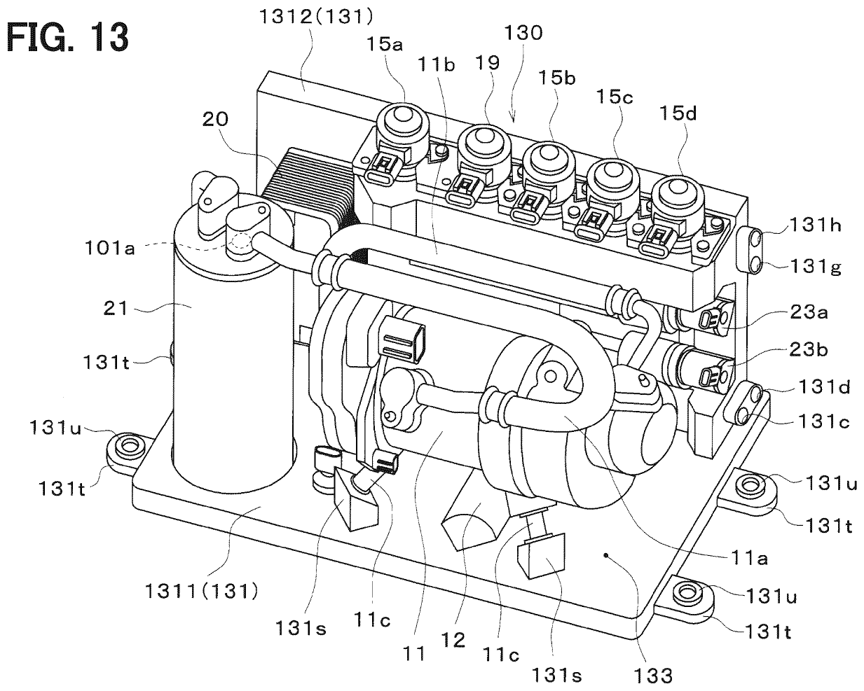

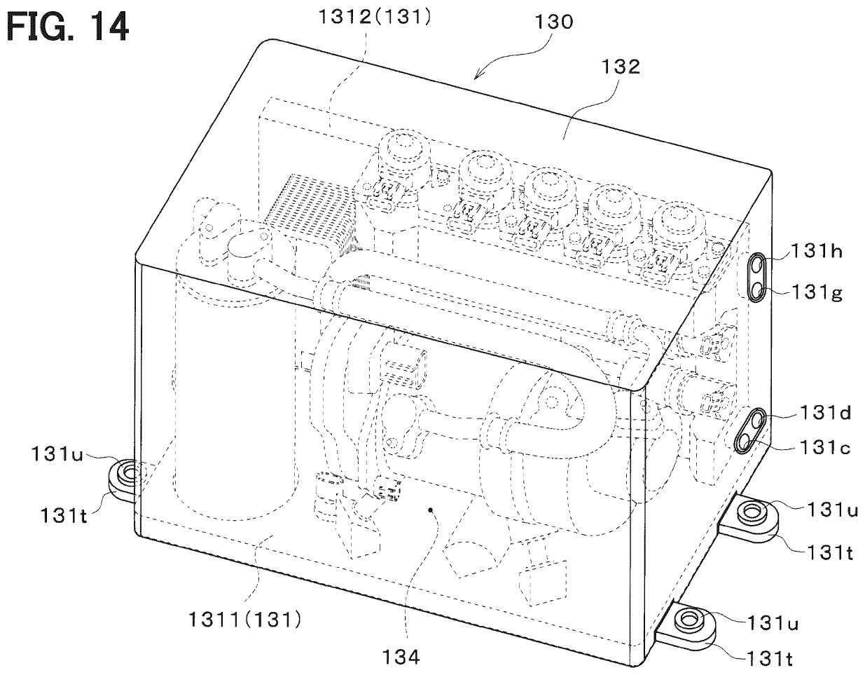

The basic configuration of the compressor module 130 is the same as that the compressor module 100 described in relation to the first embodiment. As illustrated in FIG. 13, the compressor module 130 includes a channel box 131 made of metal. As illustrated in FIG. 14, the compressor module 130 includes a cover member 132 made of resin. Further, in the heat pump cycle 10 in the present embodiment, the accumulator portion 21 is formed of a different member from the channel box 131.

The channel box 131 in the present embodiment is formed by combining a plurality of metal members. Specifically, the channel box 131 in the present embodiment includes a first box member 1311 and a second box member 1312. The first box member 1311 and the second box member 1312 are both formed of a rectangular plate-like member.

The first box member 1311 forms a bottom face of the compressor module 130. Of the above-mentioned component devices of the heat pump cycle 10, the compressor 11 and the accumulator portion 21 are attached to the first box member 1311 and are thereby integrated. The muffler portion 12 is integrally formed with the first box member 1311.

The heating expansion valve 15a, the cooling expansion valve 15b, the refrigerating expansion valve 15c, the hot gas flow regulating valve 15d, the evaporator pressure control valve 19, the chiller 20, the dehumidifying on-off valve 23a, and the heating on-off valve 23b are attached to the second box member 1312 and are thereby integrated.

The first box member 1311 and the second box member 1312 are fixed by such a means as bolting so that respective flat surfaces are orthogonal to each other. In more detail, the first box member 1311 and the second box member 1312 are fixed so that one end face of the second box member 1312 is abutted against a flat surface of the first box member 1311.

At least either of an internal refrigerant channel and an internal heating medium channel is formed inside the first box member 1311 and the second box member 1312. A seal member, now shown, is placed in the abutment plane between the first box member 1311 and the second box member 1312. As a result, a refrigerant or a low temperature-side heating medium does not leak from a gap in the contact area between the first box member 1311 and the second box member 1312.

A plurality of (in the present embodiment, four) attaching portions 131t for attaching the compressor module 130 to an object (in the present embodiment, a vehicle) are formed in the first box member 1311. The attaching portions 131t are formed of a part protruded from an end portion of the first box member 1311 in parallel with a flat surface.

A through hole for passing a bolt through is formed in each of the attaching portions 131t. An annular rubber vibration insulator 131u is disposed in the through hole formed in each attaching portion 131t along the rim of the through hole. The rubber vibration insulator 131u is a vibration insulating member that suppresses transmission of vibration from the channel box 131 to the vehicle.

When attached to the channel box 131, as in the first embodiment, the cover member 132 forms a housing space 133 as a sealed space for housing the compressor 11 and the like in the compressor module 130. The cover member 132 is formed in a shape of a box whose rectangular parallelepiped shape is open in one face. For this reason, as shown in FIG. 14, the appearance of the compressor module 130 is in a rectangular parallelepiped shape.

Of the six outer surfaces of the rectangular parallelepiped shape of the compressor module 130, the bottom face is formed of the first box member 1311 of the channel box 131. The remaining five surfaces are formed by the cover member 132. For this reason, in the compressor module 130, the second box member 1312 of the channel box 131 is also disposed in the housing space 133.

As in the first embodiment, a heat insulating material 134 is disposed substantially throughout an inner wall surface of the cover member 132 and a face of the channel box 131 on the housing space 133 side, that is, an inner side face of the compressor module 130 on the housing space 133 side.

The compressor 11, the heating expansion valve 15a, the cooling expansion valve 15b, the refrigerating expansion valve 15c, the hot gas flow regulating valve 15d, the evaporator pressure control valve 19, the chiller 20, the accumulator portion 21, the dehumidifying on-off valve 23a, and the heating on-off valve 23b are housed in the housing space 133. For this reason, the compressor-side outlet 131a, the compressor-side inlet 131b, the chiller-side outlet 131i, and the chiller side inlet 131j are formed in the housing space 133.

In more detail, the compressor-side outlet 131a is formed in the accumulator portion 21 that is a component device disposed in the housing space 103 and is thus formed in the housing space 133. The compressor-side inlet 131b is formed in inner side faces of the housing space 103 side of the channel box 131 and thus formed in the housing space 133.

As in the first embodiment, the interior condenser 14, outdoor heat exchanger 16, and interior evaporator 18 are external component devices.

For this reason, a condenser-side outlet 131c, a condenser-side inlet 131d, an outdoor machine-side outlet 131e, an outdoor machine-side inlet 131f, an evaporator-side outlet 131g, and an evaporator-side inlet 131h are formed in an outer side face of the channel box 131 and are thus formed outside the housing space 133.

Therefore, in the present embodiment, the condenser-side outlet 131c, the condenser-side inlet 131d, the outdoor machine-side outlet 131e, the outdoor machine-side inlet 131f, the evaporator-side outlet 131g, and the evaporator-side inlet 131h are outside connection ports to which the inflow and outflow port sides of the external component devices.

As in the first embodiment, the compressor 11 is fixed to a plurality (four in the present embodiment) of fixing portions 131s formed on the face forming the housing space 133 of the first box member 1311 through a rubber vibration insulator 11c.

The accumulator portion 21 is fixed to a fixing portion formed in a face of the first box member 1311 where the housing space 133 is formed by such a means as screw-fastening, press-fitting, or bonding.

The muffler portion 12 is formed with the first box member 1311. The muffler portion 12 is formed in such a shape as to swell to the housing space 133 side to form a buffer space. The muffler portion 12 is disposed in the first box member 1311 encircled with a plurality of the fixing portions 131s. In other words, the fixing portions 131s are disposed around the area where the muffler portion 12 is formed.

As a result, in the compressor module 130, heat of a high pressure-side refrigerant in the muffler portion 12 can be transferred to the rubber vibration insulators 11c to heat the rubber vibration insulators 11c. In other words, the rubber vibration insulators 11c are so disposed that the rubber vibration insulators can be heated by heat of a high pressure-side refrigerant in the muffler portion 12. Fixation and electrical connection of the other component devices are the same as those in the first embodiment.

The other configuration elements and operations of the vehicle air conditioner 1 are the same as in the first embodiment. Therefore, according to the vehicle air conditioner 1 in the present embodiment, the same effects as in the first embodiment can be obtained. That is, noise of the compressor 11 can be sufficiently suppressed without incurring degradation in the productivity of the vehicle air conditioner 1 as a heat pump cycle.

Further, the compressor module 130 in the present embodiment adopts the box-shaped cover member 132. According to the foregoing, by disposing a seal member around the first box member 1311 of the channel box 131, the housing space 133 can be easily made a sealed space without necessity for a seal member in a complicated shape.

In the compressor module 130 in the present embodiment, heat of a high pressure-side refrigerant in the muffler portion 12 as a high pressure-side refrigerant device can be transferred to the rubber vibration insulators 11c to heat the rubber vibration insulators 11c. According to the foregoing, as in the second embodiment, degradation in the elasticity of the rubber vibration insulators 11c can be suppressed and production of noise by the channel box 131 or the cover member 132 can be effectively suppressed.

In the compressor module 130 in the present embodiment, a heat insulating material 134 is disposed on an inner side face on the housing space 133 side. According to the foregoing, the heat insulating material 134 can be suppressed from peeling off or being deteriorated due to flooding or the like. To dispose the heat insulating material 134 on an inner side face on the housing space 133 side, spray coating or the like may be used.

Further, the compressor module 130 in the present embodiment is provided with the attaching portions 131t arranging the rubber vibration insulator 131u disposed therein. According to the foregoing, a noise reduction effect and a vibration suppression effect can be more effectively obtained in the compressor module 130 owing to the rubber vibration insulators 11c placed between the compressor 11 and the channel box 131 and the rubber vibration insulators 131u placed between the channel box 131 and the vehicle.

The present disclosure is not limited to the above-mentioned embodiments and can be variously modified without departing from the subject matter of the present disclosure as described below:
In the descriptions of the above embodiments, the vehicle air conditioner 1, 1a, 1b has been taken a heat pump cycle to which a compressor module according to the present disclosure is applied. But the heat pump cycle to which the compressor module is applied is not limited to a vehicle air conditioner.

For example, the heat pump cycle may be a stationary air conditioner with a temperature control function that performs air conditioning in a room and further controls a temperature of an object to be temperature-controlled (for example, a computer, a server for a computer, other electrical devices).

In the descriptions of the above embodiments, an example in which a temperature of the battery 80 as an in-vehicle device to be temperature-controlled is controlled has been taken but the in-vehicle device to be temperature-controlled is not limited to a battery 80. For example, a temperature of an inverter, PCU, a transaxle, an ADAS controller, or the like may be controlled.

The inverter supplies electric power to a motor generator or the like. The PCU is a power control unit that performs power transformation or power distribution. The transaxle is a power transmission mechanism in which a transmission, a differential gear, and the like are integrated. The ADAS controller is a controller for an advanced driver-assistance system.

The concrete configuration of the compressor module 100, 110, 120, 130 according to the present disclosure is not limited to the configuration disclosed in the above embodiments.

For example, the housing space 103, 113, 123, 133 need not be a sealed space that houses the whole of the compressor 11. The housing space 103, 113, 123, 133 may be a sealed space that houses at least a part of the compressor 11 as long as noise of the compressor 11 can be suppressed from leaking to outside the housing space 103, 113, 123, 133.

Each component device of the heat pump cycle 1, 1a, 1b integrated into the compressor module 100 to 130 is not limited to a component device disclosed in the above embodiments. Each of the other component devices may be integrated or may be not integrated as long as the compressor 11 is housed at least in the housing space 103, 113, 123, 133. Further, the other component devices integrated into the compressor module 100 to 130 may be disposed in the housing space 103 to 133 or may be disposed outside.

As described in relation to the above embodiments, the compressor-side outlet 101a, 111a, 121a, 131a and the compressor-side inlet 101b, 111b, 121b, 131b may be formed in an inner side face of the channel box 101, 111, 121, 131 and thus formed inside the housing space 103 to 133.

Alternatively, the compressor-side outlet 101a to 131a and the compressor-side inlet 101b to 131b may be formed in a component device of the heat pump cycle 1, 1a, 1b disposed in the housing space 103 to 133 and thus formed inside the housing space 103 to 133.

Similarly, the outside connection port 101c to 131h may be formed in an outer side face of the channel box 101 to 131 and thus formed outside housing space 103 to 133. Further, the outside connection port 101c to 131h may be formed in a component device of the heat pump cycle 1, 1a, 1b attached to the channel box 101 to 131 and thus formed outside the housing space 103 to 133.

A disposition of the rubber vibration insulators 11c is not limited to the example disclosed in the above embodiments. For example, the rubber vibration insulators 11c may be so disposed that the rubber vibration insulators can be heated by a high pressure-side refrigerant in the receiver portion 24 as described in relation to the third embodiment.

In the descriptions of the above embodiments, an example in which an aluminum alloy is adopted as a material for forming the channel box 101 to 131 has been taken. But the material of the channel box 101 to 131 is not limited to an aluminum alloy. By adopting iron or a stainless alloy larger in specific gravity than aluminum, a weight of the entire compressor module 100 to 130 can be increased to enhance the damping properties of the compressor module.

Further, an example in which polypropylene is adopted as a material of the cover member 102, 122, 132 has been taken. But the material of the cover member 102 to 132 may be any other type of resin or may be the same metal as the material of the channel box 101 to 131. Whatever material is adopted for the channel box 101 to 131 and the cover member 102 to 132, it is desirable that the housing space 103 to 133 can be formed as a sealed space.

The heat insulating materials 104, 124, 134 may be disposed in an outer side face of the compressor module 100 to 120 as in the first to fourth embodiments or may be disposed in an inner side face of the compressor module 130 as in the fifth embodiment. A heat insulating portion may be disposed both in an outer side face and in an inner side face of the compressor module.

The same internal refrigerant channel as the refrigeration channel 22f described in relation to the fourth embodiment may be formed in the channel box 101, 121, 131. The attaching portions 131t arranging the rubber vibration insulator 131u described in relation to the fifth embodiment may be formed in the compressor modules 100, 110, 120. The attaching portions 131t need not be formed in the channel box 101 to 131 but may be formed in the cover member 102 to 132.

The concrete configuration of a heat pump cycle to which a compressor module according to the present disclosure is applied is not limited to the configuration disclosed in the above embodiments.

For example, the evaporator pressure control valve 19 need not be an electrically operated variable throttle mechanism. A mechanically operated variable throttle mechanism that increases a valve opening with increase in the pressure of an outlet-side refrigerant in the interior evaporator 18 may be adopted as an evaporator pressure control valve.

For example, the refrigerant of the heat pump cycle 10, 10a, 10b is not limited to R1234yf. R134a, R600a, R410A, R404A, R32, R407C, or the like may be adopted as a refrigerant. Or, a mixed refrigerant or the like obtained by mixing a plurality of refrigerants among these refrigerants may be adopted.

For example, a low temperature-side heating medium of the low temperature-side heating medium circuit 30, 30a or a high temperature-side heating medium of the high temperature-side heating medium circuit 40 is not limited to an ethylene glycol aqueous solution. A solution containing dimethylpolysiloxane, a nano fluid, or the like, an aqueous liquid refrigerant containing antifreeze, alcohol, or the like, or a liquid medium containing oil or the like may be adopted as the low temperature-side heating medium and the high temperature-side heating medium.

An operating mode of a heat pump cycle to which a compressor module according to the present disclosure is applied is not limited to the modes disclosed in the above-mentioned embodiments.

For example, in the vehicle air conditioner 1 described in relation to the first embodiment, an outside air heat absorption hot gas heating mode may be performed.

In the heat pump cycle 10 in the outside air heat absorption hot gas heating mode, the controller 60 brings the heating expansion valve 15a into a throttled state, the cooling expansion valve 15b into a fully closed state, the refrigerating expansion valve 15c into a fully opened state, and the hot gas flow regulating valve 15d into a throttled state. Further, the controller 60 closes the dehumidifying on-off valve 23a and closes the heating on-off valve 23b.

For this reason, in the heat pump cycle 10a in the single heating mode, a refrigerant discharged from the compressor 11 circulates in the order of the muffler portion 12, the interior condenser 14, the throttled heating expansion valve 15a, the outdoor heat exchanger 16, the fully opened refrigerating expansion valve 15c, the chiller 20, the accumulator portion 21 and the suction port of the compressor 11. Simultaneously, the refrigerant circuit is switched to a refrigerant circuit in which a refrigerant discharged from the compressor 11 circulates in the order of the muffler portion 12, the throttled hot gas flow regulating valve 15d in the hot gas channel 22a, the chiller 20, the accumulator portion 21 and the suction port of the compressor 11.

Further, in the low temperature-side heating medium circuit 30 in the outside air heat absorption hot gas heating mode, the low temperature-side pump 31 is stopped.

Therefore, in the heat pump cycle 10 in the outside air heat absorption hot gas heating mode, a flow of a refrigerant discharged from the compressor 11 is branched at the first internal three-way joint 13a.

One refrigerant branched at the first internal three-way joint 13a flows into the interior condenser 14 and radiates heat to ventilation air. As a result, the ventilation air is heated. A refrigerant flowing out of the interior condenser 14 flows into the heating expansion valve 15a and is depressurized there. The refrigerant depressurized at the heating expansion valve 15a flows into the outdoor heat exchanger 16. The refrigerant that flowed into the outdoor heat exchanger 16 absorbs heat from outside air and is evaporated. A refrigerant flowing out of the outdoor heat exchanger 16 flows into the chiller 20.

Meanwhile, the other refrigerant branched at the first internal three-way joint 13a has a flow rate thereof regulated at the hot gas flow regulating valve 15d and is depressurized there. The refrigerant depressurized at the hot gas flow regulating valve 15d and relatively high in enthalpy flows into the chiller 20 through the fourth internal three-way joint 13d.

At the chiller 20, the refrigerant depressurized at the refrigerating expansion valve 15c and the refrigerant depressurized at the hot gas flow regulating valve 15d are mixed together. Since the low temperature-side pump 31 is at a stop at this time, at the chiller 20, a refrigerant and a low temperature-side heating medium do not exchange heat. A refrigerant flowing out of the chiller 20 flows into the accumulator portion 21 and is separated into gas and liquid there. A vapor-phase refrigerant separated at the accumulator portion 21 is sucked into the compressor 11 and is compressed again there.

In the interior air conditioning unit 50 in the outside air heat absorption hot gas heating mode, ventilation air sent from the interior blower 52 passes through the interior evaporator 18. The ventilation air that passed through the interior evaporator 18 is heated at the interior condenser 14 according to an opening of the air mix door 54. Ventilation air heated at the interior condenser 14 is blown out into the vehicle compartment and heating of the interior of the vehicle compartment is thereby implemented.

Since in the outside air heat absorption hot gas heating mode, the hot gas flow regulating valve 15d is brought into a throttled state, a refrigerant relatively high in enthalpy can be let to flow into the chiller 20.

Therefore, in the vehicle air conditioner 1 in the parallel dehumidification hot gas heating mode, a suction-side refrigerant let to flow out to the suction port side of the compressor 11 can be made a vapor-phase refrigerant having a degree of superheat even though the refrigerant discharge capacity of the compressor 11 is increased to a higher value than in the parallel dehumidification heating mode. Further, by increasing a compression workload of the compressor 11, an amount of heat radiated from a refrigerant to ventilation air at the interior condenser 14 can be increased to enhance heating capacity.

A compressor module according to the present disclosure is effective at suppressing noise in a heat pump cycle having an operation mode, such as the outside air heat absorption hot gas heating mode, in which a refrigerant discharge capacity of the compressor 11 is increased.

Further, in the above-mentioned vehicle air conditioners 1, 1a, 1b, the warm-up mode in which some component devices and a refrigerant are heated at a cryogenic outside air temperature (for example, when the outside air temperature Tam is at −10° C. or below) may be performed.

In the warm-up mode, the controller 60 brings the heating expansion valve 15a into a fully closed state, the cooling expansion valve 15b into a fully closed state, the refrigerating expansion valve 15c into a fully closed state, and the hot gas flow regulating valve 15d into a throttled state. Further, the controller 60 closes the dehumidifying on-off valve 23a, the heating on-off valve 23b, the first on-off valve 23c, and the second on-off valve 23d.

For this reason, in the heat pump cycle 10, 10a, 10b in the warm-up mode, the refrigerant circuit is switched to a refrigerant circuit in which a refrigerant discharged from the compressor 11 circulates in the order of the hot gas flow regulating valve 15d in the hot gas channel 22a, the chiller 20 and the suction port side of the compressor 11. As a result, some component devices and a refrigerant whose temperatures are reduced at a cryogenic outside air temperature can be heated and warmed up.

Although the present disclosure has been described in accordance with examples, it is understood that the present disclosure is not limited to the examples and structures. The present disclosure also includes various modifications, and modifications within an equivalent scope. In addition, various combinations and modes, and other combinations and modes including only one element, more elements, or less elements are also within the scope and idea of the present disclosure.

What is claimed is:

1. A compressor module for a heat pump cycle including component devices, the compressor module comprising:
a compressor configured to suck, compress, and discharge a refrigerant;
a channel forming member configured to define therein a plurality of internal refrigerant channels through which the refrigerant flows; and
a cover member configured to define a housing space of a housing, which houses the compressor, together with the channel forming member, wherein
the housing is provided therein with a compressor-side inlet and a compressor-side outlet communicating to the internal refrigerant channels,
the housing is provided with an outside connection port outside of the housing space and communicating to the internal refrigerant channels,
the compressor has a refrigerant discharge port coupled to the compressor-side inlet, and a refrigerant suction port coupled to the compressor-side outlet,
the outside connection port is configured to be connected to inflow and outflow sides of external component devices disposed outside the housing space, in the component devices of the heat pump cycle, and
at least a part of an outer surface of the housing is defined by both of the channel forming member and the cover member.

2. The compressor module according to claim 1, wherein the housing space is a sealed space housing at least a part of the compressor.

3. The compressor module according to claim 1, further comprising:
a low-pressure hose connecting the compressor-side outlet and the refrigerant suction port of the compressor with each other; and
a high-pressure hose connecting the refrigerant discharge port of the compressor and the compressor-side inlet with each other,
wherein the low-pressure hose and the high-pressure hose are flexible and attached to the compressor and the channel forming member, respectively, in a curved state.

4. The compressor module according to claim 1, wherein
the compressor is fixed to the channel forming member through a vibration insulating member,
the channel forming member is configured to define a part of a high pressure-side refrigerant device of the component devices of the heat pump cycle, in which a high pressure-side refrigerant of the heat pump cycle flows, and
the vibration insulating member is made of a material having a thermoplasticity and is disposed to be heated by the high pressure-side refrigerant in the high pressure-side refrigerant device.

5. The compressor module according to claim 1, wherein
the compressor is fixed to the channel forming member through a vibration insulating member, and
the vibration insulating member is made of a material having a thermoplasticity and is disposed to be heated by heat generated by the compressor.

6. The compressor module according to claim 1, wherein
an electrical device, electrically operated, is fixed to the channel forming member, and
the electrical device is disposed to be cooled by a low pressure-side refrigerant of the heat pump cycle, flowing through the internal refrigerant channels.

7. The compressor module according to claim 1, further comprising:
a heat insulating portion configured to suppress heat transfer between air inside the housing space and air outside the housing space.

8. The compressor module according to claim 1, wherein
the heat pump cycle includes: a discharge-side branch portion configured to branch a flow of the refrigerant discharged from the compressor; and a heater configured to heat a fluid to be heated using, as a heat source, the refrigerant of one stream branched at the discharge-side branch portion, and
in an operation mode in which the fluid is heated, the heat pump cycle is configured such that the refrigerant flowing out of the heater and the refrigerant of another stream branched at the discharge-side branch portion are merged and sucked into the compressor.

9. A compressor module for a heat pump cycle including component devices, the compressor module comprising:
a compressor configured to suck, compress, and discharge a refrigerant;
a channel forming member configured to define therein a plurality of internal refrigerant channels through which the refrigerant flows; and
a cover member configured to define a housing space of a housing, which houses the compressor, together with the channel forming member, wherein
the housing is provided therein with a compressor-side inlet and a compressor-side outlet communicating to the internal refrigerant channels,
the housing is provided with an outside connection port outside of the housing space and communicating to the internal refrigerant channels,
the compressor has a refrigerant discharge port coupled to the compressor-side inlet, and a refrigerant suction port coupled to the compressor-side outlet,
the outside connection port is configured to be connected to inflow and outflow sides of external component devices disposed outside the housing space, in the component devices of the heat pump cycle,
the compressor is fixed to the channel forming member through a vibration insulating member,
the channel forming member is configured to define a part of a high pressure-side refrigerant device of the component devices of the heat pump cycle, in which a high pressure-side refrigerant of the heat pump cycle flows, and
the vibration insulating member is made of a material having a thermoplasticity and is disposed to be heated by the high pressure-side refrigerant in the high pressure-side refrigerant device.

10. A compressor module for a heat pump cycle including component devices, the compressor module comprising:
a compressor configured to suck, compress, and discharge a refrigerant;
a channel forming member configured to define therein a plurality of internal refrigerant channels through which the refrigerant flows; and
a cover member configured to define a housing space of a housing, which houses the compressor, together with the channel forming member, wherein
the housing is provided therein with a compressor-side inlet and a compressor-side outlet communicating to the internal refrigerant channels,
the housing is provided with an outside connection port outside of the housing space and communicating to the internal refrigerant channels,
the compressor has a refrigerant discharge port coupled to the compressor-side inlet of the housing, and a refrigerant suction port coupled to the compressor-side outlet of the housing,
the outside connection port is configured to be connected to inflow and outflow sides of external component devices disposed outside the housing space, in the component devices of the heat pump cycle,
the compressor is fixed to the channel forming member through a vibration insulating member, and
the vibration insulating member is made of a material having a thermoplasticity and is disposed to be heated by heat generated by the compressor.
